(19) United States
(12) Patent Application Publication
(10) Pub. No.: US 2017/0189892 A1
(43) Pub. Date: Jul. 6, 2017

(54) LAYERED CATALYSTS FOR GASOLINE ENGINE EXHAUST

(71) Applicant: SDCmaterials, Inc., Tempe, AZ (US)

(72) Inventors: Qinghua YIN, Tempe, AZ (US); Xiwang QI, Scottsdale, AZ (US); Bryant KEARL, Phoenix, AZ (US); Maximilian A. BIBERGER, Scottsdale, AZ (US)

(21) Appl. No.: 15/390,373

(22) Filed: Dec. 23, 2016

Related U.S. Application Data
(60) Provisional application No. 62/273,902, filed on Dec. 31, 2015.
(60) Provisional application No. 62/275,152, filed on Jan. 5, 2016.

(51) Int. Cl. B01J 23/63; F01N 3/10; B01J 37/02; B01D 53/94; B01J 35/00; B01J 35/02

(52) U.S. Cl. CPC B01J 23/63; B01J 35/0006; B01J 35/026; B01J 37/024; B01D 53/945; F01N 3/101; B01D 2255/1023; B01D 2255/2042; B01D 2255/2061; B01D 2255/2063; B01D 2255/2065; B01D 2255/20715; B01D 2255/407; B01D 2255/9032; F01N 2510/06

(57) ABSTRACT

The present invention relates to coated substrates useful in catalytic converters. The coated substrates can have two washcoat layers, and in some embodiments, the first washcoat layer is divided into two zones. The substrates can be used in catalytic converters and emission control systems for treatment of exhaust gases from gasoline engines.

### CROSS-REFERENCE TO RELATED APPLICATIONS

This application claims priority benefit of U.S. Provisional Patent Application No. 62/273,902 filed Dec. 31, 2015, and of U.S. Provisional Patent Application No. 62/275,152 filed Jan. 5, 2016. The entire contents of both of those applications are incorporated by reference herein.

### FIELD OF THE INVENTION

The invention relates to catalytic converters used to treat gasoline engine exhaust, and coated substrates used in such catalytic converters.

### BACKGROUND OF THE INVENTION

Gasoline and diesel internal combustion engine exhaust contains various pollutants, including carbon monoxide (CO), unburned hydrocarbons due to incomplete combustion (“HC”), and nitrogen oxides (such as NO and NO₂). Abatement of such pollutants is desirable from an environmental standpoint, and is mandated by law in many countries. Catalytic converters which can reduce the amounts of these gases in engine exhaust were developed in response to such regulatory requirements.

Catalytic converters for gasoline engines are called “three-way” catalytic converters as they oxide CO to CO₂, oxidize unburned hydrocarbons to CO₂, and reduce nitrogen oxides to N₂. Gasoline engines are typically tuned so that the mixture of fuel and air is very close to the stoichiometric ratio required for complete combustion of hydrocarbons and oxygen to carbon dioxide and water. Running in a fuel-lean condition, with excess oxygen over the stoichiometric ratio, is desirable for complete combustion of hydrocarbons (reducing CO and unburned hydrocarbon output), while running in a fuel-rich condition, with excess hydrocarbon fuel over the stoichiometric ratio, is desirable for optimal conditions for reduction of nitrogen oxides to nitrogen by the catalytic converter. Accordingly, gasoline engines are usually tuned to oscillate within a narrow air-fuel ratio band, running slightly richer to provide a mixture of gases to the catalytic converter suitable to reduce nitrogen oxides, then running slightly leaner to provide a mixture of gases to the catalytic converter suitable to oxidize hydrocarbons and carbon monoxide.

### SUMMARY OF THE INVENTION

Provided herein is a coated substrate for treating gasoline engine exhaust, comprising a substrate; a first washcoat layer coating the substrate comprising first metal oxide particles; first composite nanoparticles comprising a first catalytic nanoparticle comprising platinum, palladium, or a platinum-palladium alloy bonded to a first support nanoparticle comprising aluminum oxide; and barium oxide; and a second washcoat layer coating the substrate comprising second metal oxide particles; and second composite nanoparticles comprising a second catalytic nanoparticle comprising rhodium bonded to a second support particle. In some embodiments, the first washcoat layer and/or the second washcoat layer further comprises filler particles. In some embodiments, the filler particles comprise aluminum oxide or aluminum-lanthanum oxide. In some embodiments, the first washcoat layer and/or the second washcoat layer comprises aluminum oxide derived from boehmite. In some embodiments, the first washcoat layer comprises about 40% to about 90% by weight of the first metal oxide particles. In some embodiments, the first washcoat layer comprises about 1% to about 10% by weight of the first composite nanoparticles. In some embodiments, the first washcoat layer comprises about 3% to about 20% by weight barium oxide. In some embodiments, the first washcoat layer comprises up to about 40% filler particles. In some embodiments, the first washcoat layer comprises up to about 70% filler particles. In some embodiments, the first washcoat layer comprises about 3% to about 8% by weight aluminum oxide derived from boehmite. In some embodiments the first washcoat layer is coated onto the substrate at about 150 g/L to about 250 g/L. In some embodiments the first washcoat layer has a platinum group metal loading content of about 1 g/L to about 5 g/L.

In some embodiments, the coated substrate for treating gasoline engine exhaust comprises a substrate; a first washcoat layer coating the substrate comprising a first zone and a second zone, wherein the first zone and the second zone do not overlap, wherein the first zone comprises first metal oxide particles; first composite nanoparticles comprising a first catalytic nanoparticle comprising platinum, palladium, or a platinum-palladium alloy bonded to a first support nanoparticle comprising aluminum oxide; and barium oxide; the second zone comprises third metal oxide particles; and third composite nanoparticles comprising a third catalytic nanoparticle comprising platinum, palladium, or a platinum-palladium alloy bonded to a third support nanoparticle comprising cerium oxide; and barium oxide; and a second washcoat layer coating the substrate comprising second metal oxide particles; and second composite nanoparticles comprising a second catalytic nanoparticle comprising rhodium bonded to a second support particle. In some embodiments, the first zone of the first washcoat layer, the second zone of the first washcoat layer, and/or the second washcoat layer further comprises filler particles. In some embodiments, the filler particles comprise aluminum oxide or aluminum-lanthanum oxide. In some embodiments, the first zone of the first washcoat layer, the second zone of the first washcoat layer, and/or the second washcoat layer comprises aluminum oxide derived from boehmite. In some embodiments, the first zone of the first washcoat layer comprises about 40% to about 90% by weight of the first metal oxide particles. In some embodiments, the first zone of the first washcoat layer comprises about 1% to about 10% by weight of the first composite nanoparticles. In some embodiments, the first zone of the first washcoat layer comprises about 3% to about 20% by weight barium oxide. In some embodiments, the first zone of the first washcoat layer comprises up to about 40% filler particles. In some embodiments, the first zone of the first washcoat layer comprises up to about 70% filler particles. In some embodiments, the first zone of the first washcoat layer comprises about 3% to about 8% by weight aluminum oxide derived from boehmite. In some embodiments, the first zone of the first washcoat layer is coated onto the substrate at about 150 g/L to about 250 g/L. In some embodiments, the first zone of the first washcoat layer has a platinum group metal loading content of about 3 g/L to about 5 g/L. In some embodiments, the second zone of the first washcoat layer comprises about 40% to about 90% by weight of the third metal oxide particles. In some embodiments, the second zone of the first washcoat layer comprises about 0.5% to about 3% by weight of the third composite nanoparticles. In some embodiments, the second zone of the first washcoat layer comprises about 3% to about 20% by weight barium oxide. In some embodiments, the second zone of the first washcoat layer comprises up to about 40% filler particles. In some embodiments, the second zone of the first washcoat layer comprises up to about 70% filler particles. In some embodiments, the second zone of the first washcoat layer comprises about 3% to about 8% by weight aluminum oxide derived from boehmite. In some embodiments, the second zone of the first washcoat layer is coated onto the substrate at about 165 g/L to about 220 g/L. In some embodiments, the second zone of the first washcoat layer has a platinum group metal loading content of about 0.5 g/L to about 1.2 g/L. In some embodiments, the first zone is about 10% to about 90% of the length of the first washcoat layer coated onto the substrate. In some embodiments, the first zone is about 25% to about 75% of the length of the first washcoat layer coated onto the substrate.

In some embodiments, the second washcoat layer comprises about 45% to about 95% by weight of the second metal oxide particles. In some embodiments, the second washcoat layer comprises about 1.5% to about 5% by weight of the second composite nanoparticles. In some embodiments, the second washcoat layer comprises up to about 45% filler particles. In some embodiments, the second washcoat layer comprises about 3% to about 8% by weight aluminum oxide derived from boehmite. In some embodiments, the second washcoat layer is coated onto the substrate at about 50 g/L to about 120 g/L. In some embodiments, the second washcoat layer has a platinum group metal loading content of about 0.1 g/L to about 0.6 g/L. In some embodiments, the first metal oxide particles, the second metal oxide particles, and/or the third metal oxide particles are micron-sized particles. In some embodiments, the first metal oxide particles, the second metal oxide particles, and/or the third metal oxide particles are porous. In some embodiments, the first metal oxide particles, the second metal oxide particles, and/or the third metal oxide particles comprise cerium oxide, zirconium oxide, lanthanum oxide, yttrium oxide, or a combination thereof. In some embodiments, the first metal oxide particles, the second metal oxide particles, and/or the third metal oxide particles comprise cerium-zirconium-lanthanum-yttrium oxide. In some embodiments, the second metal oxide particles comprise cerium oxide, zirconium oxide, lanthanum oxide, yttrium oxide, neodymium oxide, or a combination thereof. In some embodiments, the second metal oxide particle comprises cerium-zirconium-lanthanum-neodymium oxide. In some embodiments, the first catalytic nanoparticle and/or the third catalytic nanoparticle comprises palladium. In some embodiments, the second support nanoparticle comprises cerium oxide, zirconium oxide, lanthanum oxide, yttrium oxide, neodymium oxide, or a combination thereof. In some embodiments, the second support nanoparticle comprises cerium-zirconium-lanthanum-neodymium oxide. In some embodiments, the third support nanoparticle comprises cerium oxide, zirconium oxide, lanthanum oxide, yttrium oxide, or a combination thereof. In some embodiments, the third support nanoparticle comprises cerium oxide.

In some embodiments, the first composite nanoparticle is not attached to the first metal oxide particle prior to forming the first washcoat layer. In some embodiments, the third composite nanoparticle is not attached to the third metal oxide particle prior to forming the second zone of the first washcoat layer. In some embodiments, the second composite nanoparticle is attached to the second metal oxide particle prior to forming the second washcoat layer.

In some embodiments, the first composite nanoparticle comprises about 20% to about 60% by weight palladium, such as palladium nanoparticles bonded to aluminum oxide nanoparticles at a 40:60 weight ratio of palladium to metal oxide.

In some embodiments, the second composite nanoparticle comprises about 1% to about 30% by weight rhodium, such as rhodium nanoparticles bonded to cerium oxide support nanoparticles. In some embodiments, the second composite nanoparticle comprises about 5% to about 20% by weight rhodium, such as rhodium nanoparticles bonded to cerium oxide support nanoparticles. In some embodiments, the second composite nanoparticle comprises about 10% by weight rhodium, such as rhodium nanoparticles bonded to cerium oxide support nanoparticles. In some embodiments, the second composite nanoparticle comprises about 1% to about 30% by weight rhodium, such as rhodium nanoparticles bonded to support nanoparticles comprising cerium-zirconium oxide, cerium-lanthanum oxide, cerium-yttrium oxide, cerium-neodymium oxide, cerium-zirconium-lanthanum oxide, cerium-zirconium-yttrium oxide, cerium-zirconium-neodymium oxide, cerium-lanthanum-yttrium oxide, cerium-lanthanum-neodymium oxide, cerium-yttrium-neodymium oxide, cerium-zirconium-lanthanum-yttrium oxide, cerium-zirconium-lanthanum-neodymium oxide, cerium-zirconium-yttrium-neodymium oxide, cerium-lanthanum-yttrium-neodymium oxide, or cerium-zirconium-lanthanum-yttrium-neodymium oxide, in an approximately 1:99 to approximately 30:70 weight ratio of rhodium to metal oxide. In some embodiments, the second composite nanoparticle comprises about 5% to about 20% by weight rhodium, such as rhodium nanoparticles bonded to support nanoparticles comprising cerium-zirconium oxide, cerium-lanthanum oxide, cerium-yttrium oxide, cerium-neodymium oxide, cerium-zirconium-lanthanum oxide, cerium-zirconium-yttrium oxide, cerium-zirconium-neodymium oxide, cerium-lanthanum-yttrium oxide, cerium-lanthanum-neodymium oxide, cerium-yttrium-neodymium oxide, cerium-zirconium-lanthanum-yttrium oxide, cerium-zirconium-lanthanum-neodymium oxide, cerium-zirconium-yttrium-neodymium oxide, cerium-lanthanum-yttrium-neodymium oxide, or cerium-zirconium-lanthanum-yttrium-neodymium oxide, in an approximately 5:95 to approximately 20:80 weight ratio of rhodium to metal oxide. In some embodiments, the second composite nanoparticle comprises about 10% by weight rhodium, such as rhodium nanoparticles bonded to support nanoparticles comprising cerium-zirconium oxide, cerium-lanthanum oxide, cerium-yttrium oxide, cerium-neodymium oxide, cerium-zirconium-lanthanum oxide, cerium-zirconium-yttrium oxide, cerium-zirconium-neodymium oxide, cerium-lanthanum-yttrium oxide, cerium-lanthanum-neodymium oxide, cerium-yttrium-neodymium oxide, cerium-zirconium-lanthanum-yttrium oxide, cerium-zirconium-lanthanum-neodymium oxide, cerium-zirconium-yttrium-neodymium oxide, cerium-lanthanum-yttrium-neodymium oxide, or cerium-zirconium-lanthanum-yttrium-neodymium oxide, in an approximately 10:90 weight ratio of rhodium to metal oxide.

In some embodiments, the third composite nanoparticle comprises about 10% to about 50% by weight palladium. In some embodiments, the third composite nanoparticle comprises about 1% to about 50% by weight palladium. In some embodiments, the remainder of the third composite nanoparticle comprises metal oxide, such as aluminum oxide.

In some embodiments, the first metal oxide particles comprise about 10% to about 70% by weight cerium oxide. In some embodiments, the first metal oxide particles comprise about 30% to about 90% by weight zirconium oxide. In some embodiments, the first metal oxide particles comprise about 1% to about 15% by weight lanthanum oxide. In some embodiments, the first metal oxide particles comprise about 1% to about 15% by weight yttrium oxide.

In some embodiments, the third metal oxide particles comprise about 10% to about 70% by weight cerium oxide. In some embodiments, the third metal oxide particles comprise about 30% to about 90% by weight zirconium oxide. In some embodiments, the third metal oxide particles comprise about 1% to about 15% by weight lanthanum oxide. In some embodiments, the third metal oxide particles comprise about 1% to about 15% by weight yttrium oxide.

In some embodiments, the second metal oxide particles comprise about 1% to about 50% by weight cerium oxide. In some embodiments, the second metal oxide particles comprise about 50% to about 99% by weight zirconium oxide. In some embodiments, the second metal oxide particles comprise about 0.5% to about 5% by weight lanthanum oxide. In some embodiments, the second metal oxide particles comprise about 1% to about 15% by weight neodymium oxide.

In some embodiments, the third support nanoparticle comprises about 10% to about 70% by weight cerium oxide. In some embodiments, the third support nanoparticle comprises about 30% to about 90% by weight zirconium oxide. In some embodiments, the third support nanoparticle comprises about 1% to about 15% by weight lanthanum oxide. In some embodiments, the third support nanoparticle comprises about 1% to about 15% by weight yttrium oxide.

In some embodiments, the second support nanoparticle comprises about 1% to about 50% by weight cerium oxide. In some embodiments, the second support nanoparticle comprises about 50% to about 99% by weight zirconium oxide. In some embodiments, the second support nanoparticle comprises about 0.5% to about 5% by weight lanthanum oxide. In some embodiments, the second support nanoparticle comprises about 1% to about 15% by weight neodymium oxide.

Also provided herein is a coated substrate for treating gasoline engine exhaust, comprising a substrate; a first washcoat layer coating the substrate comprising first composite nanoparticles embedded in first porous carriers, where the first composite nanoparticles comprise a first catalytic nanoparticle comprising platinum, palladium, or a platinum-palladium alloy bonded to a first support nanoparticle comprising aluminum oxide; and barium oxide; and a second washcoat layer coating the substrate comprising second metal oxide particles; and second composite nanoparticles comprising a second catalytic nanoparticle comprising rhodium bonded to a second support particle. In some embodiments, the first porous carriers with embedded first composite nanoparticles are micron-sized. In some embodiments, the first porous carrier comprises aluminum oxide. In some embodiments, the second support nanoparticle comprises cerium oxide. In some embodiments, the second support nanoparticle comprises cerium-zirconium oxide, cerium-lanthanum oxide, cerium-yttrium oxide, cerium-neodymium oxide, cerium-zirconium-lanthanum oxide, cerium-zirconium-yttrium oxide, cerium-zirconium-neodymium oxide, cerium-lanthanum-yttrium oxide, cerium-lanthanum-neodymium oxide, cerium-yttrium-neodymium oxide, cerium-zirconium-lanthanum-yttrium oxide, cerium-zirconium-lanthanum-neodymium oxide, cerium-zirconium-yttrium-neodymium oxide, cerium-lanthanum-yttrium-neodymium oxide, or cerium-zirconium-lanthanum-yttrium-neodymium oxide. In some embodiments, the second metal oxide particles are micron-sized. In some embodiments, the second metal oxide particles comprise cerium oxide. In some embodiments, the second metal oxide particles comprise cerium-zirconium oxide, cerium-lanthanum oxide, cerium-yttrium oxide, cerium-neodymium oxide, cerium-zirconium-lanthanum oxide, cerium-zirconium-yttrium oxide, cerium-zirconium-neodymium oxide, cerium-lanthanum-yttrium oxide, cerium-lanthanum-neodymium oxide, cerium-yttrium-neodymium oxide, cerium-zirconium-lanthanum-yttrium oxide, cerium-zirconium-lanthanum-neodymium oxide, cerium-zirconium-yttrium-neodymium oxide, cerium-lanthanum-yttrium-neodymium oxide, or cerium-zirconium-lanthanum-yttrium-neodymium oxide. In some embodiments, the second metal oxide particles comprise aluminum oxide. In some embodiments, a portion of the second composite nanoparticles are not attached to the second metal oxide particles.

Also provided herein is a coated substrate for treating gasoline engine exhaust, comprising a substrate; a first washcoat layer coating the substrate comprising first metal oxide particles; first composite nanoparticles comprising a first catalytic nanoparticle comprising platinum, palladium, or a platinum-palladium alloy bonded to a first support nanoparticle comprising aluminum oxide; and barium oxide; and a second washcoat layer coating the substrate comprising second composite nanoparticles embedded in second porous carriers, where the second composite nanoparticles comprise a second catalytic nanoparticle comprising rhodium bonded to a second support particle. In some embodiments, the first metal oxide particles are micron-sized. In some embodiments, the first metal oxide particles comprise aluminum oxide. In some embodiments, the second porous carriers with embedded second composite nanoparticles are micron-sized. In some embodiments, the second support nanoparticle comprises cerium oxide. In some embodiments, the second support nanoparticle comprises cerium-zirconium oxide, cerium-lanthanum oxide, cerium-yttrium oxide, cerium-neodymium oxide, cerium-zirconium-lanthanum oxide, cerium-zirconium-yttrium oxide, cerium-zirconium-neodymium oxide, cerium-lanthanum-yttrium oxide, cerium-lanthanum-neodymium oxide, cerium-yttrium-neodymium oxide, cerium-zirconium-lanthanum-yttrium oxide, cerium-zirconium-lanthanum-neodymium oxide, cerium-zirconium-yttrium-neodymium oxide, cerium-lanthanum-yttrium-neodymium oxide, or cerium-zirconium-lanthanum-yttrium-neodymium oxide. In some embodiments, the second porous carrier in which the second composite nanoparticles are embedded comprises cerium oxide. In some embodiments, the second porous carrier in which the second composite nanoparticles are embedded comprises cerium-zirconium oxide, cerium-lanthanum oxide, cerium-yttrium oxide, cerium-neodymium oxide, cerium-zirconium-lanthanum oxide, cerium-zirconium-yttrium oxide, cerium-zirconium-neodymium oxide, cerium-lanthanum-yttrium oxide, cerium-lanthanum-neodymium oxide, cerium-yttrium-neodymium oxide, cerium-zirconium-lanthanum-yttrium oxide, cerium-zirconium-lanthanum-neodymium oxide, cerium-zirconium-yttrium-neodymium oxide, cerium-lanthanum-yttrium-neodymium oxide, or cerium-zirconium-lanthanum-yttrium-neodymium oxide. In some embodiments, a portion of the first composite nanoparticles are not attached to the first metal oxide particles.

Also provided herein is a coated substrate for treating gasoline engine exhaust, comprising a substrate; a first washcoat layer coating the substrate comprising first composite nanoparticles embedded in first porous carriers, where the first composite nanoparticles comprise a first catalytic nanoparticle comprising platinum, palladium, or a platinum-palladium alloy bonded to a first support nanoparticle comprising aluminum oxide; and barium oxide; and a second washcoat layer coating the substrate comprising second composite nanoparticles embedded in second porous carriers, where the second composite nanoparticles comprise a second catalytic nanoparticle comprising rhodium bonded to a second support particle. In some embodiments, the first porous carriers with embedded first composite nanoparticles are micron-sized. In some embodiments, the first porous carriers comprise aluminum oxide. In some embodiments, the second porous carriers with embedded second composite nanoparticles are micron-sized. In some embodiments, the second support nanoparticle comprises cerium oxide. In some embodiments, the second support nanoparticle comprises cerium-zirconium oxide, cerium-lanthanum oxide, cerium-yttrium oxide, cerium-neodymium oxide, cerium-zirconium-lanthanum oxide, cerium-zirconium-yttrium oxide, cerium-zirconium-neodymium oxide, cerium-lanthanum-yttrium oxide, cerium-lanthanum-neodymium oxide, cerium-yttrium-neodymium oxide, cerium-zirconium-lanthanum-yttrium oxide, cerium-zirconium-lanthanum-neodymium oxide, cerium-zirconium-yttrium-neodymium oxide, cerium-lanthanum-yttrium-neodymium oxide, or cerium-zirconium-lanthanum-yttrium-neodymium oxide. In some embodiments, the second porous carriers comprise cerium oxide. In some embodiments, the second porous carriers comprise cerium-zirconium oxide, cerium-lanthanum oxide, cerium-yttrium oxide, cerium-neodymium oxide, cerium-zirconium-lanthanum oxide, cerium-zirconium-yttrium oxide, cerium-zirconium-neodymium oxide, cerium-lanthanum-yttrium oxide, cerium-lanthanum-neodymium oxide, cerium-yttrium-neodymium oxide, cerium-zirconium-lanthanum-yttrium oxide, cerium-zirconium-lanthanum-neodymium oxide, cerium-zirconium-yttrium-neodymium oxide, cerium-lanthanum-yttrium-neodymium oxide, or cerium-zirconium-lanthanum-yttrium-neodymium oxide.

In some embodiments, the first washcoat layer and/or the second washcoat layer further comprises filler particles. In some embodiments, the filler particles comprise aluminum oxide or aluminum-lanthanum oxide. In some embodiments, the filler particles comprise cerium oxide. In some embodiments, the filler particles comprise cerium-zirconium oxide, cerium-lanthanum oxide, cerium-yttrium oxide, cerium-neodymium oxide, cerium-zirconium-lanthanum oxide, cerium-zirconium-yttrium oxide, cerium-zirconium-neodymium oxide, cerium-lanthanum-yttrium oxide, cerium-lanthanum-neodymium oxide, cerium-yttrium-neodymium oxide, cerium-zirconium-lanthanum-yttrium oxide, cerium-zirconium-lanthanum-neodymium oxide, cerium-zirconium-yttrium-neodymium oxide, cerium-lanthanum-yttrium-neodymium oxide, or cerium-zirconium-lanthanum-yttrium-neodymium oxide. In some embodiments, the filler particles in the first washcoat layer comprise aluminum oxide or aluminum-lanthanum oxide. In some embodiments, the filler particles, such as the filler particles in the second washcoat layer, comprise cerium oxide. In some embodiments, the filler particles, such as the filler particles in the second washcoat layer, comprise cerium-zirconium oxide, cerium-lanthanum oxide, cerium-yttrium oxide, cerium-neodymium oxide, cerium-zirconium-lanthanum oxide, cerium-zirconium-yttrium oxide, cerium-zirconium-neodymium oxide, cerium-lanthanum-yttrium oxide, cerium-lanthanum-neodymium oxide, cerium-yttrium-neodymium oxide, cerium-zirconium-lanthanum-yttrium oxide, cerium-zirconium-lanthanum-neodymium oxide, cerium-zirconium-yttrium-neodymium oxide, cerium-lanthanum-yttrium-neodymium oxide, or cerium-zirconium-lanthanum-yttrium-neodymium oxide. In some embodiments, the first washcoat layer and/or the second washcoat layer comprises aluminum oxide derived from boehmite. In some embodiments, the filler particles are micron-sized.

In some embodiments, the first washcoat layer comprises about 40% to about 99% by weight of the first porous carriers with embedded first composite nanoparticles. In some embodiments, the first washcoat layer comprises about 1% to about 10% by weight of the first composite nanoparticles. In some embodiments, the first washcoat layer comprises about 3% to about 20% by weight barium oxide. In some embodiments, the first washcoat layer comprises up to about 50% filler particles. In some embodiments, the first washcoat layer comprises about 3% to about 8% by weight aluminum oxide derived from boehmite. In some embodiments the first washcoat layer is coated onto the substrate at about 150 g/L to about 250 g/L. In some embodiments the first washcoat layer has a platinum group metal loading content of about 1 g/L to about 5 g/L.

In some embodiments, the coated substrate for treating gasoline engine exhaust comprises a substrate; a first washcoat layer coating the substrate comprising a first zone and a second zone, wherein the first zone comprises first composite nanoparticles embedded in first porous carriers, where the first composite nanoparticles comprise a first catalytic nanoparticle comprising platinum, palladium, or a platinum-palladium alloy bonded to a first support nanoparticle comprising aluminum oxide; and barium oxide; the second zone comprises third composite nanoparticles embedded in third porous carriers, where the third composite nanoparticles comprise a third catalytic nanoparticle comprising platinum, palladium, or a platinum-palladium alloy bonded to a third support nanoparticle comprising cerium oxide; and barium oxide; and a second washcoat layer coating the substrate comprising second metal oxide particles; and second composite nanoparticles comprising a second catalytic nanoparticle comprising rhodium bonded to a second support particle. In one embodiment, the first zone and the second zone of the first washcoat layer do not overlap. In some embodiments, the first zone of the first washcoat layer, the second zone of the first washcoat layer, and/or the second washcoat layer further comprises filler particles. In some embodiments, the filler particles comprise aluminum oxide or aluminum-lanthanum oxide. In some embodiments, the filler particles, such as the filler particles in the second washcoat layer, comprise cerium oxide. In some embodiments, the filler particles, such as the filler particles in the second washcoat layer, comprise cerium-zirconium oxide, cerium-lanthanum oxide, cerium-yttrium oxide, cerium-neodymium oxide, cerium-zirconium-lanthanum oxide, cerium-zirconium-yttrium oxide, cerium-zirconium-neodymium oxide, cerium-lanthanum-yttrium oxide, cerium-lanthanum-neodymium oxide, cerium-yttrium-neodymium oxide, cerium-zirconium-lanthanum-yttrium oxide, cerium-zirconium-lanthanum-neodymium oxide, cerium-zirconium-yttrium-neodymium oxide, cerium-lanthanum-yttrium-neodymium oxide, or cerium-zirconium-lanthanum-yttrium-neodymium oxide. In some embodiments, a portion of the second composite nanoparticles are not attached to the second metal oxide particles. In some embodiments, the first zone of the first washcoat layer, the second zone of the first washcoat layer, and/or the second washcoat layer comprises aluminum oxide derived from boehmite. In some embodiments, the first zone of the first washcoat layer comprises about 40% to about 99% by weight of the first porous carriers with embedded first composite nanoparticles. In some embodiments, the first zone of the first washcoat layer comprises about 1% to about 10% by weight of the first composite nanoparticles. In some embodiments, the first zone of the first washcoat layer comprises about 3% to about 20% by weight barium oxide. In some embodiments, the first zone of the first washcoat layer comprises up to about 50% filler particles. In some embodiments, the first zone of the first washcoat layer comprises about 3% to about 8% by weight aluminum oxide derived from boehmite. In some embodiments, the first zone of the first washcoat layer is coated onto the substrate at about 150 g/L to about 250 g/L. In some embodiments, the first zone of the first washcoat layer has a platinum group metal loading content of about 3 g/L to about 5 g/L. In some embodiments, the second zone of the first washcoat layer comprises about 40% to about 99% by weight of the third porous carriers with embedded third composite nanoparticles. In some embodiments, the second zone of the first washcoat layer comprises about 0.5% to about 3% by weight of the third composite nanoparticles. In some embodiments, the second zone of the first washcoat layer comprises about 3% to about 20% by weight barium oxide. In some embodiments, the second zone of the first washcoat layer comprises up to about 50% filler particles. In some embodiments, the second zone of the first washcoat layer comprises about 3% to about 8% by weight aluminum oxide derived from boehmite. In some embodiments, the second zone of the first washcoat layer is coated onto the substrate at about 165 g/L to about 220 g/L. In some embodiments, the second zone of the first washcoat layer has a platinum group metal loading content of about 0.5 g/L to about 1.2 g/L. In some embodiments, the first zone is about 10% to about 90% of the length of the first washcoat layer coated onto the substrate. In some embodiments, the first zone is about 25% to about 75% of the length of the first washcoat layer coated onto the substrate.

In some embodiments where second metal oxide particles are used, the second washcoat layer comprises about 45% to about 95% by weight of the second metal oxide particles. In some embodiments, the second washcoat layer comprises about 1.5% to about 5% by weight of the second composite nanoparticles. In some embodiments, the second washcoat layer comprises up to about 45% filler particles. In some embodiments, the second washcoat layer comprises about 3% to about 8% by weight aluminum oxide derived from boehmite. In some embodiments, the second washcoat layer is coated onto the substrate at about 50 g/L to about 120 g/L. In some embodiments, the second washcoat layer has a platinum group metal loading content of about 0.1 g/L to about 0.6 g/L.

In some embodiments, the coated substrate for treating gasoline engine exhaust comprises a substrate; a first washcoat layer coating the substrate comprising a first zone and a second zone, wherein the first zone comprises first composite nanoparticles embedded in first porous carriers, where the first composite nanoparticles comprise a first catalytic nanoparticle comprising platinum, palladium, or a platinum-palladium alloy bonded to a first support nanoparticle comprising aluminum oxide; and barium oxide; the second zone comprises third composite nanoparticles embedded in third porous carriers, where the third composite nanoparticles comprise a third catalytic nanoparticle comprising platinum, palladium, or a platinum-palladium alloy bonded to a third support nanoparticle comprising cerium oxide; and barium oxide; and a second washcoat layer coating the substrate comprising second composite nanoparticles embedded in second porous carriers, where the second composite nanoparticles comprise a second catalytic nanoparticle comprising rhodium bonded to a second support particle. In one embodiment, the first zone and the second zone of the first washcoat layer do not overlap. In some embodiments, the first zone of the first washcoat layer, the second zone of the first washcoat layer, and/or the second washcoat layer further comprises filler particles. In some embodiments, the filler particles comprise aluminum oxide or aluminum-lanthanum oxide. In some embodiments, the filler particles, such as the filler particles in the second washcoat layer, comprise cerium oxide. In some embodiments, the filler particles, such as the filler particles in the second washcoat layer, comprise cerium-zirconium oxide, cerium-lanthanum oxide, cerium-yttrium oxide, cerium-neodymium oxide, cerium-zirconium-lanthanum oxide, cerium-zirconium-yttrium oxide, cerium-zirconium-neodymium oxide, cerium-lanthanum-yttrium oxide, cerium-lanthanum-neodymium oxide, cerium-yttrium-neodymium oxide, cerium-zirconium-lanthanum-yttrium oxide, cerium-zirconium-lanthanum-neodymium oxide, cerium-zirconium-yttrium-neodymium oxide, cerium-lanthanum-yttrium-neodymium oxide, or cerium-zirconium-lanthanum-yttrium-neodymium oxide. In some embodiments, the first zone of the first washcoat layer, the second zone of the first washcoat layer, and/or the second washcoat layer comprises aluminum oxide derived from boehmite. In some embodiments, the first zone of the first washcoat layer comprises about 40% to about 99% by weight of the first porous carriers with embedded first composite nanoparticles. In some embodiments, the first zone of the first washcoat layer comprises about 1% to about 10% by weight of the first composite nanoparticles. In some embodiments, the first zone of the first washcoat layer comprises about 3% to about 20% by weight barium oxide. In some embodiments, the first zone of the first washcoat layer comprises up to about 50% filler particles. In some embodiments, the first zone of the first washcoat layer comprises about 3% to about 8% by weight aluminum oxide derived from boehmite. In some embodiments, the first zone of the first washcoat layer is coated onto the substrate at about 150 g/L to about 250 g/L. In some embodiments, the first zone of the first washcoat layer has a platinum group metal loading content of about 3 g/L to about 5 g/L. In some embodiments, the second zone of the first washcoat layer comprises about 40% to about 99% by weight of the third porous carriers with embedded third composite nanoparticles. In some embodiments, the second zone of the first washcoat layer comprises about 0.5% to about 3% by weight of the third composite nanoparticles. In some embodiments, the second zone of the first washcoat layer comprises about 3% to about 20% by weight barium oxide. In some embodiments, the second zone of the first washcoat layer comprises up to about 50% filler particles. In some embodiments, the second zone of the first washcoat layer comprises about 3% to about 8% by weight aluminum oxide derived from boehmite. In some embodiments, the second zone of the first washcoat layer is coated onto the substrate at about 165 g/L to about 220 g/L. In some embodiments, the second zone of the first washcoat layer has a platinum group metal loading content of about 0.5 g/L to about 1.2 g/L. In some embodiments, the first zone is about 10% to about 90% of the length of the first washcoat layer coated onto the substrate. In some embodiments, the first zone is about 25% to about 75% of the length of the first washcoat layer coated onto the substrate.

In any of the embodiments using first metal oxide particles, second metal oxide particles, and/or third metal oxide particles, the first metal oxide particles, the second metal oxide particles, and/or the third metal oxide particles can be micron-sized particles. In some embodiments, the first metal oxide particles, the second metal oxide particles, and/or the third metal oxide particles are porous. In some embodiments, the first metal oxide particles, the second metal oxide particles, and/or the third metal oxide particles comprise cerium oxide, zirconium oxide, lanthanum oxide, yttrium oxide, or a combination thereof. In some embodiments, the first metal oxide particles, the second metal oxide particles, and/or the third metal oxide particles comprise cerium-zirconium oxide, cerium-lanthanum oxide, cerium-yttrium oxide, cerium-neodymium oxide, cerium-zirconium-lanthanum oxide, cerium-zirconium-yttrium oxide, cerium-zirconium-neodymium oxide, cerium-lanthanum-yttrium oxide, cerium-lanthanum-neodymium oxide, cerium-yttrium-neodymium oxide, cerium-zirconium-lanthanum-yttrium oxide, cerium-zirconium-lanthanum-neodymium oxide, cerium-zirconium-yttrium-neodymium oxide, cerium-lanthanum-yttrium-neodymium oxide, or cerium-zirconium-lanthanum-yttrium-neodymium oxide. In some embodiments, the first metal oxide particles, the second metal oxide particles, and/or the third metal oxide particles comprise cerium-zirconium-lanthanum-yttrium oxide. In some embodiments, the second metal oxide particles comprise cerium oxide, zirconium oxide, lanthanum oxide, yttrium oxide, neodymium oxide, or a combination thereof. In some embodiments, the second metal oxide particle comprises cerium-zirconium-lanthanum-neodymium oxide. In some embodiments, the first catalytic nanoparticle and/or the third catalytic nanoparticle comprises palladium. In some embodiments, the second support nanoparticle comprises cerium oxide, zirconium oxide, lanthanum oxide, yttrium oxide, neodymium oxide, or a combination thereof. In some embodiments, the second support nanoparticle comprises cerium-zirconium-lanthanum-neodymium oxide. In some embodiments, the third support nanoparticle comprises cerium oxide, zirconium oxide, lanthanum oxide, yttrium oxide, or a combination thereof. In some embodiments, the second support nanoparticle comprises cerium-zirconium oxide, cerium-lanthanum oxide, cerium-yttrium oxide, cerium-neodymium oxide, cerium-zirconium-lanthanum oxide, cerium-zirconium-yttrium oxide, cerium-zirconium-neodymium oxide, cerium-lanthanum-yttrium oxide, cerium-lanthanum-neodymium oxide, cerium-yttrium-neodymium oxide, cerium-zirconium-lanthanum-yttrium oxide, cerium-zirconium-lanthanum-neodymium oxide, cerium-zirconium-yttrium-neodymium oxide, cerium-lanthanum-yttrium-neodymium oxide, or cerium-zirconium-lanthanum-yttrium-neodymium oxide. In some embodiments, the third support nanoparticle comprises cerium oxide. In some embodiments, the third support nanoparticle comprises cerium-zirconium oxide, cerium-lanthanum oxide, cerium-yttrium oxide, cerium-neodymium oxide, cerium-zirconium-lanthanum oxide, cerium-zirconium-yttrium oxide, cerium-zirconium-neodymium oxide, cerium-lanthanum-yttrium oxide, cerium-lanthanum-neodymium oxide, cerium-yttrium-neodymium oxide, cerium-zirconium-lanthanum-yttrium oxide, cerium-zirconium-lanthanum-neodymium oxide, cerium-zirconium-yttrium-neodymium oxide, cerium-lanthanum-yttrium-neodymium oxide, or cerium-zirconium-lanthanum-yttrium-neodymium oxide.

In some embodiments, the first composite nanoparticle comprises about 20% to about 60% by weight palladium, such as palladium nanoparticles bonded to aluminum oxide nanoparticles at a 40:60 weight ratio of palladium to metal oxide. In some embodiments, the second composite nanoparticle comprises about 5% to about 20% by weight rhodium, such as rhodium nanoparticles bonded to cerium oxide particles at a 10:90 weight ratio of rhodium to metal oxide, or rhodium nanoparticles bonded to support nanoparticles comprising cerium-zirconium oxide, cerium-lanthanum oxide, cerium-yttrium oxide, cerium-neodymium oxide, cerium-zirconium-lanthanum oxide, cerium-zirconium-yttrium oxide, cerium-zirconium-neodymium oxide, cerium-lanthanum-yttrium oxide, cerium-lanthanum-neodymium oxide, cerium-yttrium-neodymium oxide, cerium-zirconium-lanthanum-yttrium oxide, cerium-zirconium-lanthanum-neodymium oxide, cerium-zirconium-yttrium-neodymium oxide, cerium-lanthanum-yttrium-neodymium oxide, or cerium-zirconium-lanthanum-yttrium-neodymium oxide at a 10:90 weight ratio of rhodium to metal oxide. In some embodiments, the third composite nanoparticle comprises about 10% to about 50% by weight palladium. In some embodiments, the third composite nanoparticle comprises about 1% to about 50% by weight palladium. In some embodiments, the remainder of the third composite nanoparticle comprises metal oxide, such as aluminum oxide.

In some embodiments, the second metal oxide particles comprise about 1% to about 50% by weight cerium oxide. In some embodiments, the second metal oxide particles comprise about 50% to about 99% by weight zirconium oxide. In some embodiments, the second metal oxide particles comprise about 0.5% to about 5% by weight lanthanum oxide. In some embodiments, the second metal oxide particles comprise about 1% to about 15% by weight neodymium oxide.

In some embodiments, the third support nanoparticle comprises about 10% to about 70% by weight cerium oxide. In some embodiments, the third support nanoparticle comprises about 30% to about 90% by weight zirconium oxide. In some embodiments, the third support nanoparticle comprises about 1% to about 15% by weight lanthanum oxide. In some embodiments, the third support nanoparticle comprises about 1% to about 15% by weight yttrium oxide.

In some embodiments, the second support nanoparticle comprises about 1% to about 50% by weight cerium oxide. In some embodiments, the second support nanoparticle comprises about 50% to about 99% by weight zirconium oxide. In some embodiments, the second support nanoparticle comprises about 0.5% to about 5% by weight lanthanum oxide. In some embodiments, the second support nanoparticle comprises about 1% to about 15% by weight neodymium oxide.

In some embodiments, the coated substrate further comprises a corner-fill washcoat layer.

Also provided herein is a method of making a coated substrate, comprising coating a substrate with a first washcoat slurry, the first washcoat slurry comprising first metal oxide particles; first composite nanoparticles comprising a first catalytic nanoparticle comprising platinum, palladium, or a platinum-palladium alloy bonded to a first support nanoparticle comprising aluminum oxide; and a barium salt; and coating the substrate with a second washcoat slurry, the second washcoat slurry comprising second metal oxide particles; and second composite nanoparticles comprising a second catalytic nanoparticle comprising rhodium bonded to a second support particle. In some embodiments, the barium salt is barium acetate or barium sulfate. The coated substrate can be dried and calcined after coating with the first washcoat slurry, and the coated substrate can be dried and calcined after coating with the second washcoat slurry.

In some embodiments, a method of making a coated substrate, comprises coating a substrate with a first washcoat slurry in a first zone, the first washcoat slurry comprising first metal oxide particles; first composite nanoparticles comprising a first catalytic nanoparticle comprising platinum, palladium, or a platinum-palladium alloy bonded to a first support nanoparticle comprising aluminum oxide; and a barium salt; and coating the substrate with a third washcoat slurry in a second zone, the third washcoat slurry comprising third metal oxide particles; third composite nanoparticles comprising a third catalytic nanoparticle comprising platinum, palladium, or a platinum-palladium alloy bonded to a third support nanoparticle comprising cerium oxide; and a barium salt; and coating the substrate with a second washcoat slurry, the second washcoat slurry comprising second metal oxide particles; and second composite nanoparticles comprising a second catalytic nanoparticle comprising rhodium bonded to a second support particle. In some embodiments, the barium salt is barium acetate or barium sulfate. In some embodiments, the first washcoat slurry is coated onto about 10% to about 90% of the length of the substrate. In some embodiments, the first washcoat slurry is coated onto about 25% to about 75% of the length of the substrate. The coated substrate can be dried and calcined after coating with the first washcoat slurry or the third washcoat slurry, and before applying the other of the first washcoat slurry or the third washcoat slurry; or the coated substrate can be coated with the first washcoat slurry and the third washcoat slurry (in either order) and then dried and calcined. The coated substrate can be dried and calcined after coating with the second washcoat slurry.

In some embodiments, the first washcoat slurry, the second washcoat slurry, and/or the third washcoat slurry comprises boehmite. In some embodiments, the first washcoat slurry, the second washcoat slurry, and/or the third washcoat slurry comprises filler particles. In some embodiments, the filler particles comprise aluminum oxide or aluminum-lanthanum oxide.

In some embodiments, a portion of the first composite nanoparticles are not attached to the first metal oxide particles. In some embodiments, a portion of the third composite nanoparticles are not attached to the third metal oxide particles. In some embodiments, the second composite nanoparticles are attached to the second metal oxide particles. In some embodiments, a portion of the second composite nanoparticles are not attached to the second metal oxide particles.

In some embodiments, the first washcoat slurry comprises about 40% to about 90% by weight of the first metal oxide particles. In some embodiments, the first washcoat slurry comprises about 1% to about 10% by weight of the first composite nanoparticles.

In some embodiments, the first washcoat slurry or the third washcoat slurry comprises about 3% to about 20% by weight barium salt.

In some embodiments, the first washcoat slurry or the third washcoat slurry comprises up to about 40% filler particles. In some embodiments, the first washcoat slurry or the third washcoat slurry comprises up to about 70% filler particles. In some embodiments, the second washcoat slurry comprises up to about 45% filler particles. In some embodiments, the second washcoat slurry comprises up to about 70% filler particles.

In some embodiments, the first washcoat slurry, the second washcoat slurry, or the third washcoat slurry comprises about 3% to about 8% by weight aluminum oxide derived from boehmite. In some embodiments, the third washcoat slurry comprises about 0.5% to about 3% by weight of the third composite nanoparticles. In some embodiments, the second washcoat slurry comprises about 45% to about 95% by weight of the second metal oxide particles. In some embodiments, the second washcoat slurry comprises about 1.5% to about 5% by weight of the second composite nanoparticles.

In some embodiments, the first metal oxide particles, the second metal oxide particles, or the third metal oxide particles are micron-sized particles. In some embodiments, the first metal oxide particles, the second metal oxide particles, or the third metal oxide particles are porous. In some embodiments, the first metal oxide particles, the second metal oxide particles, or the third metal oxide particles comprise cerium oxide, zirconium oxide, lanthanum oxide, yttrium oxide, or a combination thereof. In some embodiments, the second metal oxide particles, or the third metal oxide particles comprise cerium-zirconium-lanthanum-yttrium oxide. In some embodiments, the second metal oxide particles comprise cerium oxide, zirconium oxide, lanthanum oxide, yttrium oxide, neodymium oxide, or a combination thereof. In some embodiments, the second metal oxide particle comprises cerium-zirconium-lanthanum-neodymium oxide. In some embodiments, the first catalytic nanoparticle or the third catalytic nanoparticle comprises palladium. In some embodiments, the second support nanoparticle comprises cerium oxide, zirconium oxide, lanthanum oxide, yttrium oxide, neodymium oxide, or a combination thereof. In some embodiments, the second support nanoparticle comprises cerium-zirconium-lanthanum-neodymium oxide. In some embodiments, the third support nanoparticle comprises cerium oxide, zirconium oxide, lanthanum oxide, yttrium oxide, or a combination thereof. In some embodiments, the third support nanoparticle comprises cerium oxide.

In some embodiments, the first composite nanoparticle comprises about 20% to about 60% by weight palladium. In some embodiments, the second composite nanoparticle comprises about 5% to about 20% by weight rhodium. In some embodiments, the third composite nanoparticle comprises about 10% to about 50% by weight palladium. In some embodiments, the third composite nanoparticle comprises about 1% to about 50% by weight palladium.

In some embodiments, the first metal oxide particles comprise about 10% to about 70% by weight cerium oxide. In some embodiments, the first metal oxide particles comprise about 30% to about 90% by weight zirconium oxide. In some embodiments, the first metal oxide particles comprise about 1% to about 15% by weight lanthanum oxide. In some embodiments, the first metal oxide particles comprise about 1% to about 15% by weight yttrium oxide.

In some embodiments, the third metal oxide particles comprise about 10% to about 70% by weight cerium oxide. In some embodiments, the third metal oxide particles comprise about 30% to about 90% by weight zirconium oxide. In some embodiments, the third metal oxide particles comprise about 1% to about 15% by weight lanthanum oxide. In some embodiments, the third metal oxide particles comprise about 1% to about 15% by weight yttrium oxide.

In some embodiments, the second metal oxide particles comprise about 1% to about 50% by weight cerium oxide. In some embodiments, the second metal oxide particles comprise about 50% to about 99% by weight zirconium oxide. In some embodiments, the second metal oxide particles comprise about 0.5% to about 5% by weight lanthanum oxide. In some embodiments, the second metal oxide particles comprise about 1% to about 15% by weight neodymium oxide.

In some embodiments, the third support nanoparticle comprises about 10% to about 70% by weight cerium oxide. In some embodiments, the third support nanoparticle comprises about 30% to about 90% by weight zirconium oxide. In some embodiments, the third support nanoparticle comprises about 1% to about 15% by weight lanthanum oxide. In some embodiments, the third support nanoparticle comprises about 1% to about 15% by weight yttrium oxide.

In some embodiments, the second support nanoparticle comprises about 1% to about 50% by weight cerium oxide. In some embodiments, the second support nanoparticle comprises about 50% to about 99% by weight zirconium oxide. In some embodiments, the second support nanoparticle comprises about 0.5% to about 5% by weight lanthanum oxide. In some embodiments, the second support nanoparticle comprises about 1% to about 15% by weight neodymium oxide.

Also provided herein is a method of making a coated substrate, comprising coating a substrate with a first washcoat slurry, the first washcoat slurry comprising first composite nanoparticles embedded in first porous carriers, where the first composite nanoparticles comprise a first catalytic nanoparticle comprising platinum, palladium, or a platinum-palladium alloy bonded to a first support nanoparticle comprising aluminum oxide; and a barium salt; and coating the substrate with a second washcoat slurry, the second washcoat slurry comprising second metal oxide particles; and second composite nanoparticles comprising a second catalytic nanoparticle comprising rhodium bonded to a second support particle. In some embodiments, the barium salt is barium acetate or barium sulfate. The coated substrate can be dried and calcined after coating with the first washcoat slurry, and the coated substrate can be dried and calcined after coating with the second washcoat slurry.

Also provided herein is a method of making a coated substrate, comprising coating a substrate with a first washcoat slurry, the first washcoat slurry comprising first metal oxide particles; first composite nanoparticles comprising a first catalytic nanoparticle comprising platinum, palladium, or a platinum-palladium alloy bonded to a first support nanoparticle comprising aluminum oxide; and a barium salt; and coating the substrate with a second washcoat slurry, the second washcoat slurry comprising second composite nanoparticles embedded in second porous carriers, where the second composite nanoparticles comprise a second catalytic nanoparticle comprising rhodium bonded to a second support particle. In some embodiments, the barium salt is barium acetate or barium sulfate. The coated substrate can be dried and calcined after coating with the first washcoat slurry, and the coated substrate can be dried and calcined after coating with the second washcoat slurry.

Also provided herein is a method of making a coated substrate, comprising coating a substrate with a first washcoat slurry, the first washcoat slurry comprising first composite nanoparticles embedded in first porous carriers, where the first composite nanoparticles comprise a first catalytic nanoparticle comprising platinum, palladium, or a platinum-palladium alloy bonded to a first support nanoparticle comprising aluminum oxide; and a barium salt; and coating the substrate with a second washcoat slurry, the second washcoat slurry comprising second composite nanoparticles embedded in second porous carriers, where the second composite nanoparticles comprise a second catalytic nanoparticle comprising rhodium bonded to a second support particle. In some embodiments, the barium salt is barium acetate or barium sulfate. The coated substrate can be dried and calcined after coating with the first washcoat slurry, and the coated substrate can be dried and calcined after coating with the second washcoat slurry.

In some embodiments, a method of making a coated substrate, comprises coating a substrate with a first washcoat slurry in a first zone, the first washcoat slurry comprising first composite nanoparticles embedded in first porous carriers, where the first composite nanoparticles comprise a first catalytic nanoparticle comprising platinum, palladium, or a platinum-palladium alloy bonded to a first support nanoparticle comprising aluminum oxide; and a barium salt; and coating the substrate with a third washcoat slurry in a second zone, the third washcoat slurry comprising third composite nanoparticles embedded in third porous carriers, where the third composite nanoparticles comprise a third catalytic nanoparticle comprising platinum, palladium, or a platinum-palladium alloy bonded to a third support nanoparticle comprising cerium oxide; and a barium salt; and coating the substrate with a second washcoat slurry, the second washcoat slurry comprising second metal oxide particles; and second composite nanoparticles comprising a second catalytic nanoparticle comprising rhodium bonded to a second support particle. In some embodiments, the barium salt is barium acetate or barium sulfate. In some embodiments, the first washcoat slurry is coated onto about 10% to about 90% of the length of the substrate. In some embodiments, the first washcoat slurry is coated onto about 25% to about 75% of the length of the substrate. The coated substrate can be dried and calcined after coating with the first washcoat slurry or the third washcoat slurry, and before applying the other of the first washcoat slurry or the third washcoat slurry; or the coated substrate can be coated with the first washcoat slurry and the third washcoat slurry (in either order) and then dried and calcined. The coated substrate can be dried and calcined after coating with the second washcoat slurry.

In some embodiments, a method of making a coated substrate, comprises coating a substrate with a first washcoat slurry in a first zone, the first washcoat slurry comprising first composite nanoparticles embedded in first porous carriers, where the first composite nanoparticles comprise a first catalytic nanoparticle comprising platinum, palladium, or a platinum-palladium alloy bonded to a first support nanoparticle comprising aluminum oxide; and a barium salt; and coating the substrate with a third washcoat slurry in a second zone, the third washcoat slurry comprising third composite nanoparticles embedded in third porous carriers, where the third composite nanoparticles comprise a third catalytic nanoparticle comprising platinum, palladium, or a platinum-palladium alloy bonded to a third support nanoparticle comprising cerium oxide; and a barium salt; and coating the substrate with a second washcoat slurry, the second washcoat slurry comprising second composite nanoparticles embedded in second porous carriers, where the second composite nanoparticles comprise a second catalytic nanoparticle comprising rhodium bonded to a second support particle. In some embodiments, the barium salt is barium acetate or barium sulfate. In some embodiments, the first washcoat slurry is coated onto about 10% to about 90% of the length of the substrate. In some embodiments, the first washcoat slurry is coated onto about 25% to about 75% of the length of the substrate. The coated substrate can be dried and calcined after coating with the first washcoat slurry or the third washcoat slurry, and before applying the other of the first washcoat slurry or the third washcoat slurry; or the coated substrate can be coated with the first washcoat slurry and the third washcoat slurry (in either order) and then dried and calcined. The coated substrate can be dried and calcined after coating with the second washcoat slurry.

In some embodiments, the first washcoat slurry, the second washcoat slurry, and/or the third washcoat slurry comprises boehmite. In some embodiments, the first washcoat slurry, the second washcoat slurry, and/or the third washcoat slurry comprises filler particles. In some embodiments, the filler particles comprise aluminum oxide or aluminum-lanthanum oxide. In some embodiments, the filler particles, such as the filler particles in the second washcoat layer, comprise cerium oxide, cerium-zirconium oxide, cerium-lanthanum oxide, cerium-yttrium oxide, cerium-neodymium oxide, cerium-zirconium-lanthanum oxide, cerium-zirconium-yttrium oxide, cerium-zirconium-neodymium oxide, cerium-lanthanum-yttrium oxide, cerium-lanthanum-neodymium oxide, cerium-yttrium-neodymium oxide, cerium-zirconium-lanthanum-yttrium oxide, cerium-zirconium-lanthanum-neodymium oxide, cerium-zirconium-yttrium-neodymium oxide, cerium-lanthanum-yttrium-neodymium oxide, or cerium-zirconium-lanthanum-yttrium-neodymium oxide.

In some embodiments, where first metal oxide particles are used, a portion of the first composite nanoparticles are not attached to the first metal oxide particles. In some embodiments, where third metal oxide particles are used, a portion of the third composite nanoparticles are not attached to the third metal oxide particles. In some embodiments, where second metal oxide particles are used, the second composite nanoparticles are attached to the second metal oxide particles. In some embodiments, where second metal oxide particles are used, a portion of the second composite nanoparticles are not attached to the second metal oxide particles.

In some embodiments, the first washcoat slurry comprises about 40% to about 90% by weight of the first metal oxide particles. In some embodiments, the first washcoat slurry comprises about 1% to about 10% by weight of the first composite nanoparticles.

In some embodiments, the first washcoat slurry or the third washcoat slurry comprises about 3% to about 20% by weight barium salt.

In some embodiments, the first washcoat slurry or the third washcoat slurry comprises up to about 40% filler particles. In some embodiments, the first washcoat slurry or the third washcoat slurry comprises up to about 70% filler particles. In some embodiments, the second washcoat slurry comprises up to about 45% filler particles. In some embodiments, the second washcoat slurry comprises up to about 70% filler particles.

In some embodiments, the first washcoat slurry, the second washcoat slurry, or the third washcoat slurry comprises about 3% to about 8% by weight aluminum oxide derived from boehmite. In some embodiments, the third washcoat slurry comprises about 0.5% to about 3% by weight of the third composite nanoparticles. In some embodiments, where second metal oxide particles are used, the second washcoat slurry comprises about 45% to about 95% by weight of the second metal oxide particles. In some embodiments, the second washcoat slurry comprises about 1.5% to about 5% by weight of the second composite nanoparticles.

In some embodiments, where first metal oxide particles, second metal oxide particles, and/or third metal oxide particles are used, the first metal oxide particles, the second metal oxide particles, and/or the third metal oxide particles are micron-sized particles. In some embodiments, the first metal oxide particles, the second metal oxide particles, and/or the third metal oxide particles are porous. In some embodiments, the first metal oxide particles, the second metal oxide particles, and/or the third metal oxide particles comprise cerium oxide, zirconium oxide, lanthanum oxide, yttrium oxide, or a combination thereof. In some embodiments, the first metal oxide particles, the second metal oxide particles, and/or the third metal oxide particles comprise cerium oxide, cerium-zirconium oxide, cerium-lanthanum oxide, cerium-yttrium oxide, cerium-neodymium oxide, cerium-zirconium-lanthanum oxide, cerium-zirconium-yttrium oxide, cerium-zirconium-neodymium oxide, cerium-lanthanum-yttrium oxide, cerium-lanthanum-neodymium oxide, cerium-yttrium-neodymium oxide, cerium-zirconium-lanthanum-yttrium oxide, cerium-zirconium-lanthanum-neodymium oxide, cerium-zirconium-yttrium-neodymium oxide, cerium-lanthanum-yttrium-neodymium oxide, or cerium-zirconium-lanthanum-yttrium-neodymium oxide. In some embodiments, the first metal oxide particles, the second metal oxide particles, and/or the third metal oxide particles comprise cerium-zirconium-lanthanum-yttrium oxide. In some embodiments, the second metal oxide particles comprise cerium oxide, zirconium oxide, lanthanum oxide, yttrium oxide, neodymium oxide, or a combination thereof. In some embodiments, the second metal oxide particles comprise cerium oxide, cerium-zirconium oxide, cerium-lanthanum oxide, cerium-yttrium oxide, cerium-neodymium oxide, cerium-zirconium-lanthanum oxide, cerium-zirconium-yttrium oxide, cerium-zirconium-neodymium oxide, cerium-lanthanum-yttrium oxide, cerium-lanthanum-neodymium oxide, cerium-yttrium-neodymium oxide, cerium-zirconium-lanthanum-yttrium oxide, cerium-zirconium-lanthanum-neodymium oxide, cerium-zirconium-yttrium-neodymium oxide, cerium-lanthanum-yttrium-neodymium oxide, or cerium-zirconium-lanthanum-yttrium-neodymium oxide. In some embodiments, the second metal oxide particle comprises cerium-zirconium-lanthanum-neodymium oxide. In some embodiments, the first catalytic nanoparticle and/or the third catalytic nanoparticle comprises palladium. In some embodiments, the second support nanoparticle comprises cerium oxide, zirconium oxide, lanthanum oxide, yttrium oxide, neodymium oxide, or a combination thereof. In some embodiments, the second support nanoparticle comprises cerium oxide, cerium-zirconium oxide, cerium-lanthanum oxide, cerium-yttrium oxide, cerium-neodymium oxide, cerium-zirconium-lanthanum oxide, cerium-zirconium-yttrium oxide, cerium-zirconium-neodymium oxide, cerium-lanthanum-yttrium oxide, cerium-lanthanum-neodymium oxide, cerium-yttrium-neodymium oxide, cerium-zirconium-lanthanum-yttrium oxide, cerium-zirconium-lanthanum-neodymium oxide, cerium-zirconium-yttrium-neodymium oxide, cerium-lanthanum-yttrium-neodymium oxide, or cerium-zirconium-lanthanum-yttrium-neodymium oxide. In some embodiments, the second support nanoparticle comprises cerium-zirconium-lanthanum-neodymium oxide. In some embodiments, the third support nanoparticle comprises cerium oxide, zirconium oxide, lanthanum oxide, yttrium oxide, or a combination thereof. In some embodiments, the third support nanoparticle comprises cerium oxide.

In some embodiments, the first composite nanoparticle comprises about 20% to about 60% by weight palladium. In some embodiments, the second composite nanoparticle comprises about 5% to about 20% by weight rhodium. In some embodiments, the third composite nanoparticle comprises about 10% to about 50% by weight palladium. In some embodiments, the third composite nanoparticle comprises about 1% to about 50% by weight palladium.

In some embodiments, the first metal oxide particles comprise about 10% to about 70% by weight cerium oxide. In some embodiments, the first metal oxide particles comprise about 30% to about 90% by weight zirconium oxide. In some embodiments, the first metal oxide particles comprise about 1% to about 15% by weight lanthanum oxide. In some embodiments, the first metal oxide particles comprise about 1% to about 15% by weight yttrium oxide.

In some embodiments, the third metal oxide particles comprise about 10% to about 70% by weight cerium oxide. In some embodiments, the third metal oxide particles comprise about 30% to about 90% by weight zirconium oxide. In some embodiments, the third metal oxide particles comprise about 1% to about 15% by weight lanthanum oxide. In some embodiments, the third metal oxide particles comprise about 1% to about 15% by weight yttrium oxide.

In some embodiments, the second metal oxide particles comprise about 1% to about 50% by weight cerium oxide. In some embodiments, the second metal oxide particles comprise about 50% to about 99% by weight zirconium oxide. In some embodiments, the second metal oxide particles comprise about 0.5% to about 5% by weight lanthanum oxide. In some embodiments, the second metal oxide particles comprise about 1% to about 15% by weight neodymium oxide.

In some embodiments, the third support nanoparticle comprises about 10% to about 70% by weight cerium oxide. In some embodiments, the third support nanoparticle comprises about 30% to about 90% by weight zirconium oxide. In some embodiments, the third support nanoparticle comprises about 1% to about 15% by weight lanthanum oxide. In some embodiments, the third support nanoparticle comprises about 1% to about 15% by weight yttrium oxide.

In some embodiments, the second support nanoparticle comprises about 1% to about 50% by weight cerium oxide. In some embodiments, the second support nanoparticle comprises about 50% to about 99% by weight zirconium oxide. In some embodiments, the second support nanoparticle comprises about 0.5% to about 5% by weight lanthanum oxide. In some embodiments, the second support nanoparticle comprises about 1% to about 15% by weight neodymium oxide.

Further provide herein is a coated substrate made according to any one of the described methods. Also provided is a catalytic converter comprising a coated substrate described herein, wherein the substrate is disposed such that the exhaust gas contacts the first zone prior to the second zone if the first zone and the second zone are present. Further described is an exhaust system comprising the catalytic converter described herein and a conduit for exhaust gas.

In some embodiments, there is a method of treating exhaust gases from a gasoline engine with the described catalytic converter, comprising passing the exhaust gases through the catalytic converter.

In some embodiments, there is a vehicle comprising the described catalytic converter. In some embodiments, the vehicle comprises a gasoline-powered engine.

In some embodiments, there is a gasoline-powered generator comprising the described catalytic converter.

### BRIEF DESCRIPTION OF THE DRAWINGS

FIG. 1A illustrates a schematic of an exemplary coated substrate with a first washcoat layer and a second washcoat layer.

FIG. 1B illustrates a schematic of an exemplary coated substrate with a first washcoat layer and a second washcoat layer, wherein the first washcoat layer has a first zone and a second zone. The arrow in the figure indicates the direction of exhaust flow.

FIG. 2 illustrates a schematic of another exemplary coated substrate with a first washcoat layer and a second washcoat layer, wherein the first washcoat layer has a first zone and a second zone.

FIG. 3A illustrates a catalytic converter with a coated substrate inside of a housing.

FIG. 3B provides a close-up view of the substrate

FIG. 4 presents the total hydrocarbons (THC), carbon monoxide (CO), and nitrogen oxides (NOₓ) in the feedgas (in total grams) when testing the catalytic efficiency of a commercially-available reference catalytic converter, an exemplary catalytic converter with a two-layer coated substrate of the present invention, and an exemplary catalytic converter with a two-layer coated substrate, wherein the first layer has two zones, of the present invention.

FIG. 5 presents average tailpipe emissions (g/km) from the commercially-available reference catalytic converter, the exemplary catalytic converter with a two-layer coated substrate of the present invention, and the exemplary catalytic converter with a two-layer coated substrate, wherein the first layer has two zones, of the present invention. Shown in FIG. 5 are the non-methane hydrocarbon (NMHC) emissions, total hydrocarbon (THC) emissions, carbon monoxide (CO) emissions, and nitrogen oxide (NOₓ) emissions.

FIG. 6 presents average tailpipe carbon dioxide (CO₂) emissions (g/km) from the commercially-available reference catalytic converter, the exemplary catalytic converter with a two-layer coated substrate of the present invention, and the exemplary catalytic converter with a two-layer coated substrate, wherein the first layer has two zones, of the present invention.

### DETAILED DESCRIPTION OF THE INVENTION

Provided herein are coated substrates useful for treating gasoline engine exhaust and catalytic converter comprising the coated substrates. Further provided are vehicles comprising the catalytic converters and methods of treating exhaust gas by using the catalytic converters.

Exhaust gas comprising carbon monoxide, hydrocarbons, and nitrogen oxides contacts the catalytic components in the washcoat layers of the coated substrates. Additional components in the washcoat layers, such as barium oxide or metal oxide particles are included in certain washcoat layers to provide storage of the nitrogen oxide or oxygen during the oscillating rich and lean cycles of the gasoline engine to provide optimized exhaust gas treatment while minimizing the amount of platinum group metal loading required by the coated substrate. The configurations described herein efficiently reduce nitrogen oxide and oxidize hydrocarbons and carbon monoxide present in gasoline engine exhaust.

In some embodiments, the coated substrate comprises two washcoat layers, the first washcoat layer comprising (1) composite nanoparticles comprising a catalytic nanoparticle comprising palladium bonded to a support nanoparticle comprising aluminum oxide, (2) micron-sized metal oxide particles, and (3) barium oxide; and the second washcoat layer comprising (1) composite nanoparticles comprising a catalytic nanoparticle comprising rhodium bonded to a support nanoparticle comprising a metal oxide, and (2) micron-sized metal oxide particles.

In some embodiments, the coated substrate comprises two washcoat layers, the first washcoat layer comprising a first zone and a second zone, the first zone comprising (1) composite nanoparticles comprising a catalytic nanoparticle comprising palladium bonded to a support nanoparticle comprising aluminum oxide, (2) micron sized metal oxide particles, and (3) barium oxide; the second zone comprising (1) composite nanoparticles comprising a catalytic nanoparticle comprising palladium bonded to a support nanoparticle comprising a metal oxide, (2) micron sized metal oxide particles, and (3) barium oxide; and the second washcoat layer comprising (1) composite nanoparticles comprising a catalytic nanoparticle comprising rhodium bonded to a support nanoparticle comprising a metal oxide, and (2) micron-sized metal oxide particles.

The metal oxide of the support nanoparticle or the metal oxide particles may be a metal oxide of cerium oxide, zirconium oxide, lanthanum oxide, yttrium oxide, neodymium oxide, or a combination thereof, such as a composite metal oxide of any one of cerium oxide, zirconium oxide, lanthanum oxide, yttrium oxide, and neodymium oxide, as detailed herein. For example, in some embodiments, the metal oxide particles in the first washcoat layer are composite cerium-zirconium metal oxide (CrₓZr_{y}O_{z}) or composite cerium-zirconium-yttrium-lanthanum oxide (CrᵥZr_{w}YₓLa_{y}O_{z}). Metal oxides which comprise two or more metallic elements combined with oxygen are frequently referred to as mixed metal oxides.

### Definitions

When numerical values are expressed herein using the term “about” or the term “approximately,” it is understood that both the value specified, as well as values reasonably close to the value specified, are included. For example, the description “about 50° C.” or “approximately 50° C.” includes both the disclosure of 50° C. itself, as well as values close to 50° C. Thus, the phrases “about X” or “approximately X” include a description of the value X itself. If a range is indicated, such as “approximately 50° C. to 60° C.,” it is understood that both the values specified by the endpoints are included, and that values close to each endpoint or both endpoints are included for each endpoint or both endpoints; that is, “approximately 50° C. to 60° C.” is equivalent to reciting both “50° C. to 60° C.” and “approximately 50° C. to approximately 60° C.”

As used herein, the singular forms “a,” “an,” and “the” include the plural reference unless the context clearly dictates otherwise.

The term “at least one of A or B” refers to item A alone, item B alone, or item A and item B together. For lists with more than two elements, “at least one of” the list of elements refers to each element alone, any possible sub-combination of elements, and all elements together (that is, “at least one of A, B, or C” refers to A alone; B alone; C alone; A and B; A and C; B and C; and A, B, and C). The term “and/or” used in a list of elements has an equivalent meaning to “at least one of” a list of elements (that is, “A, B, and/or C” refers to A alone; B alone; C alone; A and B; A and C; B and C; and A, B, and C).

The unit of measure g/L,” “g/l,” or “grams per liter” is used herein as a measure of density of a substance in terms of the mass of the substance in any given volume containing that substance. In some embodiments, the “g/l” or g/L is used to refer to the loading density of a substance into, for example, a coated substrate. For example, in some embodiments, “4.0 g/L platinum” refers to the loading of 4.0 grams of platinum into each liter of a coated substrate. Similarly, in some embodiments, “30 g/L metal oxide” refers to the loading of 30 grams of a metal oxide into each liter of a coated substrate.

The terms “micro-particle,” “micro-sized particle,” “micron-particle,” and “micron-sized particle” are generally understood to encompass a particle on the order of micrometers in diameter, typically between about 0.5 μm to 1000 μm, about 1 μm to 1000 μm, about 1 μm to 100 μm, or about 1 μm to 50 μm.

The term “platinum group metals” (abbreviated “PGM”) used in this disclosure refers to the collective name used for six metallic elements clustered together in the periodic table. The six platinum group metals are ruthenium, rhodium, palladium, osmium, iridium, and platinum.

A “portion” of a material is understood to mean at least some of the material and, in some embodiments, may include all of that material. In some embodiments, a “portion” of a material may include more than 0% of the material, more than about 10% of the material, more than about 20% of the material, more than about 30% of the material, more than about 40% of the material, more than about 50% of the material, more than about 60% of the material, more than about 70% of the material, more than about 80% of the material, or more than about 90% of the material. In some embodiments, a “portion” of a material may include a range from more than 0% to about 10%, a range from more than 0% to about 20%, a range from more than 0% to about 30%, a range from more than 0% to about 40%, a range from more than 0% to about 50%, a range from more than 0% to about 60%, a range from more than 0% to about 70%, a range from more than 0% to about 80%, a range from more than 0% to about 90%, or a range from more than 0% to about 100% of the material.

This disclosure refers to both particles and powders. These two terms are equivalent, except for the caveat that a singular “powder” refers to a collection of particles. The present invention can apply to a wide variety of powders and particles.

The terms “nanoparticle” and “nano-sized particle” are generally understood by those of ordinary skill in the art to encompass a particle on the order of nanometers in diameter, typically between about 0.5 nm to 500 nm, about 1 nm to 500 nm, about 1 nm to 100 nm, or about 1 nm to 50 nm. Preferably, the nanoparticles have an average grain size less than 250 nanometers. In some embodiments, the nanoparticles have an average grain size of about 50 nm or less, about 30 nm or less, or about 20 nm or less. In additional embodiments, the nanoparticles have an average diameter of about 50 nm or less, about 30 nm or less, or about 20 nm or less. The aspect ratio of the particles, defined as the longest dimension of the particle divided by the shortest dimension of the particle, is preferably between one and one hundred, more preferably between one and ten, yet more preferably between one and two. “Grain size” is measured using the ASTM (American Society for Testing and Materials) standard (see ASTM E112-10). When calculating a diameter of a particle, the average of its longest and shortest dimension is taken; thus, the diameter of an ovoid particle with long axis 20 nm and short axis 10 nm would be 15 nm. The average diameter of a population of particles is the average of diameters of the individual particles, and can be measured by various techniques known to those of skill in the art.

By “substantially free of” a specific component, a specific composition, a specific compound, or a specific ingredient in various embodiments, is meant that less than about 5%, less than about 2%, less than about 1%, less than about 0.5%, less than about 0.1%, less than about 0.05%, less than about 0.025%, or less than about 0.01% of the specific component, the specific composition, the specific compound, or the specific ingredient is present by weight. Preferably, “substantially free of” a specific component, a specific composition, a specific compound, or a specific ingredient indicates that less than about 1% of the specific component, the specific composition, the specific compound, or the specific ingredient is present by weight.

It should be noted that, during fabrication or during operation (particularly over long periods of time), small amounts of materials present in one washcoat layer may diffuse, migrate, or otherwise move into other washcoat layers. Accordingly, use of the terms “substantial absence of” and “substantially free of” is not to be construed as absolutely excluding minor amounts of the materials referenced.

By “substantially each” of a specific component, a specific composition, a specific compound, or a specific ingredient in various embodiments, is meant that at least about 95%, at least about 98%, at least about 99%, at least about 99.5%, at least about 99.9%, at least about 99.95%, at least about 99.975%, or at least about 99.99% of the specific component, the specific composition, the specific compound, or the specific ingredient is present by number or by weight. Preferably, “substantially each” of a specific component, a specific composition, a specific compound, or a specific ingredient is meant that at least about 99% of the specific component, the specific composition, the specific compound, or the specific ingredient is present by number or by weight.

It is understood that reference to relative weight percentages in a composition assumes that the combined total weight percentages of all components in the composition add up to 100. It is further understood that relative weight percentages of one or more components may be adjusted upwards or downwards such that the weight percent of the components in the composition combine to a total of 100, provided that the weight percent of any particular component does not fall outside the limits of the range specified for that component.

With respect to numerical ranges disclosed in the present description, any disclosed upper limit for a component may be combined with any disclosed lower limit for that component to provide a range (provided that the upper limit is greater than the lower limit with which it is to be combined). Each of these combinations of disclosed upper and lower limits are explicitly envisaged herein. For example, if ranges for the amount of a particular component are given as 10% to 30%, 10% to 12%, and 15% to 20%, the ranges 10% to 20% and 15% to 30% are also envisaged, whereas the combination of a 15% lower limit and a 12% upper limit is not possible and hence is not envisaged.

With respect to numerical values disclosed in the present description, any two disclosed individual values for a component may be combined to provide a range for that component, with the lower of the two values forming the lower limit and the higher of the two values forming the upper limit. Each and every combination of values are explicitly envisaged herein. For example, if values for the amount of a particular component are given as 7%, 25%, and 35%, the ranges 7% to 35%, 7% to 25%, and 25% to 35% for that component are also envisaged.

“Treating” an exhaust gas, such as the exhaust gas from a gasoline engine, refers to having the exhaust gas proceed through an exhaust system (exhaust treatment system) prior to release into the environment, in order to reduce the amount of harmful gases, such as unburned hydrocarbons, carbon monoxide, or nitrogen oxides present in the exhaust gas.

The term “washcoat composition” or “washcoat formulation” as used herein is used to refer to a washcoat slurry or a washcoat layer. A washcoat slurry may comprise solids or salts suspended or dissolved in a liquid. The washcoat slurry may be coated onto a substrate, dried, and calcined. A “washcoat layer” generally refers to a washcoat composition coated onto a substrate, for example after the washcoat composition has been applied to a substrate, dried, and calcined.

Percentages by weight of any material in a washcoat slurry are used to refer to the weight percent of that material of the solids content of the washcoat slurry, and would exclude any liquid content. For the purposes of calculating weight percentages in a washcoat slurry, salts dissolved in a liquid would be considered a solid.

### Coated Substrates

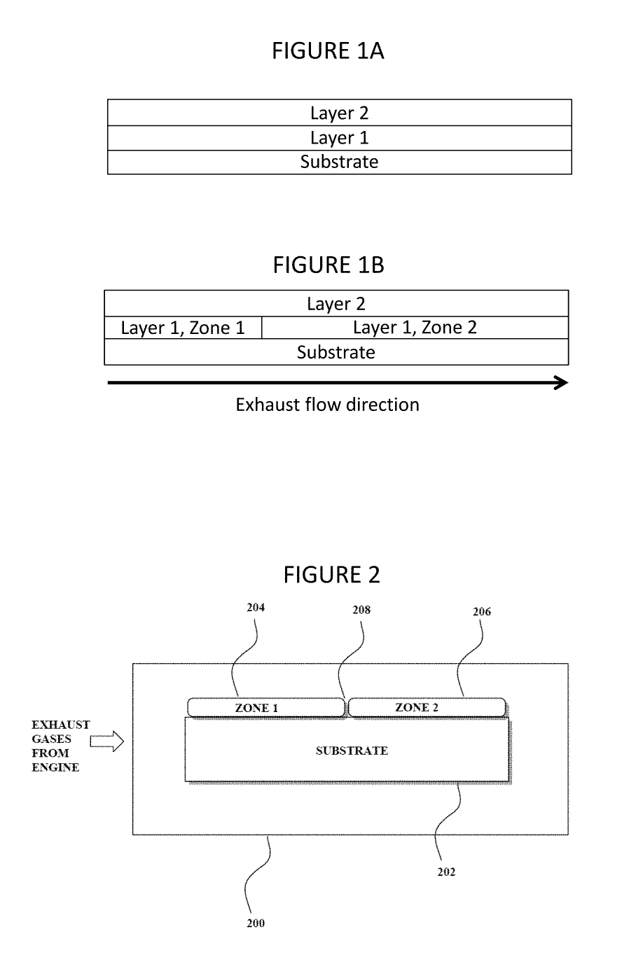

Substrates coated with one or more washcoat layers are useful for the catalytic converters and exhaust systems described herein. In some embodiments, the substrates are coated with the one or more washcoat layers by applying a washcoat slurry, drying the substrate with the applied washcoat composition, and calcining the substrate with the applied washcoat composition. In some embodiment, the coated substrate comprises a first washcoat layer and a second washcoat layer, as illustrated in FIG. 1A. In some embodiments, one or more layers are divided into two or more laterally disposed zone, each zone comprising a separate washcoat composition. For example, in some embodiments, a substrate is coated with a first washcoat layer and a second washcoat layer, wherein the first washcoat layer comprises a first zone and a second zone. This configuration is illustrated in FIG. 1B. In some embodiments, the compositions described herein as useful for the first zone of the first washcoat layer are used for the entire first washcoat layer.

In some embodiments, the coated substrates described herein are used to treat exhaust gas and minimize tailpipe emissions from a vehicle. Additionally, the coated substrate architectures (two-layer coated substrate or two-layer coated substrates, wherein the first washcoat layer comprises a first zone and a second zone) minimize the amount of platinum group metal (such as palladium, platinum, and rhodium) in the coated substrate. Generally, the coated substrates comprise rhodium in the second washcoat layer and palladium and/or platinum in the first washcoat layer. In some embodiments, the coated substrate comprises about 1.5 g/L to about 3.5 g/L platinum group metal (such as about 1.5 g/L to about 2.4 g/L platinum group metal, about 1.8 g/L to about 2.7 g/L platinum group metal, about 2.1 g/L to about 3.3 g/L platinum group metal, or about 2.4 g/L to about 3.5 g/L platinum group metal). In some embodiments, the coated substrate comprises about 1.2 g/L to about 3.3 g/L palladium (such as about 1.2 g/L to about 2.1 g/L palladium, about 1.5 g/L to about 2.4 g/L palladium, about 1.8 g/L to about 2.7 g/L palladium, about 2.1 g/L to about 3.0 g/L palladium, or about 2.4 g/L to about 3.3 g/L palladium). In some embodiments, the palladium in the coated substrate is present in the first washcoat layer, and may be unevenly distributed in the first zone and the second zone of the first washcoat layer. In some embodiments, the coated substrate comprises about 0.1 g/L to about 0.6 g/L rhodium (such as about 0.1 g/L to about 0.3 g/L rhodium, about 0.2 g/L to about 0.4 g/L rhodium, about 0.3 g/L to about 0.5 g/L rhodium, or about 0.4 g/L to about 0.6 g/L rhodium).

The initial substrate is preferably a catalytic converter substrate that demonstrates good thermal stability, including resistance to thermal shock, and to which the described washcoats can be affixed in a stable manner. Suitable substrates include, but are not limited to, substrates formed from cordierite or other ceramic materials, and substrates formed from metal. The substrates may be a honeycomb structure or any other structure that provides numerous channels and results in a high surface area. The high surface area of the coated substrate with its applied washcoats in the catalytic converter provides for effective treatment of the exhaust gas flowing through the catalytic converter.

In some embodiments, a corner-fill washcoat layer, buffer washcoat layer, or adhesion washcoat layer, may be applied to the substrate prior to applying any of the active layers, but is not required. It should be noted that, in some embodiments, additional washcoat layers can be disposed under, over, or between any of the washcoat layers indicated in these basic configurations; that is, further washcoat layers can be present on the catalytic converter substrate in addition to the ones listed in the configurations above. For example, in any embodiment a corner fill washcoat layer may be included as the first coating layer. In other embodiments, additional washcoat layers are not applied; that is, the washcoats listed in the configurations above are the only washcoats present on the catalytic converter substrate.

Washcoat slurries are generally prepared by suspending the designated materials in an aqueous solution. In some embodiments, the resulting suspension may comprise about 1% to about 30% solids content, about 2% to about 20% solids content, or about 5% to about 10% solids content. In some embodiments, the resulting suspension may comprise more than about 30% solids content or less than about 1% solids content. The pH may be adjusted to between about 3 and about 7, to between about 4 and about 5.75, or to about 5 by adding an acid, for example acetic acid, or a base, for example sodium hydroxide. In some embodiments, the washcoat slurry may be milled to arrive at an average particle size of less than 4 μm, less than 10 μm, less than 15 μm, or between about 4 μm and 15 μm. In some embodiments, the washcoat slurry is aged for about 24 hours to about 48 hours after adjusting the viscosity of the washcoat by adding thickening agent such as cellulose, cornstarch, or other thickeners, to a value between about 300 cP to about 1200 cP.

The washcoat slurry is applied to the substrate (which may already have one or more previously-applied washcoat compositions) by coating the substrate with the aqueous suspension (for example by dip-coating or vacuum coating), blowing excess washcoat off the substrate (and optionally collecting and recycling the excess washcoat blown off the substrate), drying the substrate, and calcining the substrate. Drying of the washcoats can be performed at room temperature or elevated temperature (for example, from about 30° C. to about 95° C., preferably about 60° C. to about 70° C.), at atmospheric pressure or at reduced pressure (for example, from about 1 pascal to about 90,000 pascal, or from about 7.5 mTorr to about 675 Torr), in ambient atmosphere or under an inert atmosphere (such as nitrogen or argon), and with or without passing a stream of gas over the substrate (for example, dry air, dry nitrogen gas or dry argon gas). In some embodiments, the drying process is a hot-drying process. A hot drying process includes any way to remove the solvent at a temperature greater than room temperature, but at a temperature below a standard calcining temperature. In some embodiments, the drying process may be a flash drying process, involving the rapid evaporation of moisture from the substrate via a sudden reduction in pressure or by placing the substrate in an updraft of warm air. It is contemplated that other drying processes may also be used.

After drying the washcoat composition onto the substrate, the washcoat may then be calcined onto the substrate. Calcining takes place at elevated temperatures, such as from 400° C. to about 700° C., preferably about 500° C. to about 600° C., more preferably at about 540° C. to about 560° C. or at about 550° C. Calcining can take place at atmospheric pressure or at reduced pressure (for example, from about 1 pascal to about 90,000 pascal, or about 7.5 mTorr to about 675 Torr), in ambient atmosphere or under an inert atmosphere (such as nitrogen or argon), and with or without passing a stream of gas over the substrate (for example, dry air, dry nitrogen gas, or dry argon gas).

In one embodiment of a coated substrate, the coated substrate comprises a first washcoat layer and a second washcoat layer. The first washcoat layer comprises composite nanoparticles, the composite nanoparticles comprising a catalytic nanoparticle comprising palladium bonded to a support nanoparticle comprising aluminum oxide; porous, micron-sized metal oxide particles comprising cerium-zirconium-lanthanum-yttrium oxide; and barium oxide. The composite nanoparticles are provided to the washcoat slurry separately from the metal oxide particles prior to forming the washcoat layer. The first washcoat layer further comprises aluminum oxide derived from boehmite. Optionally, the first washcoat layer further comprises filler particles comprising aluminum oxide or aluminum-lanthanum oxide. The first washcoat layer has a palladium loading of about 2 g/L to about 3 g/L. The second washcoat layer comprises composite nanoparticles, the composite nanoparticles comprising a catalytic nanoparticle comprising rhodium bonded to a support nanoparticle comprising cerium-zirconium-lanthanum-neodymium oxide; and porous, micron-sized metal oxide particles comprising cerium-zirconium-lanthanum-neodymium oxide, wherein the composite nanoparticles are attached to the metal oxide particles. The second washcoat layer further comprises aluminum oxide derived from boehmite. Optionally, the second washcoat layer further comprises filler particles comprising aluminum oxide or aluminum-lanthanum oxide. The second washcoat layer has a rhodium loading of about 0.1 g/L to about 0.6 g/L.

In another exemplary embodiment, the coated substrate comprises a first washcoat layer and a second washcoat layer, wherein the first washcoat layer comprises a first zone and a second zone. The first zone of the first washcoat layer comprises composite nanoparticles, the composite nanoparticles comprising a catalytic nanoparticle comprising palladium bonded to a support nanoparticle comprising aluminum oxide; porous, micron-sized metal oxide particles comprising cerium-zirconium-lanthanum-yttrium oxide; and barium oxide. The composite nanoparticles are provided to the washcoat slurry separately from the metal oxide particles prior to forming the washcoat layer. The first zone of the first washcoat layer further comprises aluminum oxide derived from boehmite. Optionally, the first zone of the first washcoat layer further comprises filler particles comprising aluminum oxide or aluminum-lanthanum oxide. The first zone of the first washcoat layer has a palladium loading of about 3 g/L to about 5 g/L. The second zone of the first washcoat layer comprises composite nanoparticles, the composite nanoparticles comprising a catalytic nanoparticle comprising palladium bonded to a support nanoparticle comprising cerium oxide; porous, micron-sized particles comprising cerium-zirconium-yttrium-lanthanum oxide; and barium oxide. The second zone of the first washcoat layer further comprises aluminum oxide derived from boehmite. Optionally, the second zone of the first washcoat layer further comprises filler particles comprising aluminum oxide or aluminum-lanthanum oxide. The first zone of the first washcoat has a palladium loading of about 0.3 g/L to about 1.2 g/L. The second washcoat layer comprises composite nanoparticles, the composite nanoparticles comprising a catalytic nanoparticle comprising rhodium bonded to a support nanoparticle comprising cerium-zirconium-lanthanum-neodymium oxide; and porous, micron-sized metal oxide particles comprising cerium-zirconium-lanthanum-neodymium oxide, wherein the composite nanoparticles are attached to the metal oxide particles. The second washcoat layer further comprises aluminum oxide derived from boehmite. Optionally, the second washcoat layer further comprises filler particles comprising aluminum oxide or aluminum-lanthanum oxide. The second washcoat layer has a rhodium loading of about 0.1 g/L to about 0.6 g/L.

The procedures described above can also be used when the first washcoat layer comprises first composite nanoparticles embedded in first porous carriers; and/or when the second washcoat layer comprises second composite nanoparticles embedded in second porous carriers; and/or when the first washcoat layer comprises a first zone and a second zone, where the first zone comprises first composite nanoparticles embedded in first porous carriers, and the second zone comprises third composite nanoparticles embedded in third porous carriers.

### Washcoat Formulations for the First Layer of a Coated Substrate

In some embodiments, the first washcoat layer of a coated substrate comprises (1) composite nanoparticles comprising a catalytic nanoparticle comprising platinum, palladium, or a platinum-palladium alloy bonded to a support nanoparticle comprising aluminum oxide, (2) metal oxide particles, and (3) barium oxide. In some embodiments, the first washcoat layer further comprises aluminum oxide, a portion of which may be, for example, derived from boehmite. In some embodiments, the washcoat formulation further comprises filler particles. In some embodiments, the first washcoat layer is formed by coating a substrate with a washcoat slurry, the washcoat slurry comprising the composite nanoparticles, the metal oxide particles, and a barium salt, such as barium oxide. In some embodiments, the first washcoat slurry further comprises boehmite and/or filler particles. Once the slurry is coated onto the substrate and dried, it the coated substrate is calcined. Calcining the substrate results in conversion of the barium salt to barium oxide and the boehmite, if present, to aluminum oxide.

### First Washcoat Layer

In some embodiments, the first washcoat layer comprises (1) a composite nanoparticle comprising a catalytic nanoparticle bonded to a support nanoparticle (2) metal oxide particles, and (3) barium oxide. In some embodiments, the first washcoat layer further comprises aluminum oxide, a portion of which may be, for example, derived from boehmite. In some embodiments, the composite nanoparticles are attached to the metal oxide particles. In some embodiments, a portion of the composite nanoparticles are not attached to the metal oxide particles. In some embodiments, the washcoat formulation further comprises filler particles.

In some embodiments, the first washcoat layer comprises (1) first composite nanoparticles embedded in first porous carriers, where the composite nanoparticles comprise a catalytic nanoparticle bonded to a support nanoparticle, and (2) barium oxide. In some embodiments, the first washcoat layer comprises (1) first composite nanoparticles embedded in first porous carriers, where the composite nanoparticles comprise a catalytic nanoparticle bonded to a support nanoparticle, and (2) barium oxide.

The composite nanoparticles (also referred to a “nano-on-nano” particles or “NN” particles) comprise a catalytic nanoparticle bonded to a support nanoparticle. In some embodiments, the catalytic nanoparticles in the first washcoat layer comprise palladium, platinum, or a platinum-palladium alloy. In some embodiments, the catalytic nanoparticles comprise palladium, which may be substantially free of platinum. In some embodiments, the support nanoparticle comprises aluminum oxide. The palladium-aluminum oxide composite nanoparticles comprise about 20% to about 60% by weight of palladium and about 40% to about 80% by weight of aluminum oxide. For example, in some embodiments, the composite nanoparticles comprise about 30% to about 50% by weight palladium and about 50% to about 70% by weight aluminum oxide. In one embodiment, the palladium-aluminum oxide composite particles comprise about 40% by weight of palladium and about 60% by weight of aluminum oxide. In some embodiments the composite nanoparticles are attached to the metal oxide particles (e.g., “nano-on-nano-on-micro” or “NNm” particles), for example by incipient wetness impregnation followed by drying and calcination. In some embodiments, the composite nanoparticles are provided to the washcoat slurry useful for the forming the first washcoat layer separately from the metal oxide particles (i.e., a “loose configuration”). In some embodiments, a portion of the composite nanoparticles are provided to the washcoat slurry separately from the metal oxide particles and a portion of the composite nanoparticles are attached to the metal oxide particles (such that the washcoat slurry comprises metal oxide particles, composite nanoparticles, and nano-on-nano-on-micro particles). In some embodiments, the composite nanoparticles are embedded in porous metal oxide carrier material (e.g., “nano-on-nano-in-micro” or “NNiM” particles).

Metal oxide particles which can be used in the first washcoat layer are typically cerium-containing metal oxides, including cerium oxide and composite oxides of cerium with one or more oxides of zirconium, lanthanum and/or yttrium. In some embodiments, the metal oxide particles comprise cerium oxide. In some embodiments, the metal oxide particles comprise cerium-zirconium oxide. In some embodiments, the metal oxide particles comprise cerium-lanthanum oxide. In some embodiments, the metal oxide particles comprise cerium-yttrium oxide. In some embodiments, the metal oxide particles comprise cerium-lanthanum-yttrium oxide. In some embodiment, the metal oxide particles comprise cerium-zirconium-lanthanum oxide. In some embodiments, the metal oxide particles comprise cerium-zirconium-yttrium oxide. In some embodiments, the metal oxide particles comprise cerium-zirconium-lanthanum-yttrium oxide. In some embodiments, the metal oxide particles comprise about 10% to about 70% by weight cerium oxide (such as about 20% to about 60% by weight cerium oxide, about 30% to about 50% by weight cerium oxide, or about 40% by weight cerium oxide). In some embodiments, the metal oxide particles comprise about 30% to about 90% by weight zirconium oxide (such as about 40% to about 80% by weight zirconium oxide, about 40% to about 60% by weight zirconium oxide, about 60% to about 80% by weight zirconium oxide, about 70% to about 90% by weight zirconium oxide, about 50% by weight zirconium oxide, or about 80% by weight zirconium oxide). In some embodiments, the metal oxide particles comprise about 1% to about 15% by weight yttrium oxide (such as about 2% to about 10% by weight yttrium oxide, about 3% to about 7% by weight yttrium oxide, about 4% to about 6% by weight yttrium oxide, or about 5% by weight yttrium oxide). In some embodiments, the metal oxide particles comprise about 1% to about 15% by weight lanthanum oxide (such as about 2% to about 10% by weight lanthanum oxide, about 3% to about 7% by weight lanthanum oxide, about 4% to about 6% by weight lanthanum oxide, or about 5% by weight lanthanum oxide). In some embodiments, the metal oxide particles comprise about 10% to about 70% by weight cerium oxide and about 30% to about 90% by weight zirconium oxide. In some embodiments, the metal oxide particles comprise about 10% to about 70% by weight cerium oxide, about 30% to about 90% by weight zirconium oxide and about 1% to about 15% by weight lanthanum oxide. In some embodiments, the metal oxide particles comprise about 10% to about 70% by weight cerium oxide, about 30% to about 90% by weight zirconium oxide and about 1% to about 15% by weight yttrium oxide. In some embodiments, the metal oxide particles comprise about 10% to about 70% by weight cerium oxide, about 30% to about 90% by weight zirconium oxide, about 1% to about 15% by weight lanthanum oxide, and about 1% to about 15% by weight yttrium oxide. In some embodiments, the metal oxide particles comprise about 40% cerium oxide, about 50% zirconium oxide, about 5% lanthanum oxide, and about 5% yttrium oxide. In some embodiments, the metal oxide particles are porous. In some embodiments, the metal oxide particles are micron-sized particles. In some embodiments, the metal oxide particles have a diameter between about 500 nm and about 50 microns, between about 500 nm and about 10 microns, between about 500 nm and about 5 microns, between about 1 micron and about 10 microns, between about 1 micron and about 5 microns, or between about 2 microns and about 8 microns.

The first washcoat layer comprises barium oxide. In some embodiments, the barium oxide is produced by adding an amount of barium salt (such as barium acetate, barium sulfate, barium carbonate, barium chloride, or barium cyclohexanebutyrate) to the washcoat slurry used to form the washcoat layer. In some embodiments, the barium salt is dissolved in the washcoat slurry. Upon calcining the coated substrate, the barium salt converts into barium oxide.

In some embodiments, the first washcoat layer comprises aluminum oxide, a portion of which may be, for example, derived from boehmite. Boehmite provided in the washcoat slurry is converted into aluminum oxide after the washcoat slurry is coated onto the substrate and the coated substrate is calcined. The aluminum oxide derived from boehmite increases adhesion of the first washcoat layer.

In some embodiments, the first washcoat layer comprises filler particles. In some embodiments, the filler particles are metal oxide particles. In some embodiments, the filler particles are porous. In some embodiments, the filler particles are aluminum oxide particles. In some embodiments, the filler particles are aluminum-lanthanum oxide particles. Exemplary aluminum-lanthanum oxide particles are MI-386 particles, commercially available from Rhodia. In some embodiments, the filler particles are micron-sized particles. In some embodiments, the filler particles have a diameter between about 500 nm and about 50 microns, between about 500 nm and about 10 microns, between about 500 nm and about 5 microns, between about 1 micron and about 10 microns, between about 1 micron and about 5 microns, or between about 2 microns and about 8 microns.

In some embodiments, the first washcoat layer comprises about 1% to about 10% by weight composite nanoparticles (such as about 1% to about 3% by weight composite nanoparticles, about 2% to about 4% by weight composite nanoparticles, about 3% to about 5% by weight composite nanoparticles, about 4% to about 6% by weight composite nanoparticles, about 5% to about 7% by weight composite nanoparticles, about 6% to about 8% by weight composite nanoparticles, or about 7% to about 9% by weight composite nanoparticles). In some embodiments, the first washcoat layer comprises about 40% to about 95% by weight metal oxide particles (such as about 50% to about 90% by weight metal oxide particles, about 60% to about 85% metal oxide particles, or about 70% to about 85% by weight metal oxide particles). In some embodiments, the first washcoat layer comprises about 3% to about 20% by weight barium oxide (such as about 3% to about 18% by weight barium oxide, about 3% to about 15% by weight barium oxide, about 3% to about 10% by weight barium oxide, about 3% to about 8% by weight barium oxide, about 6% to about 15% by weight barium oxide, about 6% to about 10% by weight barium oxide, or about 6% to about 8% by weight barium oxide). In some embodiments, the first washcoat layer comprises about 3% to about 8% by weight aluminum oxide derived from boehmite (such as about 3% to about 7% by weight aluminum oxide derived from boehmite, about 4% to about 6% by weight aluminum oxide derived from boehmite, or about 5% by weight aluminum oxide derived from boehmite). In some embodiments, the first washcoat layer comprises up to about 70% by weight filler particles (such as up to about 40% by weight filler particles, for example, about 5% to about 35% by weight filler particles, about 10% to about 30% by weight filler particles, or about 15% to about 25% by weight filler particles). In some embodiments, the first washcoat layer is coated onto the substrate the substrate at about 150 g/L to about 250 g/L (such as about 165 g/L to about 240 g/L, about 180 g/L to about 230 g/L, or about 190 g/L to about 220 g/L). In some embodiments, the first washcoat layer has a platinum group metal (e.g., palladium) loading of about 1 g/L to about 5 g/L (such as about 1 g/L to about 2 g/L, about 1.5 g/L to about 2.5 g/L, about 2 g/L to about 3 g/L, about 2.5 g/L to about 3.5 g/L, about 3 g/L to about 4 g/L, about 3.5 g/L to about 4.5 g/L, or about 4 g/L to about 5 g/L).

In some embodiments, the first washcoat layer comprises composite nanoparticles, the composite nanoparticles comprising a catalytic nanoparticle comprising palladium bonded to a support nanoparticle comprising aluminum oxide; porous, micron-sized particles comprising cerium oxide; and barium oxide. In some embodiments, the first washcoat layer comprises aluminum oxide derived from boehmite. Optionally, the first washcoat layer further comprises filler particles. In some embodiments, the first washcoat layer has a palladium loading of about 2 g/L to about 3 g/L.

In some embodiments, the first washcoat layer comprises composite nanoparticles, the composite nanoparticles comprising a catalytic nanoparticle comprising palladium bonded to a support nanoparticle comprising aluminum oxide; porous, micron-sized metal oxide particles comprising cerium-zirconium oxide; and barium oxide. In some embodiments, the composite nanoparticles are provided to the washcoat slurry separately from the metal oxide particles prior to forming the washcoat layer. In some embodiments, the first washcoat layer comprises aluminum oxide derived from boehmite. Optionally, the first washcoat layer further comprises filler particles comprising aluminum oxide. In some embodiments, the first washcoat layer has a palladium loading of about 2 g/L to about 3 g/L.

In some embodiments, the first washcoat layer comprises composite nanoparticles, the composite nanoparticles comprising a catalytic nanoparticle comprising palladium bonded to a support nanoparticle comprising aluminum oxide; porous, micron-sized particles comprising cerium-zirconium oxide; and barium oxide. In some embodiments, the composite nanoparticles are provided to the washcoat slurry separately from the metal oxide particles prior to forming the washcoat layer. In some embodiments, the first washcoat layer comprises aluminum oxide derived from boehmite. Optionally, the first washcoat layer further comprises filler particles comprising aluminum-lanthanum oxide. In some embodiments, the first washcoat layer has a palladium loading of about 2 g/L to about 3 g/L.

In some embodiments, the first washcoat layer comprises composite nanoparticles, the composite nanoparticles comprising a catalytic nanoparticle comprising palladium bonded to a support nanoparticle comprising aluminum oxide; porous, micron-sized metal oxide particles comprising cerium-zirconium-lanthanum oxide; and barium oxide. In some embodiments, the composite nanoparticles are provided to the washcoat slurry separately from the metal oxide particles prior to forming the washcoat layer. In some embodiments, the first washcoat layer comprises aluminum oxide derived from boehmite. Optionally, the first washcoat layer further comprises filler particles comprising aluminum oxide. In some embodiments, the first washcoat layer has a palladium loading of about 2 g/L to about 3 g/L.

In some embodiments, the first washcoat layer comprises composite nanoparticles, the composite nanoparticles comprising a catalytic nanoparticle comprising palladium bonded to a support nanoparticle comprising aluminum oxide; porous, micron-sized metal oxide particles comprising cerium-zirconium-lanthanum oxide; and barium oxide. In some embodiments, the composite nanoparticles are provided to the washcoat slurry separately from the metal oxide particles prior to forming the washcoat layer. In some embodiments, the first washcoat layer comprises aluminum oxide derived from boehmite. Optionally, the first washcoat layer further comprises filler particles comprising aluminum-lanthanum oxide. In some embodiments, the first washcoat layer has a palladium loading of about 2 g/L to about 3 g/L.

In some embodiments, the first washcoat layer comprises composite nanoparticles, the composite nanoparticles comprising a catalytic nanoparticle comprising palladium bonded to a support nanoparticle comprising aluminum oxide; porous, micron-sized metal oxide particles comprising cerium-zirconium-yttrium oxide; and barium oxide. In some embodiments, the composite nanoparticles are provided to the washcoat slurry separately from the metal oxide particles prior to forming the washcoat layer. In some embodiments, the first washcoat layer comprises aluminum oxide derived from boehmite. Optionally, the first washcoat layer further comprises filler particles comprising aluminum oxide. In some embodiments, the first washcoat layer has a palladium loading of about 2 g/L to about 3 g/L.

In some embodiments, the first washcoat layer comprises composite nanoparticles, the composite nanoparticles comprising a catalytic nanoparticle comprising palladium bonded to a support nanoparticle comprising aluminum oxide; porous, micron-sized metal oxide particles comprising cerium-zirconium-yttrium oxide; and barium oxide. In some embodiments, the composite nanoparticles are provided to the washcoat slurry separately from the metal oxide particles prior to forming the washcoat layer. In some embodiments, the first washcoat layer comprises aluminum oxide derived from boehmite. Optionally, the first washcoat layer further comprises filler particles comprising aluminum-lanthanum oxide. In some embodiments, the first washcoat layer has a palladium loading of about 2 g/L to about 3 g/L.

In some embodiments, the first washcoat layer comprises composite nanoparticles, the composite nanoparticles comprising a catalytic nanoparticle comprising palladium bonded to a support nanoparticle comprising aluminum oxide; porous, micron-sized metal oxide particles comprising cerium-zirconium-lanthanum-yttrium oxide; and barium oxide. In some embodiments, the composite nanoparticles are provided to the washcoat slurry separately from the metal oxide particles prior to forming the washcoat layer. In some embodiments, the first washcoat layer comprises aluminum oxide derived from boehmite. Optionally, the first washcoat layer further comprises filler particles comprising aluminum oxide. In some embodiments, the first washcoat layer has a palladium loading of about 2 g/L to about 3 g/L.

In some embodiments, the first washcoat layer comprises composite nanoparticles, the composite nanoparticles comprising a catalytic nanoparticle comprising palladium bonded to a support nanoparticle comprising aluminum oxide; porous, micron-sized metal oxide particles comprising cerium-zirconium-lanthanum-yttrium oxide; and barium oxide. In some embodiments, the composite nanoparticles are provided to the washcoat slurry separately from the metal oxide particles prior to forming the washcoat layer. In some embodiments, the first washcoat layer comprises aluminum oxide derived from boehmite. Optionally, the first washcoat layer further comprises filler particles comprising aluminum-lanthanum oxide. In some embodiments, the first washcoat layer has a palladium loading of about 2 g/L to about 3 g/L.

### Washcoat Slurry Useful for Forming First Washcoat Layer

In some embodiments, the first washcoat layer is formed by coating a substrate with a washcoat slurry comprising composite nanoparticles, the composite nanoparticles comprising a catalytic nanoparticle bonded to a support nanoparticle, metal oxide particles, and a barium salt. In some embodiments the washcoat slurry further comprises filler particles and/or boehmite. In some embodiments, the catalytic nanoparticle comprises platinum, palladium, or a platinum-palladium alloy. In some embodiments, the support particle comprises aluminum oxide. In some embodiments, the metal oxide particles comprise cerium oxide, zirconium oxide, lanthanum oxide, and/or yttrium oxide. In some embodiments, the metal oxide particles are micron-sized particles. In some embodiments, the metal oxide particles are porous. In some embodiments, the composite nanoparticles are provided separately from the metal oxide particles (i.e., a “loose configuration”). In some embodiments, the composite nanoparticles are attached to the metal oxide particles (e.g., “NNm” particles), for example by incipient wetness impregnation followed by drying and calcination. In some embodiments, a portion of the composite nanoparticles are provided to the washcoat slurry separately from the metal oxide particles and a portion of the composite nanoparticles are attached to the metal oxide particles (such that the washcoat slurry comprises metal oxide particles, composite nanoparticles, and nano-on-nano-on-micro particles). The materials for the washcoat slurry are combined with an aqueous liquid to form a dispersion. In some embodiments, a surfactant is included in the washcoat slurry. In some embodiments, the composite nanoparticles are embedded in porous metal oxide carrier material (e.g., “nano-on-nano-in-micro” or “NNiM” particles).

In some embodiments, the composite nanoparticles in the washcoat slurry useful for forming the first washcoat layer comprise a catalytic nanoparticle comprising palladium, platinum, or a platinum-palladium alloy. In some embodiments, the catalytic nanoparticles comprise palladium, which may be substantially free of platinum. In some embodiments, the composite nanoparticles in the washcoat slurry comprise a support nanoparticle comprising aluminum oxide. The palladium-aluminum oxide composite nanoparticles comprise about 20% to about 60% by weight of palladium and about 40% to about 80% by weight of aluminum oxide. For example, in some embodiments, the composite nanoparticles comprise about 30% to about 50% by weight palladium and about 50% to about 70% by weight aluminum oxide. In one embodiment, the palladium-aluminum oxide composite particles comprise about 40% by weight of palladium and about 60% by weight of aluminum oxide. In some embodiments the composite nanoparticles in the washcoat slurry are attached to the metal oxide particles (e.g., “nano-on-nano-on-micro” or “NNm” particles), for example by incipient wetness impregnation followed by drying and calcination. In some embodiments, the composite nanoparticles in the washcoat slurry are embedded in porous metal oxide carrier material (e.g., “nano-on-nano-in-micro” or “NNiM” particles). In some embodiments, the composite nanoparticles are provided to the washcoat slurry used to for the first washcoat layer separately from the metal oxide particles (i.e., a “loose configuration”).

In some embodiments, the metal oxide particles in the washcoat slurry useful for forming the first washcoat layer comprise metal oxide particles. In some embodiments, the metal oxide particles are cerium-containing metal oxides, such as cerium oxide and composite oxides of cerium with one or more oxides of zirconium, lanthanum and/or yttrium. In some embodiments, the metal oxide particles comprise cerium oxide. In some embodiments, the metal oxide particles comprise zirconium oxide. In some embodiments, the metal oxide particles comprise lanthanum oxide. In some embodiments, the metal oxide particles comprise yttrium oxide. In some embodiments, the metal oxide particles comprise cerium-zirconium oxide. In some embodiments, the metal oxide particles comprise cerium-lanthanum oxide. In some embodiments, the metal oxide particles comprise cerium-yttrium oxide. In some embodiments, the metal oxide particles comprise cerium-lanthanum-yttrium oxide. In some embodiment, the metal oxide particles comprise cerium-zirconium-lanthanum oxide. In some embodiments, the metal oxide particles comprise cerium-zirconium-yttrium oxide. In some embodiments, the metal oxide particles comprise cerium-zirconium-lanthanum-yttrium oxide. In some embodiments, the metal oxide particles comprise about 10% to about 70% by weight cerium oxide (such as about 20% to about 60% by weight cerium oxide, about 30% to about 50% by weight cerium oxide, or about 40% by weight cerium oxide). In some embodiments, the metal oxide particles comprise about 30% to about 90% by weight zirconium oxide (such as about 40% to about 80% by weight zirconium oxide, about 40% to about 60% by weight zirconium oxide, about 60% to about 80% by weight zirconium oxide, about 70% to about 90% by weight zirconium oxide, about 50% by weight zirconium oxide, or about 80% by weight zirconium oxide). In some embodiments, the metal oxide particles comprise about 1% to about 15% by weight yttrium oxide (such as about 2% to about 10% by weight yttrium oxide, about 3% to about 7% by weight yttrium oxide, about 4% to about 6% by weight yttrium oxide, or about 5% by weight yttrium oxide). In some embodiments, the metal oxide particles comprise about 1% to about 15% by weight lanthanum oxide (such as about 2% to about 10% by weight lanthanum oxide, about 3% to about 7% by weight lanthanum oxide, about 4% to about 6% by weight lanthanum oxide, or about 5% by weight lanthanum oxide). In some embodiments, the metal oxide particles comprise about 10% to about 70% by weight cerium oxide and about 30% to about 90% by weight zirconium oxide. In some embodiments, the metal oxide particles comprise about 10% to about 70% by weight cerium oxide, about 30% to about 90% by weight zirconium oxide and about 1% to about 15% by weight lanthanum oxide. In some embodiments, the metal oxide particles comprise about 10% to about 70% by weight cerium oxide, about 30% to about 90% by weight zirconium oxide and about 1% to about 15% by weight yttrium oxide. In some embodiments, the metal oxide particles comprise about 10% to about 70% by weight cerium oxide, about 30% to about 90% by weight zirconium oxide, about 1% to about 15% by weight lanthanum oxide, and about 1% to about 15% by weight yttrium oxide. In some embodiments, the metal oxide particles comprise about 40% cerium oxide, about 50% zirconium oxide, about 5% lanthanum oxide, and about 5% yttrium oxide. In some embodiments, the metal oxide particles are porous. In some embodiments, the metal oxide particles are micron-sized particles. In some embodiments, the metal oxide particles have a diameter between about 500 nm and about 50 microns, between about 500 nm and about 10 microns, between about 500 nm and about 5 microns, between about 1 micron and about 10 microns, between about 1 micron and about 5 microns, or between about 2 microns and about 8 microns.

In some embodiments, the washcoat slurry useful for forming the first washcoat layer comprises a barium salt (such as barium acetate, barium sulfate, barium carbonate, barium chloride, or barium cyclohexanebutyrate). The washcoat slurry comprises an appropriate amount of the barium salt to reach the target barium oxide content of the first washcoat layer.

In some embodiments, the washcoat slurry useful for forming the first washcoat layer comprises boehmite. The washcoat slurry comprises an appropriate amount of boehmite to reach the target aluminum oxide derived from boehmite content in the first washcoat layer.

In some embodiments, the washcoat slurry useful for the formation of the first washcoat layer comprises filler particles. In some embodiments, the filler particles are metal oxide particles. In some embodiments, the filler particles are porous. In some embodiments, the filler particles comprise aluminum oxide. In some embodiments, the filler particles comprise aluminum-lanthanum oxide. Exemplary aluminum-lanthanum oxide particles are MI-386 particles, commercially available from Rhodia. In some embodiments, the filler particles are micron-sized particles. In some embodiments, the filler particles have a diameter between about 500 nm and about 50 microns, between about 500 nm and about 10 microns, between about 500 nm and about 5 microns, between about 1 micron and about 10 microns, between about 1 micron and about 5 microns, or between about 2 microns and about 8 microns.

In some embodiments, the washcoat slurry useful for the formation of the first washcoat layer comprises about 1% to about 10% by weight composite nanoparticles (such as about 1% to about 3% by weight composite nanoparticles, about 2% to about 4% by weight composite nanoparticles, about 3% to about 5% by weight composite nanoparticles, about 4% to about 6% by weight composite nanoparticles, about 5% to about 7% by weight composite nanoparticles, about 6% to about 8% by weight composite nanoparticles, or about 7% to about 9% by weight composite nanoparticles). In some embodiments, the first washcoat layer comprises about 40% to about 95% by weight metal oxide particles (such as about 50% to about 90% by weight metal oxide particles, about 60% to about 85% metal oxide particles, or about 70% to about 85% by weight metal oxide particles). In some embodiments, the first washcoat layer comprises about 3% to about 20% by weight barium salt (such as about 3% to about 18% by weight barium salt, about 6% to about 15% by weight barium salt, about 8% to about 12% by weight barium salt, or about 9% to about 11% by weight barium salt. The amount of barium salt added by weight will depend on the barium salt composition (e.g., barium acetate or barium sulfate), depending on the target barium oxide amount in the first washcoat layer. In some embodiments, the washcoat slurry comprises about 3% to about 8% by weight boehmite (such as about 3% to about 7% by weight boehmite, about 4% to about 6% by weight boehmite, or about 5% by weight boehmite). Optionally, the washcoat slurry useful for the formation of the first washcoat layer comprises up to about 70% by weight filler particles (such as up to about 40% by weight filler particles, for example, about 5% to about 35% by weight filler particles, about 10% to about 30% by weight filler particles, or about 15% to about 25% by weight filler particles).

In some embodiments, the washcoat slurry comprises composite nanoparticles, the composite nanoparticles comprising a catalytic nanoparticle comprising palladium bonded to a support nanoparticle comprising aluminum oxide; porous, micron-sized metal oxide particles comprising cerium oxide; and a barium salt (such as barium acetate or barium sulfate). In some embodiments, the washcoat slurry comprises boehmite. In some embodiments, the washcoat slurry comprises filler particles comprising aluminum oxide. In some embodiments, a portion of the composite nanoparticles are not attached to the micron-sized particles.

In some embodiments, the washcoat slurry comprises composite nanoparticles, the composite nanoparticles comprising a catalytic nanoparticle comprising palladium bonded to a support nanoparticle comprising aluminum oxide; porous, micron-sized metal oxide particles comprising cerium oxide; and a barium salt (such as barium acetate or barium sulfate). In some embodiments, the washcoat slurry comprises boehmite. In some embodiments, the washcoat slurry comprises filler particles comprising aluminum-lanthanum oxide. In some embodiments, a portion of the composite nanoparticles are not attached to the micron-sized particles.

In some embodiments, the washcoat slurry comprises composite nanoparticles, the composite nanoparticles comprising a catalytic nanoparticle comprising palladium bonded to a support nanoparticle comprising aluminum oxide; porous, micron-sized metal oxide particles comprising cerium-zirconium oxide; and a barium salt (such as barium acetate or barium sulfate). In some embodiments, the washcoat slurry comprises boehmite. In some embodiments, the washcoat slurry further comprises filler particles comprising aluminum oxide. In some embodiments, a portion of the composite nanoparticles are not attached to the micron-sized particles.

In some embodiments, the washcoat slurry comprises composite nanoparticles, the composite nanoparticles comprising a catalytic nanoparticle comprising palladium bonded to a support nanoparticle comprising aluminum oxide; porous, micron-sized metal oxide particles comprising cerium-zirconium-lanthanum oxide; and a barium salt (such as barium acetate or barium sulfate). In some embodiments, the washcoat slurry comprises boehmite. In some embodiments, the washcoat slurry further comprises filler particles comprising aluminum oxide. In some embodiments, the composite nanoparticles are attached to the micron-sized particles. In some embodiments, a portion of the composite nanoparticles are not attached to the micron-sized particles.

In some embodiments, the washcoat slurry comprises composite nanoparticles, the composite nanoparticles comprising a catalytic nanoparticle comprising palladium bonded to a support nanoparticle comprising aluminum oxide; porous, micron-sized metal oxide particles comprising cerium-zirconium-lanthanum oxide; and a barium salt (such as barium acetate or barium sulfate). In some embodiments, the washcoat slurry comprises boehmite. In some embodiments, the washcoat slurry further comprises filler particles comprising aluminum-lanthanum oxide. In some embodiments, a portion of the composite nanoparticles are not attached to the micron-sized particles.

In some embodiments, the washcoat slurry comprises composite nanoparticles, the composite nanoparticles comprising a catalytic nanoparticle comprising palladium bonded to a support nanoparticle comprising aluminum oxide; porous, micron-sized metal oxide particles comprising cerium-zirconium-yttrium oxide; and a barium salt (such as barium acetate or barium sulfate). In some embodiments, the washcoat slurry comprises boehmite. In some embodiments, the washcoat slurry further comprises filler particles comprising aluminum oxide. In some embodiments, a portion of the composite nanoparticles are not attached to the micron-sized particles.

In some embodiments, the washcoat slurry comprises composite nanoparticles, the composite nanoparticles comprising a catalytic nanoparticle comprising palladium bonded to a support nanoparticle comprising aluminum oxide; porous, micron-sized metal oxide particles comprising cerium-zirconium-yttrium oxide; and a barium salt (such as barium acetate or barium sulfate). In some embodiments, the washcoat slurry comprises boehmite. In some embodiments, the washcoat slurry further comprises filler particles comprising aluminum-lanthanum oxide. In some embodiments, a portion of the composite nanoparticles are not attached to the micron-sized particles.

In some embodiments, the washcoat slurry comprises composite nanoparticles, the composite nanoparticles comprising a catalytic nanoparticle comprising palladium bonded to a support nanoparticle comprising aluminum oxide; porous, micron-sized particles comprising cerium-zirconium-lanthanum-yttrium oxide; and a barium salt (such as barium acetate or barium sulfate). In some embodiments, the washcoat slurry comprises boehmite. In some embodiments, the washcoat slurry further comprises filler particles comprising aluminum oxide. In some embodiments, a portion of the composite nanoparticles are not attached to the micron-sized particles.

In some embodiments, the washcoat slurry comprises composite nanoparticles, the composite nanoparticles comprising a catalytic nanoparticle comprising palladium bonded to a support nanoparticle comprising aluminum oxide; porous, micron-sized particles comprising cerium-zirconium-lanthanum-yttrium oxide; and a barium salt (such as barium acetate or barium sulfate). In some embodiments, the washcoat slurry comprises boehmite. In some embodiments, the washcoat slurry further comprises filler particles comprising aluminum-lanthanum oxide. In some embodiments, a portion of the composite nanoparticles are not attached to the micron-sized particles.

In some embodiments, rheology modifiers, including, but not limited to, corn starch and cellulose (such as 2-hydroxyethyl cellulose) are added to adjust the washcoat slurry to the desired viscosity. In some embodiments, the rheology modifiers are added to the washcoat slurry to between about 0.5% and about 1.6% of the washcoat slurry.

In some embodiments, the washcoat slurry useful for the formation of the first washcoat layer is applied to the substrate. The substrate is then dried and calcined to form the first washcoat layer.

### Zoned Coated Substrates

In some embodiments, the coated substrate is coated with a first washcoat layer and a second washcoat layer, wherein the first washcoat layer comprises a first zone and a second zone. By “first zone,” it is meant that this is the first zone in any given layer of the coated substrate encountered by the engine exhaust gases when the coated substrate is used in a catalytic converter. By “second zone,” it is meant that this is the second zone in any given layer of the coated substrate encountered by the engine exhaust gases when the coated substrate is used in a catalytic converter. It is understood that additional washcoat layers may be included, for example, in the coated substrate between the substrate and the first washcoat layer.

Zoned catalytic converters can be readily prepared by techniques known in the art, such as those described in U.S. Pat. No. 5,010,051 or U.S. Pat. No. 5,057,483. Additional examples of zone coated catalyst substrates are provided in U.S. Patent Application Publication No. 2016/0045867. Zone coating can be accomplished simply by dipping a first end of a substrate into a first washcoat slurry, and subsequently dipping the second end of the substrate into a second washcoat slurry. Other methods of zone coating known in the art can be used.

In some embodiments, the first washcoat layer comprises a first zone and a second zone. In some embodiments, the washcoat composition of the first zone and the second zone are different. In some embodiments, each of the washcoat compositions in the first zone and the second zone are different from the washcoat composition of the second layer.

Zone coating can be used to separate various washcoat formulations or washcoat layers into different regions on a substrate, rather than having the washcoat formulations or washcoat layers in the same region on the substrate. In other words, instead of coating a substrate with a first washcoat, and then coating the substrate with a second washcoat disposed on top of the first washcoat, the substrate can be coated in one region or zone with a first washcoat, and then in a different region or zone with another washcoat, so that the contact (or overlap) between different washcoats can be adjusted as desired, including minimizing contact or eliminating contact between different washcoats. A small gap can be left between the zones of the coated substrate, such as a gap of 5 mm or less; the gap should be as small as practical so as to maximize the use of the surface area of the substrate. In some embodiments, the gap between the different zones of the coated substrate is between about 5 mm and about 50 mm, between about 5 mm and about 40 mm, between about 5 mm and about 30 mm, between about 5 mm and about 20 mm, between about 5 mm and about 10 mm, between about 10 mm and about 50 mm, between about 10 mm and about 40 mm, between about 10 mm and about 30 mm, or between about 10 mm and about 20 mm. By zone coating the substrate, particular washcoat formulations can be applied to particular zones of the substrate in a particular combination to achieve a certain result.

A highly schematic drawing of a zoned catalytic converter is shown in FIG. 2. The coated substrate is contained in a housing 200. A first washcoat slurry is applied to the first zone 204 of the substrate 202; a second washcoat slurry is applied to the second zone 206 of the substrate 202. The gap between zones 208 is minimized. The direction of flow of exhaust gases from the engine is indicated by the arrow. It should be noted that the washcoats are coated on the surface of the interior channels of the substrate; the highly schematic drawing of FIG. 2 is simply meant to aid in conceptualizing the separation of the different washcoats in the different zones, and is not meant to be a detailed physical representation, nor are the dimensions drawn to scale.

In any of the above embodiments, the ratio of the length of the first zone on the substrate to the length of the second zone on the substrate varies between about 10:1 to about 1:10, such as between about 5:1 to about 1:5, about 4:1 to about 1:4, about 3:1 to about 1:3 or about 1:1. By way of illustration, when the ratio of the length of the first zone to the length of the second zone is about 3:1, the first zone takes up about the first 75% of the length of the substrate, while the second zone takes up about the following 25% of the length of the substrate, with a small gap in between the zones as discussed above. In one embodiment, the length of the first zone on the coated substrate is equal to, or about equal to, the length of the second zone on the coated substrate, that is, the first and second zones each occupy about half of the length of the coated substrate, and the ratio of the length of the first zone to the length of the second zone is about 1:1. Since the zones occupy a volume of the substrate proportional to their length, the ratio of the length of the first zone on the substrate to the length of the second zone on the substrate will be the same, or about the same, as the ratio of the volume occupied by the first zone on the substrate to the volume occupied by the second zone on the substrate.

When the zones are of unequal length, the concentrations of ingredients in the various washcoat layers are adjusted so that the same absolute amount of material is present in a given zone, regardless of how much of the substrate the zone occupies. For example, if the first zone contains about 4 g/L of palladium when it occupies 1 liter of space on a substrate, it should contain 6 g/L of palladium when it occupies two-thirds of a liter of space on the substrate, so that the final loading of palladium remains at an absolute amount of 4 grams.

### First Zone of the First Washcoat Layer

In some embodiments, the first zone of the first washcoat layer comprises (1) a composite nanoparticle comprising a catalytic nanoparticle comprising platinum, palladium, or a platinum-palladium alloy bonded to a support nanoparticle (2) metal oxide particles, and (3) barium oxide. In some embodiments, the first zone of the first washcoat layer further comprises aluminum oxide, a portion of which may be, for example, derived from boehmite. In some embodiments, the composite nanoparticles are attached to the metal oxide particles. In some embodiments, a portion of the composite nanoparticles are not attached to the metal oxide particles. In some embodiments, the washcoat formulation further comprises filler particles.

The composite nanoparticles (also referred to a “nano-on-nano” particles or “NN” particles) comprise a catalytic nanoparticle bonded to a support nanoparticle. In some embodiments, the catalytic nanoparticles in the first zone of the first washcoat layer comprise palladium, platinum, or a platinum-palladium alloy. In some embodiments, the catalytic nanoparticles comprise palladium, which may be substantially free of platinum. In some embodiments, the support nanoparticle comprises aluminum oxide. The palladium-aluminum oxide composite nanoparticles comprise about 20% to about 60% by weight of palladium and about 40% to about 80% by weight of aluminum oxide. For example, in some embodiments, the composite nanoparticles comprise about 30% to about 50% by weight palladium and about 50% to about 70% by weight aluminum oxide. In one embodiment, the palladium-aluminum oxide composite particles comprise about 40% by weight of palladium and about 60% by weight of aluminum oxide. In some embodiments the composite nanoparticles are attached to the metal oxide particles (e.g., “nano-on-nano-on-micro” or “NNm” particles), for example by incipient wetness impregnation followed by drying and calcination. In some embodiments, the composite nanoparticles are provided to the washcoat slurry useful for the forming the first zone of the first washcoat layer separately from the metal oxide particles (i.e., a “loose configuration”). In some embodiments, a portion of the composite nanoparticles are provided to the washcoat slurry separately from the metal oxide particles and a portion of the composite nanoparticles are attached to the metal oxide particles (such that the washcoat slurry comprises metal oxide particles, composite nanoparticles, and nano-on-nano-on-micro particles). In some embodiments, the composite nanoparticles are embedded in porous metal oxide carrier material (e.g., “nano-on-nano-in-micro” or “NNiM” particles).

Metal oxide particles which can be used in the first zone of the first washcoat layer are typically cerium-containing metal oxides, including cerium oxide and composite oxides of cerium with one or more oxides of zirconium, lanthanum and/or yttrium. In some embodiments, the metal oxide particles comprise cerium oxide. In some embodiments, the metal oxide particles comprise zirconium oxide. In some embodiments, the metal oxide particles comprise lanthanum oxide. In some embodiments, the metal oxide particles comprise yttrium oxide. In some embodiments, the metal oxide particles comprise cerium-zirconium oxide. In some embodiments, the metal oxide particles comprise cerium-lanthanum oxide. In some embodiments, the metal oxide particles comprise cerium-yttrium oxide. In some embodiments, the metal oxide particles comprise cerium-lanthanum-yttrium oxide. In some embodiment, the metal oxide particles comprise cerium-zirconium-lanthanum oxide. In some embodiments, the metal oxide particles comprise cerium-zirconium-yttrium oxide. In some embodiments, the metal oxide particles comprise cerium-zirconium-lanthanum-yttrium oxide. In some embodiments, the metal oxide particles comprise about 10% to about 70% by weight cerium oxide (such as about 20% to about 60% by weight cerium oxide, about 30% to about 50% by weight cerium oxide, or about 40% by weight cerium oxide). In some embodiments, the metal oxide particles comprise about 30% to about 90% by weight zirconium oxide (such as about 40% to about 80% by weight zirconium oxide, about 40% to about 60% by weight zirconium oxide, about 60% to about 80% by weight zirconium oxide, about 70% to about 90% by weight zirconium oxide, about 50% by weight zirconium oxide, or about 80% by weight zirconium oxide). In some embodiments, the metal oxide particles comprise about 1% to about 15% by weight yttrium oxide (such as about 2% to about 10% by weight yttrium oxide, about 3% to about 7% by weight yttrium oxide, about 4% to about 6% by weight yttrium oxide, or about 5% by weight yttrium oxide). In some embodiments, the metal oxide particles comprise about 1% to about 15% by weight lanthanum oxide (such as about 2% to about 10% by weight lanthanum oxide, about 3% to about 7% by weight lanthanum oxide, about 4% to about 6% by weight lanthanum oxide, or about 5% by weight lanthanum oxide). In some embodiments, the metal oxide particles comprise about 10% to about 70% by weight cerium oxide and about 30% to about 90% by weight zirconium oxide. In some embodiments, the metal oxide particles comprise about 10% to about 70% by weight cerium oxide, about 30% to about 90% by weight zirconium oxide and about 1% to about 15% by weight lanthanum oxide. In some embodiments, the metal oxide particles comprise about 10% to about 70% by weight cerium oxide, about 30% to about 90% by weight zirconium oxide and about 1% to about 15% by weight yttrium oxide. In some embodiments, the metal oxide particles comprise about 10% to about 70% by weight cerium oxide, about 30% to about 90% by weight zirconium oxide, about 1% to about 15% by weight lanthanum oxide, and about 1% to about 15% by weight yttrium oxide. In some embodiments, the metal oxide particles comprise about 40% cerium oxide, about 50% zirconium oxide, about 5% lanthanum oxide, and about 5% yttrium oxide. In some embodiments, the metal oxide particles are porous. In some embodiments, the metal oxide particles are micron-sized particles. In some embodiments, the metal oxide particles have a diameter between about 500 nm and about 50 microns, between about 500 nm and about 10 microns, between about 500 nm and about 5 microns, between about 1 micron and about 10 microns, between about 1 micron and about 5 microns, or between about 2 microns and about 8 microns.

The first washcoat layer comprises barium oxide. In some embodiments, the barium oxide is produced by adding an amount of barium salt (such as barium acetate, barium sulfate, barium carbonate, barium chloride, or barium cyclohexanebutyrate) to the washcoat slurry used to form the first zone of the first washcoat layer. In some embodiments, the barium salt is dissolved in the washcoat slurry. Upon calcining the coated substrate, the barium salt converts into barium oxide.

In some embodiments, the first zone of the first washcoat layer comprises aluminum oxide, a portion of which may be, for example, derived from boehmite. Boehmite provided in the washcoat slurry is converted into aluminum oxide after the washcoat slurry is coated onto the substrate and the coated substrate is calcined. The aluminum oxide derived from boehmite increases adhesion of the first zone of the first washcoat layer.

In some embodiments, the first zone of the first washcoat layer comprises filler particles. In some embodiments, the filler particles are metal oxide particles. In some embodiments, the filler particles are porous. In some embodiments, the filler particles comprise aluminum oxide. In some embodiments, the filler particles comprise aluminum-lanthanum oxide. Exemplary aluminum-lanthanum oxide particles are MI-386 particles, commercially available from Rhodia. In some embodiments, the filler particles are micron-sized particles. In some embodiments, the filler particles have a diameter between about 500 nm and about 50 microns, between about 500 nm and about 10 microns, between about 500 nm and about 5 microns, between about 1 micron and about 10 microns, between about 1 micron and about 5 microns, or between about 2 microns and about 8 microns.

In some embodiments, the first zone of the first washcoat layer comprises about 1% to about 10% by weight composite nanoparticles (such as about 1% to about 3% by weight composite nanoparticles, about 2% to about 4% by weight composite nanoparticles, about 3% to about 5% by weight composite nanoparticles, about 4% to about 6% by weight composite nanoparticles, about 5% to about 7% by weight composite nanoparticles, about 6% to about 8% by weight composite nanoparticles, or about 7% to about 9% by weight composite nanoparticles). In some embodiments, the first zone of the first washcoat layer comprises about 40% to about 95% by weight metal oxide particles (such as about 50% to about 90% by weight metal oxide particles, about 60% to about 85% metal oxide particles, or about 70% to about 85% by weight metal oxide particles). In some embodiments, the first zone of the first washcoat layer comprises about 3% to about 20% by weight barium oxide (such as about 3% to about 18% by weight barium oxide, about 3% to about 15% by weight barium oxide, about 3% to about 10% by weight barium oxide, about 3% to about 8% by weight barium oxide, about 6% to about 15% by weight barium oxide, about 6% to about 10% by weight barium oxide, or about 6% to about 8% by weight barium oxide). In some embodiments, the first zone of the first washcoat layer comprises about 3% to about 8% by weight aluminum oxide derived from boehmite (such as about 3% to about 7% by weight aluminum oxide derived from boehmite, about 4% to about 6% by weight aluminum oxide derived from boehmite, or about 5% by weight aluminum oxide derived from boehmite). In some embodiments, the first zone of the first washcoat layer comprises up to about 70% by weight filler particles (such as up to about 40% by weight filler particles, for example, about 5% to about 35% by weight filler particles, about 10% to about 30% by weight filler particles, or about 15% to about 25% by weight filler particles). In some embodiments, the first zone of the first washcoat layer is coated onto the substrate the substrate at about 150 g/L to about 250 g/L (such as about 165 g/L to about 240 g/L, about 180 g/L to about 230 g/L, or about 190 g/L to about 220 g/L). In some embodiments, the first zone of the first washcoat layer has a platinum group metal (e.g., palladium) loading of about 2 g/L to about 10 g/L (such as about 2 g/L to about 3 g/L, about 2.5 g/L to about 3.5 g/L, about 3 g/L to about 4 g/L, about 3.5 g/L to about 4.5 g/L, about 4 g/L to about 5 g/L, about 4.5 g/L to about 5.5 g/L, or about 5 g/L to about 6 g/L, about 5.5 g/L to about 6.5 g/L, about 6 g/L to about 7 g/L, about 6.5 g/L to about 7.5 g/L, about 7 g/L to about 8 g/L, about 7.5 g/L to about 8.5 g/L, about 8 g/L to about 9 g/L, about 8.5 g/L to about 9.5 g/L or about 8 g/L to about 10 g/L). The density of the platinum group metal loading will depend on the length of the first zone of the first washcoat layer.

In some embodiments, the first zone of the first washcoat layer comprises composite nanoparticles, the composite nanoparticles comprising a catalytic nanoparticle comprising palladium bonded to a support nanoparticle comprising aluminum oxide; porous, micron-sized particles comprising cerium oxide; and barium oxide. In some embodiments, the first zone of the first washcoat layer comprises aluminum oxide derived from boehmite. Optionally, the first zone of the first washcoat layer further comprises filler particles. In some embodiments, the first zone of the first washcoat layer has a palladium loading of about 3 g/L to about 5 g/L.

In some embodiments, the first zone of the first washcoat layer comprises composite nanoparticles, the composite nanoparticles comprising a catalytic nanoparticle comprising palladium bonded to a support nanoparticle comprising aluminum oxide; porous, micron-sized metal oxide particles comprising cerium-zirconium oxide; and barium oxide. In some embodiments, the composite nanoparticles are provided to the washcoat slurry separately from the metal oxide particles prior to forming the washcoat layer. In some embodiments, the first zone of the first washcoat layer comprises aluminum oxide derived from boehmite. Optionally, the first zone of the first washcoat layer further comprises filler particles comprising aluminum oxide. In some embodiments, the first washcoat layer has a palladium loading of about 3 g/L to about 5 g/L.

In some embodiments, the first zone of the first washcoat layer comprises composite nanoparticles, the composite nanoparticles comprising a catalytic nanoparticle comprising palladium bonded to a support nanoparticle comprising aluminum oxide; porous, micron-sized particles comprising cerium-zirconium oxide; and barium oxide. In some embodiments, the composite nanoparticles are provided to the washcoat slurry separately from the metal oxide particles prior to forming the washcoat layer. In some embodiments, the first zone of the first washcoat layer comprises aluminum oxide derived from boehmite. Optionally, the first zone of the first washcoat layer further comprises filler particles comprising aluminum-lanthanum oxide. In some embodiments, the first zone of the first washcoat layer has a palladium loading of about 3 g/L to about 5 g/L.

In some embodiments, the first zone of the first washcoat layer comprises composite nanoparticles, the composite nanoparticles comprising a catalytic nanoparticle comprising palladium bonded to a support nanoparticle comprising aluminum oxide; porous, micron-sized metal oxide particles comprising cerium-zirconium-lanthanum oxide; and barium oxide. In some embodiments, the composite nanoparticles are provided to the washcoat slurry separately from the metal oxide particles prior to forming the washcoat layer. In some embodiments, the first zone of the first washcoat layer comprises aluminum oxide derived from boehmite. Optionally, the first zone of the first washcoat layer further comprises filler particles comprising aluminum oxide. In some embodiments, the first zone of the first washcoat layer has a palladium loading of about 3 g/L to about 5 g/L.

In some embodiments, the first zone of the first washcoat layer comprises composite nanoparticles, the composite nanoparticles comprising a catalytic nanoparticle comprising palladium bonded to a support nanoparticle comprising aluminum oxide; porous, micron-sized metal oxide particles comprising cerium-zirconium-lanthanum oxide; and barium oxide. In some embodiments, the composite nanoparticles are provided to the washcoat slurry separately from the metal oxide particles prior to forming the washcoat layer. In some embodiments, the first zone of the first washcoat layer comprises aluminum oxide derived from boehmite. Optionally, the first zone of the first washcoat layer further comprises filler particles comprising aluminum-lanthanum oxide. In some embodiments, the first zone of the first washcoat layer has a palladium loading of about 3 g/L to about 5 g/L.

In some embodiments, the first zone of the first washcoat layer comprises composite nanoparticles, the composite nanoparticles comprising a catalytic nanoparticle comprising palladium bonded to a support nanoparticle comprising aluminum oxide; porous, micron-sized metal oxide particles comprising cerium-zirconium-yttrium oxide; and barium oxide. In some embodiments, the composite nanoparticles are provided to the washcoat slurry separately from the metal oxide particles prior to forming the washcoat layer. In some embodiments, the first zone of the first washcoat layer comprises aluminum oxide derived from boehmite. Optionally, the first zone of the first washcoat layer further comprises filler particles comprising aluminum oxide. In some embodiments, the first zone of the first washcoat layer has a palladium loading of about 3 g/L to about 5 g/L.

In some embodiments, the first zone of the first washcoat layer comprises composite nanoparticles, the composite nanoparticles comprising a catalytic nanoparticle comprising palladium bonded to a support nanoparticle comprising aluminum oxide; porous, micron-sized metal oxide particles comprising cerium-zirconium-yttrium oxide; and barium oxide. In some embodiments, the composite nanoparticles are provided to the washcoat slurry separately from the metal oxide particles prior to forming the washcoat layer. In some embodiments, the first zone of the first washcoat layer comprises aluminum oxide derived from boehmite. Optionally, the first zone of the first washcoat layer further comprises filler particles comprising aluminum-lanthanum oxide. In some embodiments, the first zone of the first washcoat layer has a palladium loading of about 3 g/L to about 5 g/L.

In some embodiments, the first zone of the first washcoat layer comprises composite nanoparticles, the composite nanoparticles comprising a catalytic nanoparticle comprising palladium bonded to a support nanoparticle comprising aluminum oxide; porous, micron-sized metal oxide particles comprising cerium-zirconium-lanthanum-yttrium oxide; and barium oxide. In some embodiments, the composite nanoparticles are provided to the washcoat slurry separately from the metal oxide particles prior to forming the washcoat layer. In some embodiments, the first zone of the first washcoat layer comprises aluminum oxide derived from boehmite. Optionally, the first zone of the first washcoat layer further comprises filler particles comprising aluminum oxide. In some embodiments, the first zone of the first washcoat layer has a palladium loading of about 3 g/L to about 5 g/L.

In some embodiments, the first zone of the first washcoat layer comprises composite nanoparticles, the composite nanoparticles comprising a catalytic nanoparticle comprising palladium bonded to a support nanoparticle comprising aluminum oxide; porous, micron-sized metal oxide particles comprising cerium-zirconium-lanthanum-yttrium oxide; and barium oxide. In some embodiments, the composite nanoparticles are provided to the washcoat slurry separately from the metal oxide particles prior to forming the washcoat layer. In some embodiments, the first zone of the first washcoat layer comprises aluminum oxide derived from boehmite. Optionally, the first zone of the first washcoat layer further comprises filler particles comprising aluminum-lanthanum oxide. In some embodiments, the first zone of the first washcoat layer has a palladium loading of about 3 g/L to about 5 g/L.

### Washcoat Slurry Useful for Forming the First Zone of the First Washcoat Layer

In some embodiments, the first zone of the first washcoat layer is formed by coating a substrate with a washcoat slurry comprising composite nanoparticles, the composite nanoparticles comprising a catalytic nanoparticle comprising palladium, platinum, or a platinum-palladium alloy bonded to a support nanoparticle, metal oxide particles, and a barium salt. In some embodiments the washcoat slurry further comprises filler particles and/or boehmite. In some embodiments, the catalytic nanoparticle comprises platinum, palladium, or a platinum-palladium alloy. In some embodiments, the catalytic nanoparticle comprises palladium and is substantially free of platinum. In some embodiments, the support particle comprises aluminum oxide. In some embodiments, the composite nanoparticles are provided separately from the metal oxide particles (i.e., a “loose configuration”). In some embodiments, the composite nanoparticles are attached to the metal oxide particles (e.g., “NNm” particles), for example by incipient wetness impregnation followed by drying and calcination. In some embodiments, the composite nanoparticles are embedded in porous metal oxide carrier material (e.g., “nano-on-nano-in-micro” or “NNiM” particles). The materials for the washcoat slurry are combined with an aqueous liquid to form a dispersion. In some embodiments, a surfactant is included in the washcoat slurry.

In some embodiments, the composite nanoparticles in the washcoat slurry useful for forming the first zone of the first washcoat layer comprise a catalytic nanoparticle bonded to a support nanoparticle. In some embodiments, the catalytic nanoparticle comprises palladium, platinum, or a platinum-palladium alloy. In some embodiments, the catalytic nanoparticle comprises palladium, which may be substantially free of platinum. In some embodiments, the composite nanoparticles in the washcoat slurry comprise a support nanoparticle comprising aluminum oxide. The palladium-aluminum oxide composite nanoparticles comprise about 20% to about 60% by weight of palladium and about 40% to about 80% by weight of aluminum oxide. For example, in some embodiments, the composite nanoparticles comprise about 30% to about 50% by weight palladium and about 50% to about 70% by weight aluminum oxide. In one embodiment, the palladium-aluminum oxide composite particles comprise about 40% by weight of palladium and about 60% by weight of aluminum oxide. In some embodiments the composite nanoparticles in the washcoat slurry are attached to the metal oxide particles (e.g., “nano-on-nano-on-micro” or “NNm” particles), for example by incipient wetness impregnation followed by drying and calcination. In some embodiments, the composite nanoparticles in the washcoat slurry are embedded in porous metal oxide carrier material (e.g., “nano-on-nano-in-micro” or “NNiM” particles). In some embodiments, the composite nanoparticles are provided to the washcoat slurry used to for the first zone of the first washcoat layer separately from the metal oxide particles (i.e., a “loose configuration”). In some embodiments, a portion of the composite nanoparticles are provided to the washcoat slurry separately from the metal oxide particles and a portion of the composite nanoparticles are attached to the metal oxide particles (such that the washcoat slurry comprises metal oxide particles, composite nanoparticles, and nano-on-nano-on-micro particles).

In some embodiments, the metal oxide particles in the washcoat slurry useful for forming the first zone of the first washcoat layer comprise metal oxide particles. In some embodiments, the metal oxide particles are cerium-containing metal oxides, such as cerium oxide and composite oxides of cerium with one or more oxides of zirconium, lanthanum and/or yttrium. In some embodiments, the metal oxide particles comprise cerium oxide. In some embodiments, the metal oxide particles comprise zirconium oxide. In some embodiments, the metal oxide particles comprise lanthanum oxide. In some embodiments, the metal oxide particles comprise yttrium oxide. In some embodiments, the metal oxide particles comprise cerium-lanthanum-yttrium oxide. In some embodiments, the metal oxide particles comprise cerium-zirconium oxide. In some embodiments, the metal oxide particles comprise cerium-lanthanum oxide. In some embodiments, the metal oxide particles comprise cerium-yttrium oxide. In some embodiment, the metal oxide particles comprise cerium-zirconium-lanthanum oxide. In some embodiments, the metal oxide particles comprise cerium-zirconium-yttrium oxide. In some embodiments, the metal oxide particles comprise cerium-zirconium-lanthanum-yttrium oxide. In some embodiments, the metal oxide particles comprise about 10% to about 70% by weight cerium oxide (such as about 20% to about 60% by weight cerium oxide, about 30% to about 50% by weight cerium oxide, or about 40% by weight cerium oxide). In some embodiments, the metal oxide particles comprise about 30% to about 90% by weight zirconium oxide (such as about 40% to about 80% by weight zirconium oxide, about 40% to about 60% by weight zirconium oxide, about 60% to about 80% by weight zirconium oxide, about 70% to about 90% by weight zirconium oxide, about 50% by weight zirconium oxide, or about 80% by weight zirconium oxide). In some embodiments, the metal oxide particles comprise about 1% to about 15% by weight yttrium oxide (such as about 2% to about 10% by weight yttrium oxide, about 3% to about 7% by weight yttrium oxide, about 4% to about 6% by weight yttrium oxide, or about 5% by weight yttrium oxide). In some embodiments, the metal oxide particles comprise about 1% to about 15% by weight lanthanum oxide (such as about 2% to about 10% by weight lanthanum oxide, about 3% to about 7% by weight lanthanum oxide, about 4% to about 6% by weight lanthanum oxide, or about 5% by weight lanthanum oxide). In some embodiments, the metal oxide particles comprise about 10% to about 70% by weight cerium oxide and about 30% to about 90% by weight zirconium oxide. In some embodiments, the metal oxide particles comprise about 10% to about 70% by weight cerium oxide, about 30% to about 90% by weight zirconium oxide and about 1% to about 15% by weight lanthanum oxide. In some embodiments, the metal oxide particles comprise about 10% to about 70% by weight cerium oxide, about 30% to about 90% by weight zirconium oxide and about 1% to about 15% by weight yttrium oxide. In some embodiments, the metal oxide particles comprise about 10% to about 70% by weight cerium oxide, about 30% to about 90% by weight zirconium oxide, about 1% to about 15% by weight lanthanum oxide, and about 1% to about 15% by weight yttrium oxide. In some embodiments, the metal oxide particles comprise about 40% cerium oxide, about 50% zirconium oxide, about 5% lanthanum oxide, and about 5% yttrium oxide. In some embodiments, the metal oxide particles are porous. In some embodiments, the metal oxide particles are micron-sized particles. In some embodiments, the metal oxide particles have a diameter between about 500 nm and about 50 microns, between about 500 nm and about 10 microns, between about 500 nm and about 5 microns, between about 1 micron and about 10 microns, between about 1 micron and about 5 microns, or between about 2 microns and about 8 microns.

In some embodiments, the washcoat slurry useful for forming the first zone of the first washcoat layer comprises a barium salt (such as barium acetate, barium sulfate, barium carbonate, barium chloride, or barium cyclohexanebutyrate). The washcoat slurry comprises an appropriate amount of the barium salt to reach the target barium oxide content of the first zone of the first washcoat layer.

In some embodiments, the washcoat slurry useful for forming the first zone of the first washcoat layer comprises boehmite. The washcoat slurry comprises an appropriate amount of boehmite to reach the target aluminum oxide derived from boehmite content in the first zone of the first washcoat layer.

In some embodiments, the washcoat slurry useful for the formation of the first zone of the first washcoat layer comprises filler particles. In some embodiments, the filler particles are metal oxide particles. In some embodiments, the filler particles are porous. In some embodiments, the filler particles comprise aluminum oxide. In some embodiments, the filler particles comprise aluminum-lanthanum oxide. Exemplary aluminum-lanthanum oxide particles are MI-386 particles, commercially available from Rhodia. In some embodiments, the filler particles are micron-sized particles. In some embodiments, the filler particles have a diameter between about 500 nm and about 50 microns, between about 500 nm and about 10 microns, between about 500 nm and about 5 microns, between about 1 micron and about 10 microns, between about 1 micron and about 5 microns, or between about 2 microns and about 8 microns.

In some embodiments, the washcoat slurry useful for the formation of the first zone of the first washcoat layer comprises about 1% to about 10% by weight composite nanoparticles (such as about 1% to about 3% by weight composite nanoparticles, about 2% to about 4% by weight composite nanoparticles, about 3% to about 5% by weight composite nanoparticles, about 4% to about 6% by weight composite nanoparticles, about 5% to about 7% by weight composite nanoparticles, about 6% to about 8% by weight composite nanoparticles, or about 7% to about 9% by weight composite nanoparticles). In some embodiments, the first zone of the first washcoat layer comprises about 40% to about 95% by weight metal oxide particles (such as about 50% to about 90% by weight metal oxide particles, about 60% to about 85% metal oxide particles, or about 70% to about 85% by weight metal oxide particles). In some embodiments, the first zone of the first washcoat layer comprises about 3% to about 20% by weight barium salt (such as about 3% to about 18% by weight barium salt, about 6% to about 15% by weight barium salt, about 8% to about 12% by weight barium salt, or about 9% to about 11% by weight barium salt). The amount of barium salt added by weight will depend on the barium salt composition (e.g., barium acetate or barium sulfate), and depend on the target barium oxide amount in the first zone of the first washcoat layer. In some embodiments, the washcoat slurry comprises about 3% to about 8% by weight boehmite (such as about 3% to about 7% by weight boehmite, about 4% to about 6% by weight boehmite, or about 5% by weight boehmite). Optionally, the washcoat slurry useful for the formation of the first zone of the first washcoat layer comprises up to about 70% by weight filler particles (such as up to about 40% by weight filler particles, for example, about 5% to about 35% by weight filler particles, about 10% to about 30% by weight filler particles, or about 15% to about 25% by weight filler particles).

In some embodiments, the washcoat slurry comprises composite nanoparticles, the composite nanoparticles comprising a catalytic nanoparticle comprising palladium bonded to a support nanoparticle comprising aluminum oxide; porous, micron-sized metal oxide particles comprising cerium oxide; and a barium salt (such as barium acetate or barium sulfate). In some embodiments, the washcoat slurry comprises boehmite. In some embodiments, the washcoat slurry comprises filler particles comprising aluminum oxide. In some embodiments, a portion of the composite nanoparticles are not attached to the micron-sized particles.

In some embodiments, the washcoat slurry comprises composite nanoparticles, the composite nanoparticles comprising a catalytic nanoparticle comprising palladium bonded to a support nanoparticle comprising aluminum oxide; porous, micron-sized metal oxide particles comprising cerium oxide; and a barium salt (such as barium acetate or barium sulfate). In some embodiments, the washcoat slurry comprises boehmite. In some embodiments, the washcoat slurry comprises filler particles comprising aluminum-lanthanum oxide. In some embodiments, a portion of the composite nanoparticles are not attached to the micron-sized particles.

In some embodiments, the washcoat slurry comprises composite nanoparticles, the composite nanoparticles comprising a catalytic nanoparticle comprising palladium bonded to a support nanoparticle comprising aluminum oxide; porous, micron-sized metal oxide particles comprising cerium-zirconium oxide; and a barium salt (such as barium acetate or barium sulfate). In some embodiments, the washcoat slurry comprises boehmite. In some embodiments, the washcoat slurry further comprises filler particles comprising aluminum oxide. In some embodiments, a portion of the composite nanoparticles are not attached to the micron-sized particles.

In some embodiments, the washcoat slurry comprises composite nanoparticles, the composite nanoparticles comprising a catalytic nanoparticle comprising palladium bonded to a support nanoparticle comprising aluminum oxide; porous, micron-sized metal oxide particles comprising cerium-zirconium-lanthanum oxide; and a barium salt (such as barium acetate or barium sulfate). In some embodiments, the washcoat slurry comprises boehmite. In some embodiments, the washcoat slurry further comprises filler particles comprising aluminum oxide. In some embodiments, the composite nanoparticles are attached to the micron-sized particles. In some embodiments, a portion of the composite nanoparticles are not attached to the micron-sized particles.

In some embodiments, the washcoat slurry comprises composite nanoparticles, the composite nanoparticles comprising a catalytic nanoparticle comprising palladium bonded to a support nanoparticle comprising aluminum oxide; porous, micron-sized metal oxide particles comprising cerium-zirconium-lanthanum oxide; and a barium salt (such as barium acetate or barium sulfate). In some embodiments, the washcoat slurry comprises boehmite. In some embodiments, the washcoat slurry further comprises filler particles comprising aluminum-lanthanum oxide. In some embodiments, a portion of the composite nanoparticles are not attached to the micron-sized particles.

In some embodiments, the washcoat slurry comprises composite nanoparticles, the composite nanoparticles comprising a catalytic nanoparticle comprising palladium bonded to a support nanoparticle comprising aluminum oxide; porous, micron-sized metal oxide particles comprising cerium-zirconium-yttrium oxide; and a barium salt (such as barium acetate or barium sulfate). In some embodiments, the washcoat slurry comprises boehmite. In some embodiments, the washcoat slurry further comprises filler particles comprising aluminum oxide. In some embodiments, a portion of the composite nanoparticles are not attached to the micron-sized particles.

In some embodiments, the washcoat slurry comprises composite nanoparticles, the composite nanoparticles comprising a catalytic nanoparticle comprising palladium bonded to a support nanoparticle comprising aluminum oxide; porous, micron-sized metal oxide particles comprising cerium-zirconium-yttrium oxide; and a barium salt (such as barium acetate or barium sulfate). In some embodiments, the washcoat slurry comprises boehmite. In some embodiments, the washcoat slurry further comprises filler particles comprising aluminum-lanthanum oxide. In some embodiments, a portion of the composite nanoparticles are not attached to the micron-sized particles.

In some embodiments, the washcoat slurry comprises composite nanoparticles, the composite nanoparticles comprising a catalytic nanoparticle comprising palladium bonded to a support nanoparticle comprising aluminum oxide; porous, micron-sized particles comprising cerium-zirconium-lanthanum-yttrium oxide; and a barium salt (such as barium acetate or barium sulfate). In some embodiments, the washcoat slurry comprises boehmite. In some embodiments, the washcoat slurry further comprises filler particles comprising aluminum oxide. In some embodiments, a portion of the composite nanoparticles are not attached to the micron-sized particles.

In some embodiments, the washcoat slurry comprises composite nanoparticles, the composite nanoparticles comprising a catalytic nanoparticle comprising palladium bonded to a support nanoparticle comprising aluminum oxide; porous, micron-sized particles comprising cerium-zirconium-lanthanum-yttrium oxide; and a barium salt (such as barium acetate or barium sulfate). In some embodiments, the washcoat slurry comprises boehmite. In some embodiments, the washcoat slurry further comprises filler particles comprising aluminum-lanthanum oxide. In some embodiments, a portion of the composite nanoparticles are not attached to the micron-sized particles.

In some embodiments, rheology modifiers, including, but not limited to, corn starch and cellulose (such as 2-hydroxyethyl cellulose) are added to adjust the washcoat slurry to the desired viscosity. In some embodiments, the rheology modifiers are added to the washcoat slurry to between about 0.5% and about 1.6% of the washcoat slurry.

In some embodiments, the washcoat slurry useful for the formation of the first washcoat layer is applied to the substrate. The substrate is then dried and calcined to form the first washcoat layer.

### Second Zone of the First Washcoat Layer

In some embodiments, the second zone of the first washcoat layer comprises (1) a composite nanoparticle comprising a catalytic nanoparticle comprising palladium, platinum, or a platinum palladium alloy bonded to a support nanoparticle (2) metal oxide particles, and (3) barium oxide. In some embodiments, the second zone of the first washcoat layer further comprises aluminum oxide, a portion of which may be, for example, derived from boehmite. In some embodiments, the second zone of the first washcoat layer further comprises filler particles.

The composite nanoparticles comprise a catalytic nanoparticle bonded to a support nanoparticle. In some embodiments, the catalytic nanoparticle in the first zone of the first washcoat layer comprises palladium, platinum, or a platinum-palladium alloy. In some embodiments, the catalytic nanoparticles comprise palladium, which may be substantially free of platinum. In some embodiments, the support nanoparticle comprises a metal oxide, for example, one or more of cerium oxide, zirconium oxide, lanthanum oxide, or yttrium oxide. The palladium-metal oxide composite nanoparticles comprise about 1% to about 50% (for example, about 10% to about 50%) by weight of palladium and about 50% to about 99% (for example, about 50% to about 90%) by weight of metal oxide. For example, in some embodiments, the composite nanoparticles comprise about 20% to about 40% by weight of palladium and about 60% to about 80% by weight metal oxide. In one embodiment, the palladium-metal oxide composite nanoparticles comprise about 30% by weight of palladium and about 70% by weight of metal oxide. Metal oxide which can be used in the support nanoparticles are typically cerium-containing metal oxides, including cerium oxide and composite oxides of cerium with one or more oxides of zirconium, lanthanum and/or yttrium. In some embodiments, the support nanoparticle comprises cerium oxide. In some embodiments, the support nanoparticle comprises zirconium oxide. In some embodiments, the support nanoparticle comprises lanthanum oxide. In some embodiments, the support nanoparticle comprises yttrium oxide. In some embodiments, the support nanoparticle comprises cerium-zirconium oxide. In some embodiments, the support nanoparticle comprises cerium-lanthanum oxide. In some embodiments, the support nanoparticle comprises cerium-yttrium oxide. In some embodiments, the support nanoparticle comprises cerium-lanthanum-yttrium oxide. In some embodiment, the support nanoparticle comprises cerium-zirconium-lanthanum oxide. In some embodiments, the support nanoparticle comprises cerium-zirconium-yttrium oxide. In some embodiments, the support nanoparticle comprises cerium-zirconium-lanthanum-yttrium oxide. In some embodiments, the support nanoparticle comprises about 10% to about 70% by weight cerium oxide (such as about 20% to about 60% by weight cerium oxide, about 30% to about 50% by weight cerium oxide, or about 40% by weight cerium oxide). In some embodiments, the support nanoparticle comprises about 30% to about 90% by weight zirconium oxide (such as about 40% to about 80% by weight zirconium oxide, about 40% to about 60% by weight zirconium oxide, about 60% to about 80% by weight zirconium oxide, about 70% to about 90% by weight zirconium oxide, about 50% by weight zirconium oxide, or about 80% by weight zirconium oxide). In some embodiments, the support nanoparticle comprises about 1% to about 15% by weight yttrium oxide (such as about 2% to about 10% by weight yttrium oxide, about 3% to about 7% by weight yttrium oxide, about 4% to about 6% by weight yttrium oxide, or about 5% by weight yttrium oxide). In some embodiments, the support nanoparticle comprises about 1% to about 15% by weight lanthanum oxide (such as about 2% to about 10% by weight lanthanum oxide, about 3% to about 7% by weight lanthanum oxide, about 4% to about 6% by weight lanthanum oxide, or about 5% by weight lanthanum oxide). In some embodiments, the support nanoparticle comprises about 10% to about 70% by weight cerium oxide and about 30% to about 90% by weight zirconium oxide. In some embodiments, the support nanoparticle comprises about 10% to about 70% by weight cerium oxide, about 30% to about 90% by weight zirconium oxide and about 1% to about 15% by weight lanthanum oxide. In some embodiments, the support nanoparticle comprises about 10% to about 70% by weight cerium oxide, about 30% to about 90% by weight zirconium oxide and about 1% to about 15% by weight yttrium oxide. In some embodiments, the support nanoparticle comprises about 10% to about 70% by weight cerium oxide, about 30% to about 90% by weight zirconium oxide, about 1% to about 15% by weight lanthanum oxide, and about 1% to about 15% by weight yttrium oxide. In some embodiments, the support nanoparticle consists essentially of cerium oxide. In some embodiments the composite nanoparticles are attached to the metal oxide particles (e.g., “nano-on-nano-on-micro” or “NNm” particles), for example by incipient wetness impregnation followed by drying and calcination. In some embodiments, the composite nanoparticles are provided to the washcoat slurry used to for the second zone of the first washcoat layer separately from the metal oxide particles (i.e., a “loose configuration”). In some embodiments, a portion of the composite nanoparticles are provided to the washcoat slurry separately from the metal oxide particles and a portion of the composite nanoparticles are attached to the metal oxide particles (such that the washcoat slurry comprises metal oxide particles, composite nanoparticles, and nano-on-nano-on-micro particles). In some embodiments, the composite nanoparticles are embedded in porous metal oxide carrier material (e.g., “nano-on-nano-in-micro” or “NNiM” particles).

Metal oxide particles which can be used in the second zone of the first washcoat layer are typically cerium-containing metal oxides, including cerium oxide and composite oxides of cerium with one or more oxides of zirconium, lanthanum and/or yttrium. In some embodiments, the metal oxide particles comprise cerium oxide. In some embodiments, the metal oxide particles comprise zirconium oxide. In some embodiments, the metal oxide particles comprise lanthanum oxide. In some embodiments, the metal oxide particles comprise yttrium oxide. In some embodiments, the metal oxide particles comprise cerium-zirconium oxide. In some embodiments, the metal oxide particles comprise cerium-lanthanum oxide. In some embodiments, the metal oxide particles comprise cerium-yttrium oxide. In some embodiment, the metal oxide particles comprise cerium-zirconium-lanthanum oxide. In some embodiments, the metal oxide particles comprise cerium-lanthanum-yttrium oxide. In some embodiments, the metal oxide particles comprise cerium-zirconium-yttrium oxide. In some embodiments, the metal oxide particles comprise cerium-zirconium-lanthanum-yttrium oxide. In some embodiments, the metal oxide particles comprise about 10% to about 70% by weight cerium oxide (such as about 20% to about 60% by weight cerium oxide, about 30% to about 50% by weight cerium oxide, or about 40% by weight cerium oxide). In some embodiments, the metal oxide particles comprise about 30% to about 90% by weight zirconium oxide (such as about 40% to about 80% by weight zirconium oxide, about 40% to about 60% by weight zirconium oxide, about 60% to about 80% by weight zirconium oxide, about 70% to about 90% by weight zirconium oxide, about 50% by weight zirconium oxide, or about 80% by weight zirconium oxide). In some embodiments, the metal oxide particles comprise about 1% to about 15% by weight yttrium oxide (such as about 2% to about 10% by weight yttrium oxide, about 3% to about 7% by weight yttrium oxide, about 4% to about 6% by weight yttrium oxide, or about 5% by weight yttrium oxide). In some embodiments, the metal oxide particles comprise about 1% to about 15% by weight lanthanum oxide (such as about 2% to about 10% by weight lanthanum oxide, about 3% to about 7% by weight lanthanum oxide, about 4% to about 6% by weight lanthanum oxide, or about 5% by weight lanthanum oxide). In some embodiments, the metal oxide particles comprise about 10% to about 70% by weight cerium oxide and about 30% to about 90% by weight zirconium oxide. In some embodiments, the metal oxide particles comprise about 10% to about 70% by weight cerium oxide, about 30% to about 90% by weight zirconium oxide and about 1% to about 15% by weight lanthanum oxide. In some embodiments, the metal oxide particles comprise about 10% to about 70% by weight cerium oxide, about 30% to about 90% by weight zirconium oxide and about 1% to about 15% by weight yttrium oxide. In some embodiments, the metal oxide particles comprise about 10% to about 70% by weight cerium oxide, about 30% to about 90% by weight zirconium oxide, about 1% to about 15% by weight lanthanum oxide, and about 1% to about 15% by weight yttrium oxide. In some embodiments, the metal oxide particles comprise about 40% cerium oxide, about 50% zirconium oxide, about 5% lanthanum oxide, and about 5% yttrium oxide. In some embodiments, the metal oxide particles are porous. In some embodiments, the metal oxide particles are micron-sized particles. In some embodiments, the metal oxide particles have a diameter between about 500 nm and about 50 microns, between about 500 nm and about 10 microns, between about 500 nm and about 5 microns, between about 1 micron and about 10 microns, between about 1 micron and about 5 microns, or between about 2 microns and about 8 microns.

In some embodiments, the second zone of the first washcoat layer comprises barium oxide. In some embodiments, the barium oxide is produced by adding an amount of barium salt (such as barium acetate, barium sulfate, barium carbonate, barium chloride, or barium cyclohexanebutyrate) to the washcoat slurry used to form the second zone of the first washcoat layer. In some embodiments, the barium salt is dissolved in the washcoat slurry. Upon calcining the coated substrate, the barium salt converts into barium oxide.

In some embodiments, the second zone of the first washcoat layer comprises aluminum oxide, a portion of which may be, for example, derived from boehmite. Boehmite provided in the washcoat slurry is converted into aluminum oxide after the washcoat slurry is coated onto the substrate and the coated substrate is calcined. The aluminum oxide derived from boehmite increases adhesion of the second zone of the first washcoat layer.

In some embodiments, the second zone of the first washcoat layer comprises filler particles. In some embodiments, the filler particles are metal oxide particles. In some embodiments, the filler particles are porous. In some embodiments, the filler particles comprise aluminum oxide. In some embodiments, the filler particles comprise aluminum-lanthanum oxide. Exemplary aluminum-lanthanum oxide particles are MI-386 particles, commercially available from Rhodia. In some embodiments, the filler particles are micron-sized particles. In some embodiments, the filler particles have a diameter between about 500 nm and about 50 microns, between about 500 nm and about 10 microns, between about 500 nm and about 5 microns, between about 1 micron and about 10 microns, between about 1 micron and about 5 microns, or between about 2 microns and about 8 microns.

In some embodiments, the second zone of the first washcoat layer comprises about 0.5% to about 3% by weight composite nanoparticles (such as about 0.5% to about 1.5% by weight composite nanoparticles, about 1% to about 2% by weight composite nanoparticles, about 1.5% to about 2.5% by weight composite nanoparticles, or about 2% to about 3% by weight composite nanoparticles). In some embodiments, the second zone of the first washcoat layer comprises about 40% to about 97% by weight metal oxide particles (such as about 50% to about 96% by weight metal oxide particles, about 60% to about 95% metal oxide particles, or about 70% to about 90% by weight metal oxide particles). In some embodiments, the second zone of the first washcoat layer comprises about 3% to about 20% by weight barium oxide (such as about 3% to about 18% by weight barium oxide, about 3% to about 15% by weight barium oxide, about 3% to about 10% by weight barium oxide, about 3% to about 8% by weight barium oxide, about 6% to about 15% by weight barium oxide, about 6% to about 10% by weight barium oxide, or about 6% to about 8% by weight barium oxide). In some embodiments, the second zone of the first washcoat layer comprises about 3% to about 8% by weight aluminum oxide derived from boehmite (such as about 3% to about 7% by weight aluminum oxide derived from boehmite, about 4% to about 6% by weight aluminum oxide derived from boehmite, or about 5% by weight aluminum oxide derived from boehmite). In some embodiments, the second zone of the first washcoat layer comprises up to about 70% by weight filler particles (such as up to about 40% by weight filler particles, for example, about 5% to about 35% by weight filler particles, about 10% to about 30% by weight filler particles, or about 15% to about 25% by weight filler particles). In some embodiments, the second zone of the first washcoat layer is coated onto the substrate the substrate at about 150 g/L to about 250 g/L (such as about 165 g/L to about 240 g/L, about 180 g/L to about 230 g/L, or about 190 g/L to about 220 g/L). In some embodiments, the second zone of the first washcoat layer has a platinum group metal (e.g., palladium) loading of about 0.1 g/L to about 1.5 g/L (such as about 0.2 g/L to about 1.4 g/L, about 0.4 g/L to about 1.3 g/L, about 0.6 g/L to about 1.2 g/L, or about 0.8 g/L to about 1.1 g/L).

In some embodiments, the second zone of the first washcoat layer comprises composite nanoparticles, the composite nanoparticles comprising a catalytic nanoparticle comprising palladium bonded to a support nanoparticle comprising cerium oxide; porous, micron-sized metal oxide particles comprising cerium oxide; and barium oxide. In some embodiments, the composite nanoparticles are provided to the washcoat slurry separately from the metal oxide particles prior to forming the washcoat layer. In some embodiments, the second zone of the first washcoat layer comprises aluminum oxide derived from boehmite. Optionally, the second zone of the first washcoat layer further comprises filler particles comprising aluminum oxide. In some embodiments, the second zone of the first washcoat has a palladium loading of about 0.3 g/L to about 1.2 g/L.

In some embodiments, the second zone of the first washcoat layer comprises composite nanoparticles, the composite nanoparticles comprising a catalytic nanoparticle comprising palladium bonded to a support nanoparticle comprising cerium oxide; porous, micron-sized metal oxide particles comprising cerium oxide; and barium oxide. In some embodiments, the composite nanoparticles are provided to the washcoat slurry separately from the metal oxide particles prior to forming the washcoat layer. In some embodiments, the second zone of the first washcoat layer comprises aluminum oxide derived from boehmite. Optionally, the second zone of the first washcoat layer further comprises filler particles comprising aluminum-lanthanum oxide. In some embodiments, the second zone of the first washcoat has a palladium loading of about 0.3 g/L to about 1.2 g/L.

In some embodiments, the second zone of the first washcoat layer comprises composite nanoparticles, the composite nanoparticles comprising a catalytic nanoparticle comprising palladium bonded to a support nanoparticle comprising cerium oxide; porous, micron-sized metal oxide particles comprising cerium-zirconium oxide; and barium oxide. In some embodiments, the composite nanoparticles are provided to the washcoat slurry separately from the metal oxide particles prior to forming the washcoat layer. In some embodiments, the second zone of the first washcoat layer comprises aluminum oxide derived from boehmite. Optionally, the second zone of the first washcoat layer further comprises filler particles comprising aluminum oxide. In some embodiments, the second zone of the first washcoat layer has a palladium loading of about 0.3 g/L to about 1.2 g/L.

In some embodiments, the second zone of the first washcoat layer comprises composite nanoparticles, the composite nanoparticles comprising a catalytic nanoparticle comprising palladium bonded to a support nanoparticle comprising cerium oxide; porous, micron-sized metal oxide particles comprising cerium-zirconium oxide; and barium oxide. In some embodiments, the composite nanoparticles are provided to the washcoat slurry separately from the metal oxide particles prior to forming the washcoat layer. In some embodiments, the second zone of the first washcoat layer comprises aluminum oxide derived from boehmite. Optionally, the second zone of the first washcoat layer further comprises filler particles comprising aluminum-lanthanum oxide. In some embodiments, the second zone of the first washcoat layer has a palladium loading of about 0.3 g/L to about 1.2 g/L.

In some embodiments, the second zone of the first washcoat layer comprises composite nanoparticles, the composite nanoparticles comprising a catalytic nanoparticle comprising palladium bonded to a support nanoparticle comprising cerium oxide; porous, micron-sized metal oxide particles comprising cerium-zirconium-lanthanum oxide; and barium oxide. In some embodiments, the second zone of the first washcoat layer comprises aluminum oxide derived from boehmite. Optionally, the second zone of the first washcoat layer further comprises filler particles comprising aluminum oxide. In some embodiments, the second zone of the first washcoat layer has a palladium loading of about 0.3 g/L to about 1.2 g/L.

In some embodiments, the second zone of the first washcoat layer comprises composite nanoparticles, the composite nanoparticles comprising a catalytic nanoparticle comprising palladium bonded to a support nanoparticle comprising cerium oxide; porous, micron-sized metal oxide particles comprising cerium-zirconium-lanthanum oxide; and barium oxide. In some embodiments, the second zone of the first washcoat layer comprises aluminum-lanthanum oxide derived from boehmite. Optionally, the second zone of the first washcoat layer further comprises filler particles comprising aluminum oxide. In some embodiments, the second zone of the first washcoat layer has a palladium loading of about 0.3 g/L to about 1.2 g/L.

In some embodiments, the second zone of the first washcoat layer comprises composite nanoparticles, the composite nanoparticles comprising a catalytic nanoparticle comprising palladium bonded to a support nanoparticle comprising cerium oxide; porous, micron-sized particles comprising cerium-zirconium-yttrium-lanthanum oxide; and barium oxide. In some embodiments, the second zone of the first washcoat layer comprises aluminum oxide derived from boehmite. Optionally, the second zone of the first washcoat layer further comprises filler particles comprising aluminum oxide. In some embodiments, the first zone of the first washcoat has a palladium loading of about 0.3 g/L to about 1.2 g/L.

In some embodiments, the second zone of the first washcoat layer comprises composite nanoparticles, the composite nanoparticles comprising a catalytic nanoparticle comprising palladium bonded to a support nanoparticle comprising cerium oxide; porous, micron-sized particles comprising cerium-zirconium-yttrium-lanthanum oxide; and barium oxide. In some embodiments, the second zone of the first washcoat layer comprises aluminum oxide derived from boehmite. Optionally, the second zone of the first washcoat layer further comprises filler particles comprising aluminum-lanthanum oxide. In some embodiments, the first zone of the first washcoat has a palladium loading of about 0.3 g/L to about 1.2 g/L.

### Washcoat Slurry Useful for Forming Second Zone of the First Washcoat Layer

In some embodiments, the second zone of the first washcoat layer is formed by coating the substrate with a washcoat slurry comprising composite nanoparticles, the composite nanoparticles comprising a catalytic nanoparticle comprising palladium, platinum, or a platinum-palladium alloy bonded to a support nanoparticle, and metal oxide particles. In some embodiments, the washcoat slurry comprises boehmite and/or filler particles. In some embodiments, the washcoat slurry comprises a barium salt. In some embodiments, the composite nanoparticles are provided separately from the metal oxide particles (i.e., a “loose configuration”). In some embodiments, the composite nanoparticles are attached to the metal oxide particles (e.g., “NNm” particles), for example by incipient wetness impregnation followed by drying and calcination. In some embodiments, a portion of the composite nanoparticles are provided to the washcoat slurry separately from the metal oxide particles and a portion of the composite nanoparticles are attached to the metal oxide particles (such that the washcoat slurry comprises metal oxide particles, composite nanoparticles, and nano-on-nano-on-micro particles). In some embodiments, the composite nanoparticles are embedded in porous metal oxide carrier material (e.g., “nano-on-nano-in-micro” or “NNiM” particles). The materials for the washcoat slurry are combined in an aqueous liquid to form a dispersion. In some embodiments, a surfactant is included in the washcoat slurry.

The composite nanoparticles comprise a catalytic nanoparticle bonded to a support nanoparticle. In some embodiments, the catalytic nanoparticle in the second zone of the first washcoat layer comprises palladium, platinum, or a platinum-palladium alloy. In some embodiments, the catalytic nanoparticles comprise palladium, which may be substantially free of platinum. In some embodiments, the support nanoparticle comprises a metal oxide. The palladium-metal oxide composite nanoparticles comprise about 1% to about 50% (such as about 10% to about 50%) by weight of palladium and about 50% to about 99% (such as about 50% to about 90%) by weight of metal oxide. For example, in some embodiments, the composite nanoparticles comprise about 20% to about 40% by weight of palladium and about 60% to about 80% by weight metal oxide. In one embodiment, the palladium-metal oxide composite nanoparticles comprise about 30% by weight of palladium and about 70% by weight of metal oxide. Metal oxide which can be used in the support nanoparticles are typically cerium-containing metal oxides, including cerium oxide and composite oxides of cerium with one or more oxides of zirconium, lanthanum and/or yttrium. In some embodiments, the support nanoparticle comprises cerium oxide. In some embodiments, the support nanoparticle comprises zirconium oxide. In some embodiments, the support nanoparticle comprises lanthanum oxide. In some embodiments, the support nanoparticle comprises yttrium oxide. In some embodiments, the support nanoparticle comprises cerium-zirconium oxide. In some embodiments, the support nanoparticle comprises cerium-lanthanum oxide. In some embodiments, the support nanoparticle comprises cerium-yttrium oxide. In some embodiments, the support nanoparticle comprises cerium-lanthanum-yttrium oxide. In some embodiment, the support nanoparticle comprises cerium-zirconium-lanthanum oxide. In some embodiments, the support nanoparticle comprises cerium-zirconium-yttrium oxide. In some embodiments, the support nanoparticle comprises cerium-zirconium-lanthanum-yttrium oxide. In some embodiments, the support nanoparticle comprises about 10% to about 70% by weight cerium oxide (such as about 20% to about 60% by weight cerium oxide, about 30% to about 50% by weight cerium oxide, or about 40% by weight cerium oxide). In some embodiments, the support nanoparticle comprises about 30% to about 90% by weight zirconium oxide (such as about 40% to about 80% by weight zirconium oxide, about 40% to about 60% by weight zirconium oxide, about 60% to about 80% by weight zirconium oxide, about 70% to about 90% by weight zirconium oxide, about 50% by weight zirconium oxide, or about 80% by weight zirconium oxide). In some embodiments, the support nanoparticle comprises about 1% to about 15% by weight yttrium oxide (such as about 2% to about 10% by weight yttrium oxide, about 3% to about 7% by weight yttrium oxide, about 4% to about 6% by weight yttrium oxide, or about 5% by weight yttrium oxide). In some embodiments, the support nanoparticle comprises about 1% to about 15% by weight lanthanum oxide (such as about 2% to about 10% by weight lanthanum oxide, about 3% to about 7% by weight lanthanum oxide, about 4% to about 6% by weight lanthanum oxide, or about 5% by weight lanthanum oxide). In some embodiments, the support nanoparticle comprises about 10% to about 70% by weight cerium oxide and about 30% to about 90% by weight zirconium oxide. In some embodiments, the support nanoparticle comprises about 10% to about 70% by weight cerium oxide, about 30% to about 90% by weight zirconium oxide and about 1% to about 15% by weight lanthanum oxide. In some embodiments, the support nanoparticle comprises about 10% to about 70% by weight cerium oxide, about 30% to about 90% by weight zirconium oxide and about 1% to about 15% by weight yttrium oxide. In some embodiments, the support nanoparticle comprises about 10% to about 70% by weight cerium oxide, about 30% to about 90% by weight zirconium oxide, about 1% to about 15% by weight lanthanum oxide, and about 1% to about 15% by weight yttrium oxide. In some embodiments, the support nanoparticle comprises about 40% cerium oxide, about 50% zirconium oxide, about 5% lanthanum oxide, and about 5% yttrium oxide. In some embodiments the composite nanoparticles are attached to the metal oxide particles (e.g., “nano-on-nano-on-micro” or “NNm” particles), for example by incipient wetness impregnation followed by drying and calcination. In some embodiments, the composite nanoparticles are provided to the washcoat slurry used to for the second zone of the first washcoat layer separately from the metal oxide particles (i.e., a “loose configuration”). In some embodiments, a portion of the composite nanoparticles are provided to the washcoat slurry separately from the metal oxide particles and a portion of the composite nanoparticles are attached to the metal oxide particles (such that the washcoat slurry comprises metal oxide particles, composite nanoparticles, and nano-on-nano-on-micro particles). In some embodiments, the composite nanoparticles are embedded in porous metal oxide carrier material (e.g., “nano-on-nano-in-micro” or “NNiM” particles).

In some embodiments, the metal oxide particles in the washcoat slurry useful for forming the second zone of the first washcoat layer comprise cerium-containing metal oxides, such as cerium oxide and composite oxides of cerium with one or more oxides of zirconium, lanthanum and/or yttrium. In some embodiments, the metal oxide particles comprise cerium oxide. In some embodiments, the metal oxide particles comprise zirconium oxide. In some embodiments, the metal oxide particles comprise lanthanum oxide. In some embodiments, the metal oxide particles comprise yttrium oxide. In some embodiments, the metal oxide particles comprise cerium-lanthanum-yttrium oxide. In some embodiments, the metal oxide particles comprise cerium-zirconium oxide. In some embodiments, the metal oxide particles comprise cerium-lanthanum oxide. In some embodiments, the metal oxide particles comprise cerium-yttrium oxide. In some embodiment, the metal oxide particles comprise cerium-zirconium-lanthanum oxide. In some embodiments, the metal oxide particles comprise cerium-zirconium-yttrium oxide. In some embodiments, the metal oxide particles comprise cerium-zirconium-lanthanum-yttrium oxide. In some embodiments, the metal oxide particles comprise about 10% to about 70% by weight cerium oxide (such as about 20% to about 60% by weight cerium oxide, about 30% to about 50% by weight cerium oxide, or about 40% by weight cerium oxide). In some embodiments, the metal oxide particles comprise about 30% to about 90% by weight zirconium oxide (such as about 40% to about 80% by weight zirconium oxide, about 40% to about 60% by weight zirconium oxide, about 60% to about 80% by weight zirconium oxide, about 70% to about 90% by weight zirconium oxide, about 50% by weight zirconium oxide, or about 80% by weight zirconium oxide). In some embodiments, the metal oxide particles comprise about 1% to about 15% by weight yttrium oxide (such as about 2% to about 10% by weight yttrium oxide, about 3% to about 7% by weight yttrium oxide, about 4% to about 6% by weight yttrium oxide, or about 5% by weight yttrium oxide). In some embodiments, the metal oxide particles comprise about 1% to about 15% by weight lanthanum oxide (such as about 2% to about 10% by weight lanthanum oxide, about 3% to about 7% by weight lanthanum oxide, about 4% to about 6% by weight lanthanum oxide, or about 5% by weight lanthanum oxide). In some embodiments, the metal oxide particles comprise about 10% to about 70% by weight cerium oxide and about 30% to about 90% by weight zirconium oxide. In some embodiments, the metal oxide particles comprise about 10% to about 70% by weight cerium oxide, about 30% to about 90% by weight zirconium oxide and about 1% to about 15% by weight lanthanum oxide. In some embodiments, the metal oxide particles comprise about 10% to about 70% by weight cerium oxide, about 30% to about 90% by weight zirconium oxide and about 1% to about 15% by weight yttrium oxide. In some embodiments, the metal oxide particles comprise about 10% to about 70% by weight cerium oxide, about 30% to about 90% by weight zirconium oxide, about 1% to about 15% by weight lanthanum oxide, and about 1% to about 15% by weight yttrium oxide. In some embodiments, the metal oxide particles comprise about 40% cerium oxide, about 50% zirconium oxide, about 5% lanthanum oxide, and about 5% yttrium oxide. In some embodiments, the metal oxide particles are porous. In some embodiments, the metal oxide particles are micron-sized particles. In some embodiments, the metal oxide particles have a diameter between about 500 nm and about 50 microns, between about 500 nm and about 10 microns, between about 500 nm and about 5 microns, between about 1 micron and about 10 microns, between about 1 micron and about 5 microns, or between about 2 microns and about 8 microns.

In some embodiments, the washcoat slurry useful for forming the second zone of the first washcoat layer comprises a barium salt (such as barium acetate, barium carbonate, barium chloride, or barium cyclohexanebutyrate). The washcoat slurry comprises an appropriate amount of the barium salt to reach the target barium oxide content of the second zone of the first washcoat layer.

In some embodiments, the washcoat slurry useful for forming the second zone of the first washcoat layer comprises boehmite. The washcoat slurry comprises an appropriate amount of boehmite to reach the target aluminum oxide derived from boehmite content in the second zone of the first washcoat layer.

In some embodiments, the washcoat slurry useful for making the second zone of the first washcoat layer comprises filler particles. In some embodiments, the filler particles are metal oxide particles. In some embodiments, the filler particles are porous. In some embodiments, the filler particles are aluminum oxide particles. In some embodiments, the filler particles are lanthanum-stabilized aluminum oxide particles. Exemplary lanthanum-stabilized aluminum oxide particles are MI-386 particles, commercially available from Rhodia. In some embodiments, the filler particles are micron-sized particles. In some embodiments, the filler particles have a diameter between about 500 nm and about 50 microns, between about 500 nm and about 10 microns, between about 500 nm and about 5 microns, between about 1 micron and about 10 microns, between about 1 micron and about 5 microns, or between about 2 microns and about 8 microns.

In some embodiments, the washcoat slurry useful for forming the second zone of the first washcoat layer comprises about 0.5% to about 3% by weight composite nanoparticles (such as about 0.5% to about 1.5% by weight composite nanoparticles, about 1% to about 2% by weight composite nanoparticles, about 1.5% to about 2.5% by weight composite nanoparticles, or about 2% to about 3% by weight composite nanoparticles). In some embodiments, the washcoat slurry useful for forming the second zone of the first washcoat layer comprises about 40% to about 97% by weight metal oxide particles (such as about 50% to about 96% by weight metal oxide particles, about 60% to about 95% metal oxide particles, or about 70% to about 90% by weight metal oxide particles). In some embodiments, the washcoat slurry useful for forming the second zone of the first washcoat layer comprises about 3% to about 8% by weight boehmite (such as about 3% to about 7% by weight boehmite, about 4% to about 6% by weight boehmite, or about 5% by weight boehmite). In some embodiments, the washcoat slurry comprises about 3% to about 20% by weight barium salt (such as about 3% to about 18% by weight barium salt, about 6% to about 15% by weight barium salt, about 8% to about 12% by weight barium salt, or about 9% to about 11% by weight barium salt). The amount of barium salt added by weight will depend on the barium salt composition (e.g., barium acetate or barium sulfate), and depend on the target barium oxide amount in the first zone of the first washcoat layer. Optionally, the washcoat slurry useful for forming the second zone of the first washcoat layer comprises up to about 70% by weight filler particles (such as up to about 40% by weight filler particles, for example, about 5% to about 35% by weight filler particles, about 10% to about 30% by weight filler particles, or about 15% to about 25% by weight filler particles).

In some embodiments, the washcoat slurry useful for forming the second zone of the first washcoat layer comprises composite nanoparticles, the composite nanoparticles comprising a catalytic nanoparticle comprising palladium bonded to a support nanoparticle comprising cerium oxide; porous, micron-sized metal oxide particles comprising cerium oxide; and a barium salt (such as barium acetate or barium sulfate). In some embodiments, the washcoat slurry comprises boehmite. Optionally, the washcoat slurry further comprises filler particles comprising aluminum oxide. In some embodiments, a portion of the composite nanoparticles are not attached to the micron-sized particles.

In some embodiments, the washcoat slurry useful for forming the second zone of the first washcoat layer comprises composite nanoparticles, the composite nanoparticles comprising a catalytic nanoparticle comprising palladium bonded to a support nanoparticle comprising cerium oxide; porous, micron-sized metal oxide particles comprising cerium oxide; and a barium salt (such as barium acetate or barium sulfate). In some embodiments, the washcoat slurry comprises boehmite. Optionally, the washcoat slurry further comprises filler particles comprising aluminum-lanthanum oxide. In some embodiments, a portion of the composite nanoparticles are not attached to the micron-sized particles.

In some embodiments, the washcoat slurry useful for forming the second zone of the first washcoat layer comprises composite nanoparticles, the composite nanoparticles comprising a catalytic nanoparticle comprising palladium bonded to a support nanoparticle comprising cerium oxide; porous, micron-sized metal oxide particles comprising cerium-zirconium oxide; and a barium salt (such as barium acetate or barium sulfate). In some embodiments, the washcoat slurry comprises boehmite. Optionally, the washcoat slurry further comprises filler particles comprising aluminum oxide. In some embodiments, a portion of the composite nanoparticles are not attached to the micron-sized particles.

In some embodiments, the washcoat slurry useful for forming the second zone of the first washcoat layer comprises composite nanoparticles, the composite nanoparticles comprising a catalytic nanoparticle comprising palladium bonded to a support nanoparticle comprising cerium oxide; porous, micron-sized metal oxide particles comprising cerium-zirconium oxide; and a barium salt (such as barium acetate or barium sulfate). In some embodiments, the washcoat slurry comprises boehmite. Optionally, the washcoat slurry further comprises filler particles comprising aluminum-lanthanum oxide. In some embodiments, a portion of the composite nanoparticles are not attached to the micron-sized particles.

In some embodiments, the washcoat slurry useful for forming the second zone of the first washcoat layer comprises composite nanoparticles, the composite nanoparticles comprising a catalytic nanoparticle comprising palladium bonded to a support nanoparticle comprising cerium oxide; porous, micron-sized metal oxide particles comprising cerium-zirconium-lanthanum oxide; and a barium salt (such as barium acetate or barium sulfate). In some embodiments, the washcoat slurry comprises boehmite. Optionally, the washcoat slurry further comprises filler particles comprising aluminum oxide. In some embodiments, a portion of the composite nanoparticles are not attached to the micron-sized particles.

In some embodiments, the washcoat slurry useful for forming the second zone of the first washcoat layer comprises composite nanoparticles, the composite nanoparticles comprising a catalytic nanoparticle comprising palladium bonded to a support nanoparticle comprising cerium oxide; porous, micron-sized metal oxide particles comprising cerium-zirconium-lanthanum oxide; and a barium salt (such as barium acetate or barium sulfate). In some embodiments, the washcoat slurry comprises boehmite. Optionally, the washcoat slurry further comprises filler particles comprising aluminum-lanthanum oxide. In some embodiments, a portion of the composite nanoparticles are not attached to the micron-sized particles.

In some embodiments, the washcoat slurry useful for forming the second zone of the first washcoat layer comprises composite nanoparticles, the composite nanoparticles comprising a catalytic nanoparticle comprising palladium bonded to a support nanoparticle comprising cerium oxide; porous, micron-sized metal oxide particles comprising cerium-zirconium-yttrium oxide; and a barium salt (such as barium acetate or barium sulfate). In some embodiments, the washcoat slurry comprises boehmite. Optionally, the washcoat slurry further comprises filler particles comprising aluminum oxide. In some embodiments, a portion of the composite nanoparticles are not attached to the micron-sized particles.

In some embodiments, the washcoat slurry useful for forming the second zone of the first washcoat layer comprises composite nanoparticles, the composite nanoparticles comprising a catalytic nanoparticle comprising palladium bonded to a support nanoparticle comprising cerium oxide; porous, micron-sized metal oxide particles comprising cerium-zirconium-yttrium oxide; and a barium salt (such as barium acetate or barium sulfate). In some embodiments, the washcoat slurry comprises boehmite. Optionally, the washcoat slurry further comprises filler particles comprising aluminum-lanthanum oxide. In some embodiments, a portion of the composite nanoparticles are not attached to the micron-sized particles.

In some embodiments, the washcoat slurry useful for forming the second zone of the first washcoat layer comprises composite nanoparticles, the composite nanoparticles comprising a catalytic nanoparticle comprising palladium bonded to a support nanoparticle comprising cerium oxide; porous, micron-sized metal oxide particles comprising cerium-zirconium-lanthanum-yttrium oxide; and a barium salt (such as barium acetate or barium sulfate). In some embodiments, the washcoat slurry comprises boehmite. Optionally, the washcoat slurry further comprises filler particles comprising aluminum oxide. In some embodiments, a portion of the composite nanoparticles are not attached to the micron-sized particles.

In some embodiments, the washcoat slurry useful for forming the second zone of the first washcoat layer comprises composite nanoparticles, the composite nanoparticles comprising a catalytic nanoparticle comprising palladium bonded to a support nanoparticle comprising cerium oxide; porous, micron-sized metal oxide particles comprising cerium-zirconium-lanthanum-yttrium oxide; and a barium salt (such as barium acetate or barium sulfate). In some embodiments, the washcoat slurry comprises boehmite. Optionally, the washcoat slurry further comprises filler particles comprising aluminum-lanthanum oxide. In some embodiments, a portion of the composite nanoparticles are not attached to the micron-sized particles.

In some embodiments, rheology modifiers, including, but not limited to, corn starch and cellulose (such as 2-hydroxyethyl cellulose) are added to adjust the washcoat slurry to the desired viscosity. In some embodiments, the rheology modifiers are added to the washcoat slurry to between about 0.5% and about 1.6% of the washcoat slurry.

In some embodiments, the washcoat slurry useful for the formation of the second zone of the first washcoat layer is applied to the substrate. The substrate is then dried and calcined to form the second zone of the first washcoat layer.

### Washcoat Formulations for the Second Layer of Coated Substrate

In some embodiments, the second washcoat layer coats the substrate on top of the first washcoat layer. The second washcoat layer can coat the substrate coated with the first washcoat layer described herein, which may be, for example, in the two zone configuration or the non-zoned configuration. It is understood that one or more washcoat layer could be provided between the first washcoat layer and the second washcoat layer.

### Second Washcoat Layer

In some embodiments, the second washcoat layer comprises (1) a composite nanoparticle comprising a catalytic nanoparticle comprising rhodium bonded to a support nanoparticle and (2) metal oxide particles. In some embodiments, the second washcoat layer further comprises aluminum oxide, a portion of which may be, for example, derived from boehmite. In some embodiments, the second washcoat layer further comprises filler particles. In some embodiments, the composite nanoparticles are provided separately from the metal oxide particles (i.e., a “loose configuration”). In some embodiments, the composite nanoparticles are attached to the metal oxide particles (e.g., “NNm” particles), for example by incipient wetness impregnation followed by drying and calcination. In some embodiments, a portion of the composite nanoparticles are provided to the washcoat slurry separately from the metal oxide particles and a portion of the composite nanoparticles are attached to the metal oxide particles (such that the washcoat slurry comprises metal oxide particles, composite nanoparticles, and nano-on-nano-on-micro particles). In some embodiments, the composite nanoparticles are embedded in porous metal oxide carrier material (e.g., “nano-on-nano-in-micro” or “NNiM” particles).

The composite nanoparticles comprise a catalytic nanoparticle bonded to a support nanoparticle. In the second washcoat layer, the catalytic nanoparticle comprises rhodium. In some embodiments, the support nanoparticle comprises a metal oxide. The rhodium-metal oxide composite nanoparticles comprise about 5% to about 20% by weight of rhodium and about 80% to about 95% by weight of metal oxide. For example, in some embodiments, the composite nanoparticles comprise about 5% to about 15% by weight rhodium and about 85% to about 95% by weight metal oxide. In one embodiment, the rhodium-metal oxide composite nanoparticles comprise about 10% by weight of rhodium and about 90% by weight of metal oxide. In one embodiment, the rhodium-metal oxide composite nanoparticles comprise about 15% by weight of rhodium and about 85% by weight of metal oxide. The support nanoparticle can comprise cerium oxide or a composite oxide of cerium and one or more oxides of zirconium, lanthanum, neodymium, and/or yttrium. The composite oxides can comprise cerium-zirconium oxide, cerium-lanthanum oxide, cerium-yttrium oxide, cerium-neodymium oxide, cerium-zirconium-lanthanum oxide, cerium-zirconium-yttrium oxide, cerium-zirconium-neodymium oxide, cerium-lanthanum-yttrium oxide, cerium-lanthanum-neodymium oxide, cerium-yttrium-neodymium oxide, cerium-zirconium-lanthanum-yttrium oxide, cerium-zirconium-lanthanum-neodymium oxide, cerium-zirconium-yttrium-neodymium oxide, cerium-lanthanum-yttrium-neodymium oxide, or cerium-zirconium-lanthanum-yttrium-neodymium oxide. The support nanoparticle can comprise zirconium oxide or a composite oxide of zirconium and one or more oxides of cerium, lanthanum, neodymium, and/or yttrium. In some embodiments, the support nanoparticle comprises zirconium oxide. In some embodiments, the support nanoparticle comprises cerium oxide. In some embodiments, the support nanoparticle comprises lanthanum oxide. In some embodiments, the support nanoparticle comprises yttrium oxide. In some embodiments, the support nanoparticle comprises neodymium oxide. In some embodiments, the support nanoparticle comprises zirconium-cerium oxide. In some embodiments, the support nanoparticle comprises zirconium-lanthanum oxide. In some embodiments, the support nanoparticle comprises zirconium-yttrium oxide. In some embodiments, the support nanoparticle comprises zirconium-neodymium oxide. In some embodiments, the support nanoparticle comprises zirconium-lanthanum-yttrium oxide. In some embodiments, the support nanoparticle comprises zirconium-lanthanum-neodymium oxide. In some embodiments, the support nanoparticle comprises zirconium-yttrium-neodymium oxide. In some embodiments, the support nanoparticle comprises zirconium-lanthanum-yttrium-neodymium oxide. In some embodiment, the support nanoparticle comprises zirconium-cerium-lanthanum oxide. In some embodiment, the support nanoparticle comprises zirconium-cerium-yttrium oxide. In some embodiments, the support nanoparticle comprises zirconium-cerium-neodymium oxide. In some embodiments, the support nanoparticle comprises zirconium-cerium-lanthanum-neodymium oxide. In some embodiments, the support nanoparticle comprises zirconium-cerium-lanthanum-yttrium oxide. In some embodiments, the support nanoparticle comprises zirconium-cerium-lanthanum-neodymium-yttrium oxide. In some embodiments, the support nanoparticle comprises zirconium-cerium-neodymium-yttrium oxide. In some embodiments, the support nanoparticle comprises about 50% to about 100% by weight zirconium oxide. In some embodiments, the support nanoparticle comprises about 0% to about 50% by weight cerium oxide. In some embodiments, the support nanoparticle comprises about 0% to about 5% by weight yttrium oxide. In some embodiments, the support nanoparticle comprises about 0% to about 5% by weight lanthanum oxide. In some embodiments, the support nanoparticle comprises about 0% to about 15% by weight neodymium oxide. In some embodiments, the support nanoparticle comprises about 10% to about 40% by weight cerium oxide and about 60% to about 90% by weight zirconium oxide. In some embodiments, the support nanoparticle comprises about 10% to about 40% by weight cerium oxide, about 60% to about 90% by weight zirconium oxide and about 1% to about 5% by weight lanthanum oxide. In some embodiments, the support nanoparticle comprises about 10% to about 40% by weight cerium oxide, about 60% to about 90% by weight zirconium oxide and about 1% to about 15% by weight neodymium oxide. In some embodiments, the support nanoparticle comprises about 10% to about 40% by weight cerium oxide, about 60% to about 90% by weight zirconium oxide and about 1% to about 5% by weight yttrium oxide. In some embodiments, the support nanoparticle comprises about 10% to about 40% by weight cerium oxide, about 60% to about 90% by weight zirconium oxide, about 1% to about 5% by weight lanthanum oxide, and about 1% to about 15% by weight neodymium oxide. In some embodiments, the support nanoparticle comprises about 21% cerium oxide, about 72% zirconium oxide, about 2% lanthanum oxide, and about 5% neodymium oxide. In some embodiments the composite nanoparticles are attached to the metal oxide particles (e.g., “nano-on-nano-on-micro” or “NNm” particles), for example by incipient wetness impregnation followed by drying and calcination. In some embodiments, the composite nanoparticles are provided to the washcoat slurry used to for the second zone of the first washcoat layer separately from the metal oxide particles (i.e., a “loose configuration”). In some embodiments, a portion of the composite nanoparticles are provided to the washcoat slurry separately from the metal oxide particles and a portion of the composite nanoparticles are attached to the metal oxide particles (such that the washcoat slurry comprises metal oxide particles, composite nanoparticles, and nano-on-nano-on-micro particles). In some embodiments, the composite nanoparticles are embedded in porous metal oxide carrier material (e.g., “nano-on-nano-in-micro” or “NNiM” particles).

Metal oxide particles which can be used in the second washcoat layer can comprise cerium oxide or a composite oxide of cerium and one or more oxides of zirconium, lanthanum, neodymium, and/or yttrium. The composite cerium oxides can comprise cerium-zirconium oxide, cerium-lanthanum oxide, cerium-yttrium oxide, cerium-neodymium oxide, cerium-zirconium-lanthanum oxide, cerium-zirconium-yttrium oxide, cerium-zirconium-neodymium oxide, cerium-lanthanum-yttrium oxide, cerium-lanthanum-neodymium oxide, cerium-yttrium-neodymium oxide, cerium-zirconium-lanthanum-yttrium oxide, cerium-zirconium-lanthanum-neodymium oxide, cerium-zirconium-yttrium-neodymium oxide, cerium-lanthanum-yttrium-neodymium oxide, or cerium-zirconium-lanthanum-yttrium-neodymium oxide. The metal oxide particles can also comprise aluminum oxide. The metal oxide particles can also comprise a mixture of aluminum oxide and cerium oxide, or a mixture of aluminum oxide and one or more composite cerium oxide. Metal oxide particles which can be used in the second washcoat layer can comprise zirconium-containing metal oxides, including zirconium oxide and composite oxides of zirconium with one or more oxides of cerium, lanthanum, neodymium, and/or yttrium. In some embodiments, the metal oxide particles comprise zirconium oxide. In some embodiments, the metal oxide particles comprise cerium oxide. In some embodiments, the metal oxide particles comprise lanthanum oxide. In some embodiments, the metal oxide particles comprise yttrium oxide. In some embodiments, the metal oxide particles comprise neodymium oxide. In some embodiments, the metal oxide particles comprise zirconium-cerium oxide. In some embodiments, the metal oxide particles comprise zirconium-lanthanum oxide. In some embodiments, the metal oxide particles comprise zirconium-yttrium oxide. In some embodiments, the metal oxide particles comprise zirconium-neodymium oxide. In some embodiments, the metal oxide particles comprise zirconium-lanthanum-yttrium oxide. In some embodiments, the metal oxide particles comprise zirconium-lanthanum-neodymium oxide. In some embodiments, the metal oxide particles comprise zirconium-yttrium-neodymium oxide. In some embodiments, the metal oxide particles comprise zirconium-lanthanum-yttrium-neodymium oxide. In some embodiment, the metal oxide particles comprise zirconium-cerium-lanthanum oxide. In some embodiment, the metal oxide particles comprise zirconium-cerium-yttrium oxide. In some embodiments, the metal oxide particles comprise zirconium-cerium-neodymium oxide. In some embodiments, the metal oxide particles comprise zirconium-cerium-lanthanum-neodymium oxide. In some embodiments, the metal oxide particles comprise zirconium-cerium-lanthanum-yttrium oxide. In some embodiments, the metal oxide particles comprise zirconium-cerium-lanthanum-neodymium-yttrium oxide. In some embodiments, the metal oxide particles comprise zirconium-cerium-neodymium-yttrium oxide. In some embodiments, the metal oxide particles comprise about 50% to about 100% by weight zirconium oxide. In some embodiments, the metal oxide particles comprise about 0% to about 50% by weight cerium oxide. In some embodiments, the metal oxide particles comprise about 0% to about 5% by weight yttrium oxide. In some embodiments, the metal oxide particles comprise about 0% to about 5% by weight lanthanum oxide. In some embodiments, the metal oxide particles comprise about 0% to about 15% by weight neodymium oxide. In some embodiments, the metal oxide particles comprise about 10% to about 40% by weight cerium oxide and about 60% to about 90% by weight zirconium oxide. In some embodiments, the metal oxide particles comprise about 10% to about 40% by weight cerium oxide, about 60% to about 90% by weight zirconium oxide and about 1% to about 5% by weight lanthanum oxide. In some embodiments, the metal oxide particles comprise about 10% to about 40% by weight cerium oxide, about 60% to about 90% by weight zirconium oxide and about 1% to about 15% by weight neodymium oxide. In some embodiments, the metal oxide particles comprise about 10% to about 40% by weight cerium oxide, about 60% to about 90% by weight zirconium oxide and about 1% to about 5% by weight yttrium oxide. In some embodiments, the metal oxide particles comprise about 10% to about 40% by weight cerium oxide, about 60% to about 90% by weight zirconium oxide, about 1% to about 5% by weight lanthanum oxide, and about 1% to about 15% by weight neodymium oxide. In some embodiments, the metal oxide particles comprise about 21% cerium oxide, about 72% zirconium oxide, about 2% lanthanum oxide, and about 5% neodymium oxide. In some embodiments, the metal oxide particles are porous. In some embodiments, the metal oxide particles are micron-sized particles. In some embodiments, the metal oxide particles have a diameter between about 500 nm and about 50 microns, between about 500 nm and about 10 microns, between about 500 nm and about 5 microns, between about 1 micron and about 10 microns, between about 1 micron and about 5 microns, or between about 2 microns and about 8 microns.

In some embodiments, the second washcoat layer comprises aluminum oxide, a portion of which may be, for example, derived from boehmite. Boehmite provided in the washcoat slurry is converted into aluminum oxide after the washcoat slurry is coated onto the substrate and the coated substrate is calcined. The aluminum oxide derived from boehmite increases adhesion of the second washcoat layer.

In some embodiments, the second washcoat layer comprises filler particles. In some embodiments, the filler particles are metal oxide particles. In some embodiments, the filler particles are porous. In some embodiments, the filler particles are aluminum oxide particles. In some embodiments, the filler particles are lanthanum-stabilized aluminum oxide particles. Exemplary lanthanum-stabilized aluminum oxide particles are MI-386 particles, commercially available from Rhodia. In some embodiments, the filler particles are micron-sized particles. In some embodiments, the filler particles have a diameter between about 500 nm and about 50 microns, between about 500 nm and about 10 microns, between about 500 nm and about 5 microns, between about 1 micron and about 10 microns, between about 1 micron and about 5 microns, or between about 2 microns and about 8 microns.

In some embodiments, the second washcoat layer comprises about 1.5% to about 5% by weight composite nanoparticles (such as about 1.5% to about 2.5% by weight composite nanoparticles, about 2% to about 3% by weight composite nanoparticles, about 2.5% to about 3.5% by weight composite nanoparticles, about 3% to about 4% by weight composite nanoparticles, about 3.5% to about 4.5% by weight composite nanoparticles, or about 4% to about 5% by weight composite nanoparticles). In some embodiments, the second washcoat layer comprises about 45% to about 95% by weight metal oxide particles (such as about 50% to about 90% by weight metal oxide particles, about 60% to about 80% metal oxide particles, or about 70% to about 80% by weight metal oxide particles). In some embodiments, the second washcoat layer comprises about 3% to about 8% by weight aluminum oxide derived from boehmite (such as about 3% to about 7% by weight aluminum oxide derived from boehmite, about 4% to about 6% by weight aluminum oxide derived from boehmite, or about 5% by weight aluminum oxide derived from boehmite). Optionally, the second washcoat layer comprises up to about 70% by weight filler particles (such as up to about 40% by weight filler particles, for example, about 5% to about 40% by weight filler particles, about 10% to about 30% by weight filler particles, or about 15% to about 25% by weight filler particles). The second washcoat layer is coated onto the substrate the substrate at about 50 g/L to about 120 g/L (such as about 60 g/L to about 120 g/L, about 70 g/L to about 115 g/L, about 80 g/L to about 115 g/L, about 90 g/L to about 110 g/L, or about 100 g/L to about 110 g/L). This results in a rhodium loading of about 0.1 g/L to about 0.6 g/L (such as about 0.1 g/L to about 0.3 g/L, about 0.2 g/L to about 0.4 g/L, about 0.3 g/L to about 0.5 g/L, or about 0.4 g/L to about 0.6 g/L).

In some embodiments, the second washcoat layer comprises composite nanoparticles, the composite nanoparticles comprising a catalytic nanoparticle comprising rhodium bonded to a support nanoparticle comprising zirconium oxide; and porous, micron-sized metal oxide particles comprising zirconium oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising zirconium oxide; and porous, micron-sized metal oxide particles comprising zirconium oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum-lanthanum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising cerium-zirconium oxide; and porous, micron-sized metal oxide particles comprising zirconium oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising cerium-zirconium oxide; and porous, micron-sized metal oxide particles comprising zirconium oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum-lanthanum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising cerium-zirconium-lanthanum oxide; and porous, micron-sized particles comprising zirconium oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising cerium-zirconium-lanthanum oxide; and porous, micron-sized particles comprising zirconium oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum-lanthanum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising cerium-zirconium-neodymium oxide; and porous, micron-sized metal oxide particles comprising zirconium oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising cerium-zirconium-neodymium oxide; and porous, micron-sized metal oxide particles comprising zirconium oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum-lanthanum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising cerium-zirconium-lanthanum-neodymium oxide; and porous, micron-sized metal oxide particles comprising zirconium oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising cerium-zirconium-lanthanum-neodymium oxide; and porous, micron-sized metal oxide particles comprising zirconium oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum-lanthanum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising zirconium oxide; and porous, micron-sized metal oxide particles comprising cerium-zirconium oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising zirconium oxide; and porous, micron-sized metal oxide particles comprising cerium-zirconium oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum-lanthanum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising cerium-zirconium oxide; and porous, micron-sized metal oxide particles comprising cerium-zirconium oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising cerium-zirconium oxide; and porous, micron-sized metal oxide particles comprising cerium-zirconium oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum-lanthanum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising cerium-zirconium-lanthanum oxide; and porous, micron-sized metal oxide particles comprising cerium-zirconium oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising cerium-zirconium-lanthanum oxide; and porous, micron-sized metal oxide particles comprising cerium-zirconium oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum-lanthanum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising cerium-zirconium-neodymium oxide; and porous, micron-sized metal oxide particles comprising cerium-zirconium oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising cerium-zirconium-neodymium oxide; and porous, micron-sized metal oxide particles comprising cerium-zirconium oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum-lanthanum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising cerium-zirconium-lanthanum-neodymium oxide; and porous, micron-sized metal oxide particles comprising cerium-zirconium oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising cerium-zirconium-lanthanum-neodymium oxide; and porous, micron-sized metal oxide particles comprising cerium-zirconium oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum-lanthanum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising zirconium oxide; and porous, micron-sized metal oxide particles comprising cerium-zirconium-lanthanum oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising zirconium oxide; and porous, micron-sized metal oxide particles comprising cerium-zirconium-lanthanum oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum-lanthanum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising cerium-zirconium oxide; and porous, micron-sized metal oxide particles comprising cerium-zirconium-lanthanum oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising cerium-zirconium oxide; and porous, micron-sized metal oxide particles comprising cerium-zirconium-lanthanum oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum-lanthanum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising cerium-zirconium-lanthanum oxide; and porous, micron-sized metal oxide particles comprising cerium-zirconium-lanthanum oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising cerium-zirconium-lanthanum oxide; and porous, micron-sized metal oxide particles comprising cerium-zirconium-lanthanum oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum-lanthanum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising cerium-zirconium-neodymium oxide; and porous, micron-sized metal oxide particles comprising cerium-zirconium-lanthanum oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising cerium-zirconium-neodymium oxide; and porous, micron-sized metal oxide particles comprising cerium-zirconium-lanthanum oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum-lanthanum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising cerium-zirconium-lanthanum-neodymium oxide; and porous, micron-sized metal oxide particles comprising cerium-zirconium-lanthanum oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising cerium-zirconium-lanthanum-neodymium oxide; and porous, micron-sized metal oxide particles comprising cerium-zirconium-lanthanum oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum-lanthanum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising zirconium oxide; and porous, micron-sized metal oxide particles comprising cerium-zirconium-neodymium oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising zirconium oxide; and porous, micron-sized metal oxide particles comprising cerium-zirconium-neodymium oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum-lanthanum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising cerium oxide and zirconium oxide; and porous, micron-sized metal oxide particles comprising cerium-zirconium-neodymium oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising cerium oxide and zirconium oxide; and porous, micron-sized metal oxide particles comprising cerium-zirconium-neodymium oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum-lanthanum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising cerium-zirconium-lanthanum oxide; and porous, micron-sized metal oxide particles comprising cerium-zirconium-neodymium oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising cerium-zirconium-lanthanum oxide; and porous, micron-sized metal oxide particles comprising cerium-zirconium-neodymium oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum-lanthanum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising cerium-zirconium-neodymium oxide; and porous, micron-sized metal oxide particles comprising cerium-zirconium-neodymium oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising cerium-zirconium-neodymium oxide; and porous, micron-sized metal oxide particles comprising cerium-zirconium-neodymium oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum-lanthanum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising cerium-zirconium-lanthanum-neodymium oxide; and porous, micron-sized metal oxide particles comprising cerium-zirconium-neodymium oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising cerium-zirconium-lanthanum-neodymium oxide; and porous, micron-sized metal oxide particles comprising cerium-zirconium-neodymium oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum-lanthanum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising zirconium oxide; and porous, micron-sized metal oxide particles comprising cerium-zirconium-lanthanum-neodymium oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising zirconium oxide; and porous, micron-sized metal oxide particles comprising cerium-zirconium-lanthanum-neodymium oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum-lanthanum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising cerium-zirconium oxide; and porous, micron-sized metal oxide particles comprising cerium-zirconium-lanthanum-neodymium oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising cerium-zirconium oxide; and porous, micron-sized metal oxide particles comprising cerium-zirconium-lanthanum-neodymium oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum-lanthanum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising cerium-zirconium-lanthanum oxide; and porous, micron-sized metal oxide particles comprising cerium-zirconium-lanthanum-neodymium oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising cerium-zirconium-lanthanum oxide; and porous, micron-sized metal oxide particles comprising cerium-zirconium-lanthanum-neodymium oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum-lanthanum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising cerium-zirconium-neodymium oxide; and porous, micron-sized metal oxide particles comprising cerium-zirconium-lanthanum-neodymium oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising cerium-zirconium-neodymium oxide; and porous, micron-sized metal oxide particles comprising cerium-zirconium-lanthanum-neodymium oxide, wherein the composite nanoparticles are attached to the metal oxide particles. In some embodiments, the second washcoat layer comprises aluminum-lanthanum oxide derived from boehmite. Optionally, the second washcoat layer further comprises filler particles comprising aluminum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising cerium-zirconium-lanthanum-neodymium oxide; and porous, micron-sized metal oxide particles comprising cerium-zirconium-lanthanum-neodymium oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising cerium-zirconium-lanthanum-neodymium oxide; and porous, micron-sized metal oxide particles comprising cerium-zirconium-lanthanum-neodymium oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum-lanthanum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle comprising cerium-zirconium-lanthanum-yttirum oxide; and porous, micron-sized metal oxide particles comprising cerium oxide, cerium-zirconium oxide, cerium-zirconium-lanthanum oxide, cerium-zirconium-lanthanum-yttrium oxide, or cerium-zirconium-lanthanum-neodymium oxide, wherein the composite nanoparticles are attached to the metal oxide particles. In some embodiments, the second washcoat layer comprises aluminum oxide derived from boehmite. Optionally, the second washcoat layer further comprises filler particles comprising aluminum-lanthanum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle, where the support nanoparticle comprises cerium oxide or a metal oxide comprising one or more of cerium oxide, zirconium oxide, lanthanum oxide, yttrium oxide, and neodymium oxide; where the composite nanoparticles are embedded in particles comprising a porous carrier. The porous carrier can comprise cerium oxide or a metal oxide comprising one or more of cerium oxide, zirconium oxide, lanthanum oxide, yttrium oxide, or neodymium oxide. In some embodiments, the porous carriers with embedded composite nanoparticles are micron-sized. In some embodiments, the second washcoat layer comprises aluminum oxide derived from boehmite. Optionally, the second washcoat layer further comprises filler particles comprising aluminum-lanthanum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In some embodiments, the second washcoat layer comprises composite nanoparticles, the composite nanoparticles comprising a catalytic nanoparticle comprising rhodium bonded to a support nanoparticle, where the support nanoparticle comprises cerium oxide or a metal oxide comprising one or more of cerium oxide, zirconium oxide, lanthanum oxide, yttrium oxide, or neodymium oxide, or a metal oxide comprising cerium-zirconium oxide, cerium-lanthanum oxide, cerium-yttrium oxide, cerium-neodymium oxide, cerium-zirconium-lanthanum oxide, cerium-zirconium-yttrium oxide, cerium-zirconium-neodymium oxide, cerium-lanthanum-yttrium oxide, cerium-lanthanum-neodymium oxide, cerium-yttrium-neodymium oxide, cerium-zirconium-lanthanum-yttrium oxide, cerium-zirconium-lanthanum-neodymium oxide, cerium-zirconium-yttrium-neodymium oxide, cerium-lanthanum-yttrium-neodymium oxide, or cerium-zirconium-lanthanum-yttrium-neodymium oxide; where the composite nanoparticles are embedded in particles comprising a porous carrier. The porous carrier can comprise cerium oxide or a metal oxide comprising one or more of cerium oxide, zirconium oxide, lanthanum oxide, yttrium oxide, or neodymium oxide, or a metal oxide comprising cerium-zirconium oxide, cerium-lanthanum oxide, cerium-yttrium oxide, cerium-neodymium oxide, cerium-zirconium-lanthanum oxide, cerium-zirconium-yttrium oxide, cerium-zirconium-neodymium oxide, cerium-lanthanum-yttrium oxide, cerium-lanthanum-neodymium oxide, cerium-yttrium-neodymium oxide, cerium-zirconium-lanthanum-yttrium oxide, cerium-zirconium-lanthanum-neodymium oxide, cerium-zirconium-yttrium-neodymium oxide, cerium-lanthanum-yttrium-neodymium oxide, or cerium-zirconium-lanthanum-yttrium-neodymium oxide. In some embodiments, the porous carriers with embedded composite nanoparticles are micron-sized. In some embodiments, the second washcoat layer comprises aluminum oxide derived from boehmite. Optionally, the second washcoat layer further comprises filler particles comprising aluminum-lanthanum oxide. In some embodiments, the second washcoat layer has a rhodium loading of about 0.05 g/L to about 3 g/L, about 0.05 g/L to about 2 g/L, or about 0.05 g/L to about 1 g/L. In some embodiments, the second washcoat layer has a rhodium loading of about 0.1 g/L to about 0.6 g/L.

In a further embodiment of the second washcoat layer, termed embodiment (I), the second washcoat layer can comprise the following components:

Component A: composite nanoparticles (nano-on-nano particles or NN particles) comprising a catalytic particle comprising rhodium, bonded to a metal oxide support nanoparticle comprising cerium oxide or a composite oxide of cerium and one or more oxides of zirconium, lanthanum, neodymium, and/or yttrium. The ratio by weight of rhodium to metal oxide in the composite nanoparticle can range from about 1% rhodium:99% metal oxide, to about 40% rhodium:60% metal oxide. The composite nanoparticles are typically handled in a liquid dispersion;

Component B: porous micron-sized particles comprising cerium oxide or a composite oxide of cerium and one or more oxides of zirconium, lanthanum, neodymium, and/or yttrium;

Component C: boehmite (as added to the washcoat formulation prior to applying to the substrate), which becomes aluminum oxide derived from boehmite after the washcoat formulation is applied to the substrate, dried, and calcined; and

Optional Component D: aluminum oxide particles, preferably micron-sized aluminum oxide stabilized with lanthanum (such as MI-386 particles).

Prior to addition of component A, the ranges of components B, C, and D can range from about 98% B, 2% C, 0% D to about 0% B, 10% C, 90% D. A sufficient amount of component A is then added to the mixture of components B, C, and D to provide the desired loading of rhodium in the washcoat layer, to result in embodiment (I) of the second washcoat layer. For example, if composite nanoparticles are used with a ratio of 15% rhodium:85% metal oxide, and the desired rhodium loading is 0.3 g/L, then 2 g/L of composite nanoparticles should be added.

It should be noted that, after the washcoat composition is applied to a substrate, dried, and calcined, the boehmite converts to aluminum oxide, and thus component C, when on the dried and calcined substrate, becomes aluminum oxide derived from boehmite.

In another embodiment of the second washcoat layer, termed embodiment (II), the second washcoat layer can comprise the following components:

Component E: nano-on-nano-on-micro particles (NNm particles) comprising composite nanoparticles, where the composite nanoparticles comprise a catalytic particle comprising rhodium, bonded to a metal oxide support nanoparticle comprising cerium oxide or a composite oxide of cerium and one or more oxides of zirconium, lanthanum, neodymium, and/or yttrium; and where the composite nanoparticles are attached to porous micron-sized metal oxide particles comprising cerium oxide or a composite oxide of cerium and one or more oxides of zirconium, lanthanum, neodymium, and/or yttrium. The composite nanoparticles can be attached to the porous micron-sized metal oxide particles by incipient wetness impregnation followed by drying and calcination The ratio by weight of rhodium to metal oxide in the composite nanoparticle can range from about 1% rhodium:99% metal oxide, to about 40% rhodium:60% metal oxide. The ratio by weight of rhodium to total metal oxide in the nano-on-nano-on-micro particles can range from about 0.01% rhodium:99.99% metal oxide to 1% rhodium:99% metal oxide;

Component C: boehmite (as added to the washcoat formulation prior to applying to the substrate), which becomes aluminum oxide derived from boehmite after the washcoat formulation is applied to the substrate, dried, and calcined; and

Optional Component D: optionally, aluminum oxide particles, preferably micron-sized aluminum oxide stabilized with lanthanum (such as MI-386 particles).

The ranges of components in embodiment (II) can vary from about 98% E, 2% C to about 90% E, 10% C when component D is not present. When component D is present, prior to addition of component E, the ranges of components C and D can vary from about 2% C, 98% D to about 10% C, 90% D; a sufficient amount of component E is then added to the mixture of components C and D to provide the desired loading of rhodium in the washcoat layer, to result in embodiment (II) of the second washcoat layer.

It should be noted that, after the washcoat composition is applied to a substrate, dried, and calcined, the boehmite converts to aluminum oxide, and thus component C, when on the dried and calcined substrate, becomes aluminum oxide derived from boehmite.

In another embodiment of the second washcoat layer, termed embodiment (III), the second washcoat layer can comprise the following components:

Component F: composite nanoparticles embedded in porous metal oxide carrier material (nano-on-nano-in-micron particles, or NNiM particles). The composite nanoparticles comprise a catalytic particle comprising rhodium, bonded to a metal oxide support nanoparticle comprising cerium oxide or a composite oxide of cerium and one or more oxides of zirconium, lanthanum, neodymium, and/or yttrium. The composite nanoparticles are embedded in particles comprising a porous carrier comprised of cerium oxide or a composite oxide of cerium and one or more oxides of zirconium, lanthanum, neodymium, and/or yttrium;

Component C: boehmite (as added to the washcoat formulation prior to applying to the substrate), which becomes aluminum oxide derived from boehmite after the washcoat formulation is applied to the substrate, dried, and calcined; and

Optional Component D: aluminum oxide particles, preferably micron-sized aluminum oxide stabilized with lanthanum (such as MI-386 particles).

The ranges of components in embodiment (III) can vary from about 98% F, 2% C to about 90% F, 10% C when component D is not present. When component D is present, prior to addition of component F, the ranges of components C and D can vary from about 2% C, 98% D to about 10% C, 90% D; a sufficient amount of component F is then added to the mixture of components C and D to provide the desired loading of rhodium in the washcoat layer, to result in embodiment (III) of the second washcoat layer.

It should be noted that, after the washcoat composition is applied to a substrate, dried, and calcined, the boehmite converts to aluminum oxide, and thus component C, when on the dried and calcined substrate, becomes aluminum oxide derived from boehmite.

The metal oxide particles, including both metal oxide support nanoparticles and porous micron-sized metal oxide particles, which can be used in embodiment (I), embodiment (II), or embodiment (III) of the second washcoat layer can comprise cerium oxide, or can comprise a composite oxide of cerium and one or more oxides of zirconium, lanthanum, neodymium, and/or yttrium. The composite cerium oxides can comprise cerium-zirconium oxide, cerium-lanthanum oxide, cerium-yttrium oxide, cerium-neodymium oxide, cerium-zirconium-lanthanum oxide, cerium-zirconium-yttrium oxide, cerium-zirconium-neodymium oxide, cerium-lanthanum-yttrium oxide, cerium-lanthanum-neodymium oxide, cerium-yttrium-neodymium oxide, cerium-zirconium-lanthanum-yttrium oxide, cerium-zirconium-lanthanum-neodymium oxide, cerium-zirconium-yttrium-neodymium oxide, cerium-lanthanum-yttrium-neodymium oxide, or cerium-zirconium-lanthanum-yttrium-neodymium oxide. The metal oxide particles can also comprise aluminum oxide, a mixture of aluminum oxide and cerium oxide, or a mixture of aluminum oxide and one or more composite cerium oxides as listed above.

In any of the embodiments I, II, or III above for the second washcoat layer, the final platinum group metal loading in the second washcoat layer can range from about 0.05 g/L rhodium to about 3 g/L rhodium, about 0.05 g/L to about 2 g/L rhodium, or about 0.05 g/L to about 1 g/L rhodium. In any of the embodiments I, II, or III above for the second washcoat layer, the final platinum group metal loading in the second washcoat layer can range from about 0.1 g/L rhodium to about 0.6 g/L rhodium.

Any of the embodiments I, II, or III above for the second washcoat layer can be combined with any of the embodiments disclosed herein for the first washcoat layer, whether the first washcoat layer comprises a single zone or comprises a first zone and a second zone.

### Washcoat Slurry Useful for Forming Second Washcoat Layer

In some embodiments, the second washcoat layer is formed by coating a substrate with a washcoat slurry comprising composite nanoparticles, the composite nanoparticles comprising a catalytic nanoparticle comprising rhodium bonded to a support nanoparticle, metal oxide particles, and boehmite. In some embodiments, the washcoat slurry further comprises filler particles. In some embodiments, the composite nanoparticles are provided separately from the metal oxide particles (i.e., a “loose configuration”). In some embodiments, the composite nanoparticles are attached to the metal oxide particles (e.g., “NNm” particles), for example by incipient wetness impregnation followed by drying and calcination. In some embodiments, a portion of the composite nanoparticles are provided to the washcoat slurry separately from the metal oxide particles and a portion of the composite nanoparticles are attached to the metal oxide particles (such that the washcoat slurry comprises metal oxide particles, composite nanoparticles, and nano-on-nano-on-micro particles). In some embodiments, the composite nanoparticles are embedded in porous metal oxide carrier material (e.g., “nano-on-nano-in-micro” or “NNiM” particles). The materials for the washcoat slurry are combined in an aqueous liquid to form a dispersion. In some embodiments, a surfactant is included in the washcoat slurry.

The composite nanoparticles in the washcoat slurry comprise a catalytic nanoparticle bonded to a support nanoparticle. In the second washcoat layer, the catalytic nanoparticle comprises rhodium. In some embodiments, the support nanoparticle comprises a metal oxide. The rhodium-metal oxide composite nanoparticles comprise about 5% to about 20% by weight of rhodium and about 80% to about 95% by weight of metal oxide. For example, in some embodiments, the composite nanoparticles comprise about 5% to about 15% by weight rhodium and about 85% to about 95% by weight metal oxide. In one embodiment, the rhodium-metal oxide composite nanoparticles comprise about 10% by weight of rhodium and about 90% by weight of metal oxide. Typically, the support nanoparticle comprises zirconium oxide or a composite oxide of zirconium and one or more oxides of cerium, lanthanum, neodymium, and/or yttrium. In some embodiments, the support nanoparticle comprises zirconium oxide. In some embodiments, the support nanoparticle comprises cerium oxide. In some embodiments, the support nanoparticle comprises lanthanum oxide. In some embodiments, the support nanoparticle comprises yttrium oxide. In some embodiments, the support nanoparticle comprises neodymium oxide. In some embodiments, the support nanoparticle comprises zirconium-cerium oxide. In some embodiments, the support nanoparticle comprises zirconium-lanthanum oxide. In some embodiments, the support nanoparticle comprises zirconium-yttrium oxide. In some embodiments, the support nanoparticle comprises zirconium-neodymium oxide. In some embodiments, the support nanoparticle comprises zirconium-cerium oxide. In some embodiments, the support nanoparticle comprises zirconium-lanthanum oxide. In some embodiments, the support nanoparticle comprises zirconium-yttrium oxide. In some embodiments, the support nanoparticle comprises zirconium-neodymium oxide. In some embodiments, the support nanoparticle comprises zirconium-lanthanum-yttrium oxide. In some embodiments, the support nanoparticle comprises zirconium-lanthanum-neodymium oxide. In some embodiments, the support nanoparticle comprises zirconium-yttrium-neodymium oxide. In some embodiments, the support nanoparticle comprises zirconium-lanthanum-yttrium-neodymium oxide. In some embodiment, the support nanoparticle comprises zirconium-cerium-lanthanum oxide. In some embodiment, the support nanoparticle comprises zirconium-cerium-yttrium oxide. In some embodiments, the support nanoparticle comprises zirconium-cerium-neodymium oxide. In some embodiments, the support nanoparticle comprises zirconium-cerium-lanthanum-neodymium oxide. In some embodiments, the support nanoparticle comprises zirconium-cerium-lanthanum-yttrium oxide. In some embodiments, the support nanoparticle comprises zirconium-cerium-lanthanum-neodymium-yttrium oxide. In some embodiments, the support nanoparticle comprises zirconium-cerium-neodymium-yttrium oxide. In some embodiments, the support nanoparticle comprises about 50% to about 100% by weight zirconium oxide. In some embodiments, the support nanoparticle comprises about 0% to about 50% by weight cerium oxide. In some embodiments, the support nanoparticle comprises about 0% to about 5% by weight yttrium oxide. In some embodiments, the support nanoparticle comprises about 0% to about 5% by weight lanthanum oxide. In some embodiments, the support nanoparticle comprises about 0% to about 15% by weight neodymium oxide. In some embodiments, the support nanoparticle comprises about 10% to about 40% by weight cerium oxide and about 60% to about 90% by weight zirconium oxide. In some embodiments, the support nanoparticle comprises about 10% to about 40% by weight cerium oxide, about 60% to about 90% by weight zirconium oxide and about 1% to about 5% by weight lanthanum oxide. In some embodiments, the support nanoparticle comprises about 10% to about 40% by weight cerium oxide, about 60% to about 90% by weight zirconium oxide and about 1% to about 15% by weight neodymium oxide. In some embodiments, the support nanoparticle comprises about 10% to about 40% by weight cerium oxide, about 60% to about 90% by weight zirconium oxide and about 1% to about 5% by weight yttrium oxide. In some embodiments, the support nanoparticle comprises about 10% to about 40% by weight cerium oxide, about 60% to about 90% by weight zirconium oxide, about 1% to about 5% by weight lanthanum oxide, and about 1% to about 15% by weight neodymium oxide. In some embodiments, the support nanoparticle comprises about 21% cerium oxide, about 72% zirconium oxide, about 2% lanthanum oxide, and about 5% neodymium oxide. In some embodiments the composite nanoparticles are attached to the metal oxide particles (e.g., “nano-on-nano-on-micro” or “NNm” particles), for example by incipient wetness impregnation followed by drying and calcination. In some embodiments, the composite nanoparticles are provided to the washcoat slurry used to for the second zone of the first washcoat layer separately from the metal oxide particles (i.e., a “loose configuration”). In some embodiments, the composite nanoparticles are embedded in porous metal oxide carrier material (e.g., “nano-on-nano-in-micro” or “NNiM” particles).

Metal oxide particles which can be used in the second washcoat layer are typically zirconium-containing metal oxides, including zirconium oxide and composite oxides of zirconium with one or more oxides of cerium, lanthanum, neodymium, and/or yttrium. In some embodiments, the metal oxide particles comprise zirconium oxide. In some embodiments, the metal oxide particles comprise cerium oxide. In some embodiments, the metal oxide particles comprise lanthanum oxide. In some embodiments, the metal oxide particles comprise yttrium oxide. In some embodiments, the metal oxide particles comprise neodymium oxide. In some embodiments, the metal oxide particles comprise zirconium-cerium oxide. In some embodiments, the metal oxide particles comprise zirconium-lanthanum oxide. In some embodiments, the metal oxide particles comprise zirconium-yttrium oxide. In some embodiments, the metal oxide particles comprise zirconium-neodymium oxide. In some embodiments, the metal oxide particles comprise zirconium-cerium oxide. In some embodiments, the metal oxide particles comprise zirconium-lanthanum oxide. In some embodiments, the metal oxide particles comprise zirconium-yttrium oxide. In some embodiments, the metal oxide particles comprise zirconium-neodymium oxide. In some embodiments, the metal oxide particles comprise zirconium-lanthanum-yttrium oxide. In some embodiments, the metal oxide particles comprise zirconium-lanthanum-neodymium oxide. In some embodiments, the metal oxide particles comprise zirconium-yttrium-neodymium oxide. In some embodiments, the metal oxide particles comprise zirconium-lanthanum-yttrium-neodymium oxide. In some embodiment, the metal oxide particles comprise zirconium-cerium-lanthanum oxide. In some embodiment, the metal oxide particles comprise zirconium-cerium-yttrium oxide. In some embodiments, the metal oxide particles comprise zirconium-cerium-neodymium oxide. In some embodiments, the metal oxide particles comprise zirconium-cerium-lanthanum-neodymium oxide. In some embodiments, the metal oxide particles comprise zirconium-cerium-lanthanum-yttrium oxide. In some embodiments, the metal oxide particles comprise zirconium-cerium-lanthanum-neodymium-yttrium oxide. In some embodiments, the metal oxide particles comprise zirconium-cerium-neodymium-yttrium oxide. In some embodiments, the metal oxide particles comprise about 50% to about 100% by weight zirconium oxide. In some embodiments, the metal oxide particles comprise about 0% to about 50% by weight cerium oxide. In some embodiments, the metal oxide particles comprise about 0% to about 5% by weight yttrium oxide. In some embodiments, the metal oxide particles comprise about 0% to about 5% by weight lanthanum oxide. In some embodiments, the metal oxide particles comprise about 0% to about 15% by weight neodymium oxide. In some embodiments, the metal oxide particles comprise about 10% to about 40% by weight cerium oxide and about 60% to about 90% by weight zirconium oxide. In some embodiments, the metal oxide particles comprise about 10% to about 40% by weight cerium oxide, about 60% to about 90% by weight zirconium oxide and about 1% to about 5% by weight lanthanum oxide. In some embodiments, the metal oxide particles comprise about 10% to about 40% by weight cerium oxide, about 60% to about 90% by weight zirconium oxide and about 1% to about 15% by weight neodymium oxide. In some embodiments, the metal oxide particles comprise about 10% to about 40% by weight cerium oxide, about 60% to about 90% by weight zirconium oxide and about 1% to about 5% by weight yttrium oxide. In some embodiments, the metal oxide particles comprise about 21% cerium oxide, about 72% zirconium oxide, about 2% lanthanum oxide, and about 5% neodymium oxide. In some embodiments, the metal oxide particles comprise about 10% to about 40% by weight cerium oxide, about 60% to about 90% by weight zirconium oxide, about 1% to about 5% by weight lanthanum oxide, and about 1% to about 15% by weight neodymium oxide. In some embodiments, the metal oxide particles are porous. In some embodiments, the metal oxide particles are micron-sized particles. In some embodiments, the metal oxide particles have a diameter between about 500 nm and about 50 microns, between about 500 nm and about 10 microns, between about 500 nm and about 5 microns, between about 1 micron and about 10 microns, between about 1 micron and about 5 microns, or between about 2 microns and about 8 microns.

In some embodiments, the washcoat slurry useful for forming the second washcoat layer comprises boehmite. The washcoat slurry comprises an appropriate amount of boehmite to reach the target aluminum oxide derived from boehmite content in the second washcoat layer.

In some embodiments, the washcoat slurry for the second washcoat layer comprises filler particles. In some embodiments, the filler particles are metal oxide particles. In some embodiments, the filler particles are porous. In some embodiments, the filler particles are aluminum oxide particles. In some embodiments, the filler particles are lanthanum-stabilized aluminum oxide particles. Exemplary lanthanum-stabilized aluminum oxide particles are MI-386 particles, commercially available from Rhodia. In some embodiments, the filler particles are micron-sized particles. In some embodiments, the filler particles have a diameter between about 500 nm and about 50 microns, between about 500 nm and about 10 microns, between about 500 nm and about 5 microns, between about 1 micron and about 10 microns, between about 1 micron and about 5 microns, or between about 2 microns and about 8 microns.

In some embodiments, the washcoat slurry used to form the second washcoat layer comprises about 1.5% to about 5% by weight composite nanoparticles (such as about 1.5% to about 2.5% by weight composite nanoparticles, about 2% to about 3% by weight composite nanoparticles, about 2.5% to about 3.5% by weight composite nanoparticles, about 3% to about 4% by weight composite nanoparticles, about 3.5% to about 4.5% by weight composite nanoparticles, or about 4% to about 5% by weight composite nanoparticles). In some embodiments, the washcoat slurry used to form the second washcoat layer comprises about 45% to about 95% by weight metal oxide particles (such as about 50% to about 90% by weight metal oxide particles, about 60% to about 80% metal oxide particles, or about 70% to about 80% by weight metal oxide particles). In some embodiments, the washcoat slurry useful for forming the second washcoat layer comprises about 3% to about 8% by weight boehmite (such as about 3% to about 7% by weight boehmite, about 4% to about 6% by weight boehmite, or about 5% by weight boehmite). Optionally, the washcoat slurry useful for forming the second washcoat layer comprises up to about 70% by weight filler particles (such as up to about 45% by weight filler particles, for example, about 5% to about 35% by weight filler particles, about 10% to about 30% by weight filler particles, or about 15% to about 25% by weight filler particles).

In some embodiments, the washcoat slurry useful for forming the second washcoat layer comprises composite nanoparticles, the composite nanoparticles comprising a catalytic nanoparticle comprising rhodium bonded to a support nanoparticle comprising zirconium oxide; and porous, micron-sized metal oxide particles comprising zirconium oxide, wherein the composite nanoparticles are attached to the metal oxide particles. In some embodiments, the washcoat slurry comprises boehmite. Optionally, the washcoat slurry further comprises filler particles comprising aluminum oxide or aluminum-lanthanum oxide.

In some embodiments, the washcoat slurry useful for forming the second washcoat layer comprises composite nanoparticles, the composite nanoparticles comprising a catalytic nanoparticle comprising rhodium bonded to a support nanoparticle comprising cerium-zirconium oxide; and porous, micron-sized metal oxide particles comprising zirconium oxide, wherein the composite nanoparticles are attached to the metal oxide particles. In some embodiments, the washcoat slurry comprises boehmite. Optionally, the washcoat slurry further comprises filler particles comprising aluminum oxide or aluminum-lanthanum oxide.

In some embodiments, the washcoat slurry useful for forming the second washcoat layer comprises composite nanoparticles, the composite nanoparticles comprising a catalytic nanoparticle comprising rhodium bonded to a support nanoparticle comprising cerium-zirconium-lanthanum oxide; and porous, micron-sized metal oxide particles comprising zirconium oxide, wherein the composite nanoparticles are attached to the metal oxide particles. In some embodiments, the washcoat slurry comprises boehmite. Optionally, the washcoat slurry further comprises filler particles comprising aluminum oxide or aluminum-lanthanum oxide.

In some embodiments, the washcoat slurry useful for forming the second washcoat layer comprises composite nanoparticles, the composite nanoparticles comprising a catalytic nanoparticle comprising rhodium bonded to a support nanoparticle comprising cerium-zirconium-neodymium oxide; and porous, micron-sized metal oxide particles comprising zirconium oxide, wherein the composite nanoparticles are attached to the metal oxide particles. In some embodiments, the washcoat slurry comprises boehmite. Optionally, the washcoat slurry further comprises filler particles comprising aluminum oxide or aluminum-lanthanum oxide.

In some embodiments, the washcoat slurry useful for forming the second washcoat layer comprises composite nanoparticles, the composite nanoparticles comprising a catalytic nanoparticle comprising rhodium bonded to a support nanoparticle comprising cerium-zirconium-lanthanum-neodymium oxide; and porous, micron-sized metal oxide particles comprising zirconium oxide, wherein the composite nanoparticles are attached to the metal oxide particles. In some embodiments, the washcoat slurry comprises boehmite. Optionally, the washcoat slurry further comprises filler particles comprising aluminum oxide or aluminum-lanthanum oxide.

In some embodiments, the washcoat slurry useful for forming the second washcoat layer comprises composite nanoparticles, the composite nanoparticles comprising a catalytic nanoparticle comprising rhodium bonded to a support nanoparticle comprising zirconium oxide; and porous, micron-sized metal oxide particles comprising cerium-zirconium oxide, wherein the composite nanoparticles are attached to the metal oxide particles. In some embodiments, the washcoat slurry comprises boehmite. Optionally, the washcoat slurry further comprises filler particles comprising aluminum oxide or aluminum-lanthanum oxide.

In some embodiments, the washcoat slurry useful for forming the second washcoat layer comprises composite nanoparticles, the composite nanoparticles comprising a catalytic nanoparticle comprising rhodium bonded to a support nanoparticle comprising cerium-zirconium oxide; and porous, micron-sized metal oxide particles comprising cerium-zirconium oxide, wherein the composite nanoparticles are attached to the metal oxide particles. In some embodiments, the washcoat slurry comprises boehmite. Optionally, the washcoat slurry further comprises filler particles comprising aluminum oxide or aluminum-lanthanum oxide.

In some embodiments, the washcoat slurry useful for forming the second washcoat layer comprises composite nanoparticles, the composite nanoparticles comprising a catalytic nanoparticle comprising rhodium bonded to a support nanoparticle comprising cerium-zirconium-lanthanum oxide; and porous, micron-sized metal oxide particles comprising cerium-zirconium oxide, wherein the composite nanoparticles are attached to the metal oxide particles. In some embodiments, the washcoat slurry comprises boehmite. Optionally, the washcoat slurry further comprises filler particles comprising aluminum oxide or aluminum-lanthanum oxide.

In some embodiments, the washcoat slurry useful for forming the second washcoat layer comprises composite nanoparticles, the composite nanoparticles comprising a catalytic nanoparticle comprising rhodium bonded to a support nanoparticle comprising cerium-zirconium-neodymium oxide; and porous, micron-sized metal oxide particles comprising cerium-zirconium oxide, wherein the composite nanoparticles are attached to the metal oxide particles. In some embodiments, the washcoat slurry comprises boehmite. Optionally, the washcoat slurry further comprises filler particles comprising aluminum oxide or aluminum-lanthanum oxide.

In some embodiments, the washcoat slurry useful for forming the second washcoat layer comprises composite nanoparticles, the composite nanoparticles comprising a catalytic nanoparticle comprising rhodium bonded to a support nanoparticle comprising cerium-zirconium-lanthanum-neodymium oxide; and porous, micron-sized metal oxide particles comprising cerium-zirconium oxide, wherein the composite nanoparticles are attached to the metal oxide particles. In some embodiments, the washcoat slurry comprises boehmite. Optionally, the washcoat slurry further comprises filler particles comprising aluminum oxide or aluminum-lanthanum oxide.

In some embodiments, the washcoat slurry useful for forming the second washcoat layer comprises composite nanoparticles, the composite nanoparticles comprising a catalytic nanoparticle comprising rhodium bonded to a support nanoparticle comprising zirconium oxide; and porous, micron-sized metal oxide particles comprising cerium-zirconium-lanthanum oxide, wherein the composite nanoparticles are attached to the metal oxide particles. In some embodiments, the washcoat slurry comprises boehmite. Optionally, the washcoat slurry further comprises filler particles comprising aluminum oxide or aluminum-lanthanum oxide.

In some embodiments, the washcoat slurry useful for forming the second washcoat layer comprises composite nanoparticles, the composite nanoparticles comprising a catalytic nanoparticle comprising rhodium bonded to a support nanoparticle comprising cerium-zirconium oxide; and porous, micron-sized metal oxide particles comprising cerium-zirconium-lanthanum oxide, wherein the composite nanoparticles are attached to the metal oxide particles. In some embodiments, the washcoat slurry comprises boehmite. Optionally, the washcoat slurry further comprises filler particles comprising aluminum oxide or aluminum-lanthanum oxide.

In some embodiments, the washcoat slurry useful for forming the second washcoat layer comprises composite nanoparticles, the composite nanoparticles comprising a catalytic nanoparticle comprising rhodium bonded to a support nanoparticle comprising cerium-zirconium-lanthanum oxide; and porous, micron-sized metal oxide particles comprising cerium-zirconium-lanthanum oxide, wherein the composite nanoparticles are attached to the metal oxide particles. In some embodiments, the washcoat slurry comprises boehmite. Optionally, the washcoat slurry further comprises filler particles comprising aluminum oxide or aluminum-lanthanum oxide.

In some embodiments, the washcoat slurry useful for forming the second washcoat layer comprises composite nanoparticles, the composite nanoparticles comprising a catalytic nanoparticle comprising rhodium bonded to a support nanoparticle comprising cerium-zirconium-neodymium oxide; and porous, micron-sized metal oxide particles comprising cerium-zirconium-lanthanum oxide, wherein the composite nanoparticles are attached to the metal oxide particles. In some embodiments, the washcoat slurry comprises boehmite. Optionally, the washcoat slurry further comprises filler particles comprising aluminum oxide or aluminum-lanthanum oxide.

In some embodiments, the washcoat slurry useful for forming the second washcoat layer comprises composite nanoparticles, the composite nanoparticles comprising a catalytic nanoparticle comprising rhodium bonded to a support nanoparticle comprising cerium-zirconium-lanthanum-neodymium oxide; and porous, micron-sized metal oxide particles comprising cerium-zirconium-lanthanum oxide, wherein the composite nanoparticles are attached to the metal oxide particles. In some embodiments, the washcoat slurry comprises boehmite. Optionally, the washcoat slurry further comprises filler particles comprising aluminum oxide or aluminum-lanthanum oxide.

In some embodiments, the washcoat slurry useful for forming the second washcoat layer comprises composite nanoparticles, the composite nanoparticles comprising a catalytic nanoparticle comprising rhodium bonded to a support nanoparticle comprising zirconium oxide; and porous, micron-sized metal oxide particles comprising cerium-zirconium-neodymium oxide, wherein the composite nanoparticles are attached to the metal oxide particles. In some embodiments, the washcoat slurry comprises boehmite. Optionally, the washcoat slurry further comprises filler particles comprising aluminum oxide or aluminum-lanthanum oxide.

In some embodiments, the washcoat slurry useful for forming the second washcoat layer comprises composite nanoparticles, the composite nanoparticles comprising a catalytic nanoparticle comprising rhodium bonded to a support nanoparticle comprising cerium-zirconium oxide; and porous, micron-sized metal oxide particles comprising cerium-zirconium-neodymium oxide, wherein the composite nanoparticles are attached to the metal oxide particles. In some embodiments, the washcoat slurry comprises boehmite. Optionally, the washcoat slurry further comprises filler particles comprising aluminum oxide or aluminum-lanthanum oxide.

In some embodiments, the washcoat slurry useful for forming the second washcoat layer comprises composite nanoparticles, the composite nanoparticles comprising a catalytic nanoparticle comprising rhodium bonded to a support nanoparticle comprising cerium-zirconium-lanthanum oxide; and porous, micron-sized metal oxide particles comprising cerium-zirconium-neodymium oxide, wherein the composite nanoparticles are attached to the metal oxide particles. In some embodiments, the washcoat slurry comprises boehmite. Optionally, the washcoat slurry further comprises filler particles comprising aluminum oxide or aluminum-lanthanum oxide.

In some embodiments, the washcoat slurry useful for forming the second washcoat layer comprises composite nanoparticles, the composite nanoparticles comprising a catalytic nanoparticle comprising rhodium bonded to a support nanoparticle comprising cerium-zirconium-neodymium oxide; and porous, micron-sized metal oxide particles comprising cerium-zirconium-neodymium oxide, wherein the composite nanoparticles are attached to the metal oxide particles. In some embodiments, the washcoat slurry comprises boehmite. Optionally, the washcoat slurry further comprises filler particles comprising aluminum oxide or aluminum-lanthanum oxide.

In some embodiments, the washcoat slurry useful for forming the second washcoat layer comprises composite nanoparticles, the composite nanoparticles comprising a catalytic nanoparticle comprising rhodium bonded to a support nanoparticle comprising cerium-zirconium lanthanum-neodymium oxide; and porous, micron-sized metal oxide particles comprising cerium-zirconium-neodymium oxide, wherein the composite nanoparticles are attached to the metal oxide particles. In some embodiments, the washcoat slurry comprises boehmite. Optionally, the washcoat slurry further comprises filler particles comprising aluminum oxide or aluminum-lanthanum oxide.

In some embodiments, the washcoat slurry useful for forming the second washcoat layer comprises composite nanoparticles, the composite nanoparticles comprising a catalytic nanoparticle comprising rhodium bonded to a support nanoparticle comprising zirconium oxide; and porous, micron-sized metal oxide particles comprising cerium-zirconium-lanthanum-neodymium oxide, wherein the composite nanoparticles are attached to the metal oxide particles. In some embodiments, the washcoat slurry comprises boehmite. Optionally, the washcoat slurry further comprises filler particles comprising aluminum oxide or aluminum-lanthanum oxide.

In some embodiments, the washcoat slurry useful for forming the second washcoat layer comprises composite nanoparticles, the composite nanoparticles comprising a catalytic nanoparticle comprising rhodium bonded to a support nanoparticle comprising cerium-zirconium oxide; and porous, micron-sized metal oxide particles comprising cerium-zirconium-lanthanum-neodymium oxide, wherein the composite nanoparticles are attached to the metal oxide particles. In some embodiments, the washcoat slurry comprises boehmite. Optionally, the washcoat slurry further comprises filler particles comprising aluminum oxide or aluminum-lanthanum oxide.

In some embodiments, the washcoat slurry useful for forming the second washcoat layer comprises composite nanoparticles, the composite nanoparticles comprising a catalytic nanoparticle comprising rhodium bonded to a support nanoparticle comprising cerium-zirconium-lanthanum oxide; and porous, micron-sized metal oxide particles comprising cerium-zirconium-lanthanum-neodymium oxide, wherein the composite nanoparticles are attached to the metal oxide particles. In some embodiments, the washcoat slurry comprises boehmite. Optionally, the washcoat slurry further comprises filler particles comprising aluminum oxide or aluminum-lanthanum oxide.

In some embodiments, the washcoat slurry useful for forming the second washcoat layer comprises composite nanoparticles, the composite nanoparticles comprising a catalytic nanoparticle comprising rhodium bonded to a support nanoparticle comprising cerium-zirconium-neodymium oxide; and porous, micron-sized metal oxide particles comprising cerium-zirconium-lanthanum-neodymium oxide, wherein the composite nanoparticles are attached to the metal oxide particles. In some embodiments, the washcoat slurry comprises aluminum oxide derived from boehmite. Optionally, the washcoat slurry further comprises filler particles comprising aluminum oxide or aluminum-lanthanum oxide.

In some embodiments, the washcoat slurry useful for forming the second washcoat layer comprises composite nanoparticles, the composite nanoparticles comprising a catalytic nanoparticle comprising rhodium bonded to a support nanoparticle comprising cerium-zirconium-lanthanum-neodymium oxide; and porous, micron-sized metal oxide particles comprising cerium-zirconium-lanthanum-neodymium oxide, wherein the composite nanoparticles are attached to the metal oxide particles. In some embodiments, the washcoat slurry comprises aluminum oxide derived from boehmite. Optionally, the washcoat slurry further comprises filler particles comprising aluminum oxide or aluminum-lanthanum oxide.

In some embodiments, the washcoat slurry useful for forming the second washcoat layer comprises the components listed for embodiment (I) of the second washcoat layer as disclosed herein.

In some embodiments, the washcoat slurry useful for forming the second washcoat layer comprises the components listed for embodiment (II) of the second washcoat layer as disclosed herein.

In some embodiments, the washcoat slurry useful for forming the second washcoat layer comprises the components listed for embodiment (III) of the second washcoat layer as disclosed herein.

In some embodiments, rheology modifiers, including, but not limited to, corn starch and cellulose (such as 2-hydroxyethyl cellulose) are added to adjust the washcoat slurry to the desired viscosity. In some embodiments, the rheology modifiers are added to the washcoat slurry to between about 0.5% and about 1.6% of the washcoat slurry.

In some embodiments, the washcoat slurry useful for the formation of the second washcoat layer is applied to the substrate. The substrate is then dried and calcined to form the second washcoat layer.

### Corner-Fill Washcoat Compositions

In some embodiments, the coated substrate further comprises a corner fill layer. The corner-fill washcoat layer may be a relatively inexpensive layer, which may be applied to the substrate to fill up the “corners” and other areas of the substrate where exhaust gases are unlikely to penetrate in significant amounts coats the substrate proximally relative to the first washcoat layer or the second washcoat layer. Preferably, this layer does not include any PGM. In some embodiments, the corner-fill layer may comprise zeolite particles. In some embodiments, the corner-fill layer does not comprise zeolite particles or is substantially free of zeolite particles.

In some embodiments, the corner-fill washcoat compositions may comprise filler particles, such as aluminum oxide particles (i.e., aluminum oxide). In some embodiments, aluminum-oxide particles such as MI-386 material from Grace Davison, or the like, can be used. The size of the aluminum oxide particles is generally above about 0.2 microns, preferably above about 1 micron. In some embodiments, the solids content of the corner-fill washcoat composition comprises about 80 wt % to about 100 wt % porous aluminum oxide (MI-386 or the like). In some embodiments, the solids content of the corner-fill washcoat composition comprises about 80 wt % to about 99 wt % porous aluminum oxide and about 20 wt % to about 1 wt % boehmite, such as about 90 wt % to 99 wt % aluminum oxide and about 10 wt % to 1 wt % boehmite, or about 95 wt % to 99 wt % aluminum oxide and about 5 wt % to about 1 wt % boehmite, such as a corner-fill washcoat composition including about 97 wt % porous aluminum oxide and about 3 wt % boehmite. In some embodiments, boehmite converts to aluminum oxide after calcination of the washcoat composition.

In some embodiments, each of the aluminum oxide particles or substantially each of the aluminum oxide particles in the corner-fill washcoat composition have a diameter of approximately 0.2 microns to approximately 8 microns, such as about 4 microns to about 6 microns. In some embodiments, the aluminum oxide particles in the corner-fill washcoat composition have an average grain size of approximately 0.2 microns to approximately 8 microns, such as about 4 microns to about 6 microns. In some embodiments, at least about 75 wt %, at least about 80 wt %, at least about 90 wt %, or at least about 95 wt % of the aluminum oxide particles in the corner-fill washcoat composition have a particle size falling within the range of approximately 0.2 microns to approximately 8 microns, such as within the range of about 4 microns to about 6 microns. After a washcoat composition has been applied to a substrate, it may be dried, and then calcined, onto the substrate. The corner-fill washcoat composition may be applied in a thickness of from about 30 g/l up to about 100 g/l; a typical value may be about 50 g/l.

### Plasma Synthesis of Composite Nanoparticles

The composite nano-particles described herein may be formed by plasma reactor methods, by feeding one or more catalytic materials, such as one or more platinum group metal(s), and one or more support materials, such as a metal oxide, into a plasma gun, where the materials are vaporized. Plasma guns such as those disclosed in US 2011/0143041, the disclosure of which is hereby incorporated by reference in its entirety, can be used, and techniques such as those disclosed in U.S. Pat. No. 5,989,648, U.S. Pat. No. 6,689,192, U.S. Pat. No. 6,755,886, and US 2005/0233380, the entire disclosures of which are hereby incorporated by reference herein, can be used to generate plasma. The high-throughput system disclosed in U.S. Published Patent Application No. 2014/0263190 and International Patent Application No. PCT/US2014/024933 (published as WO 2014/159736), the entire disclosures of which are hereby incorporated by reference herein, can be used to generate the composite nanoparticles. A working gas, such as argon, is supplied to the plasma gun for the generation of plasma; in one embodiment, an argon/hydrogen mixture (for example, in the ratio of 10:1 Ar/H₂ or 10:2 Ar/H₂) is used as the working gas. In one embodiment, one or more platinum group metals, such as palladium, platinum and/or rhodium, which are generally in the form of metal particles of about 0.5 to 6 microns in diameter, are introduced into the plasma reactor as a fluidized powder in a carrier gas stream such as argon. In some embodiments two or more platinum group metals may be added, such as a mixture of platinum and palladium in any ratio, or any range of ratios. Support material, for example a metal oxide, such as one or more of aluminum oxide, cerium oxide, zirconium oxide, lanthanum oxide, neodymium oxide, or yttrium oxide in any proportion, in a particle size of about 15 to 25 microns diameter, is also introduced as a fluidized powder in carrier gas. In some embodiments, a composition of about 5 wt % to about 65 wt % platinum group metal(s) and about 95 wt % to about 35 wt % metal oxide may be used, depending on the desired ratio of platinum group metal to metal oxide, as described herein.

Other methods of introducing the materials into the reactor can be used, such as in a liquid slurry. Any solid or liquid materials are rapidly vaporized or turned into plasma. The kinetic energy of the superheated material, which can reach temperatures of 20,000 to 30,000 Kelvin, ensures extremely thorough mixing of all components.

The superheated material of the plasma stream is then quenched rapidly, using such methods as the turbulent quench chamber disclosed in US 2008/0277267. Argon quench gas at high flow rates, such as 2400 to 2600 liters per minute, is injected into the superheated material. The material is further cooled in a cool-down tube, and collected and analyzed to ensure proper size ranges of material. Equipment suitable for plasma synthesis is disclosed in U.S. Patent Application Publication No. 2008/0277267, U.S. Pat. No. 8,663,571, U.S. patent application Ser. No. 14/207,087 and International Patent Appl. No. PCT/US2014/024933. As the mixed platinum group metal(s)-support material plasma cools down, composite nano-particles comprising a platinum group metal nanoparticle bonded to a support nanoparticle form. If two or more platinum group metals were introduced into the plasma gun, along with the support material, then composite nanoparticles, comprising a nanoparticle comprising an alloy of those platinum group metals bonded to a support nanoparticle, form.

The plasma production method described above produces highly uniform composite nano-particles, where the composite nano-particles comprise a catalytic nano-particle bonded to a support nano-particle.

### Micron-Sized Carrier Particles Bearing Composite Catalytic Nanoparticles (“Nano-On-Nano-On-Micro” Particles or “NNm” Particles

In some embodiments, the composite nanoparticles are attached to the metal oxide particles, for example by incipient wetness impregnation followed by drying and calcination, in any of the washcoat slurries or washcoat layers. In some embodiments, the metal oxide particles are micron sized particles. When the composite nanoparticles (i.e., “nano-on-nano” particles) are attached to micron-sized metal oxide particles, the resulting particles are termed “nano-on-nano-on-micro” or NNm particles. In some embodiments, the second washcoat layer and/or the washcoat slurry used to form the second washcoat layer comprises NNm particles, the NNm particles comprising composite nanoparticles bound to a micron-sized metal oxide particle, the composite nanoparticles comprising a catalytic nanoparticle (such as a rhodium catalytic nanoparticle) and a support nanoparticle (such as a cerium oxide-zirconium oxide mixed-metal oxide support nanoparticle), and the micron-sized metal oxide particle is a cerium oxide-zirconium oxide mixed-metal oxide micron-sized particle.

The metal oxide particles can have an average size between about 1 micron and about 100 microns, such as between about 1 micron and about 10 microns, between about 3 microns and about 7 microns, or between about 4 microns and about 6 microns.

In some embodiments, catalytic nanoparticles comprise about 0.001 wt % to about 5 wt % of the total NNm particle. For example, in some embodiments, the catalytic nanoparticles comprise about 0.01 wt % to about 2 wt % of the total NNm particle, about 0.1 wt % to about 1 wt % of the total NNm particle, about 0.15 wt % of the total NNm particle, about 0.17 wt % of the total NNm particle, or about 0.2 wt % of the total NNm particle. In some embodiments, platinum group metals may comprise less than about 5 wt %, less than about 2 wt %, less than about 1 wt %, or less than about 0.5 wt % of the total NNm particle.

In some embodiments, an NNm particle is prepared by suspending composite nanoparticles in a liquid (such as water), adjusting the pH of the suspension to between about 2 and about 7, between about 3 and about 5, or about 4 to form a suspension. The pH may be adjusted, for example by using acetic acid or another organic acid. Optionally one or more surfactants and/or dispersants may be added to the suspension (or, alternatively, adding the surfactants to the water before suspending the composite nanoparticles in the liquid). Surfactants suitable for use include Jeffsperse® X3202 (Chemical Abstracts Registry No. 68123-18-2, described as 4,4′-(1-methylethylidene)bis-phenol polymer with 2-(chloromethyl)oxirane, 2-methyloxirane, and oxirane), Jeffsperse® X3204, and Jeffsperse® X3503 surfactants from Huntsman (JEFFSPERSE is a registered trademark of Huntsman Corporation, The Woodlands, Tex., United States of America for chemicals for use as dispersants and stabilizers), which are non-ionic polymeric dispersants. Other suitable surfactants include Solsperse® 24000 and Solsperse® 46000 from Lubrizol (SOLSPERSE is a registered trademark of Lubrizol Corporation, Derbyshire, United Kingdom for chemical dispersing agents). The surfactant may be added in a range, for example, of about 0.5% to about 5%, with about 2% being a typical value. The suspension of catalytic composite nanoparticles is then applied to micron-sized metal oxide particles to the point of incipient wetness, thereby impregnating the micron-sized particles with catalytic composite nanoparticles. The resulting wet powder may then be dried and calcined, resulting in NNm particles.

Micron-Sized Particles with Embedded Composite Catalytic Nanoparticles (“Nano-On-Nano-in-Micro” Particles or “NNiM” Particles

In some embodiments, the composite nanoparticles (nano-on-nano particles or NN particles, which are comprised of a support nanoparticle and a catalytic nanoparticle) can be embedded within a porous carrier particle to produce micron-sized catalytic particles, called “nano-on-nano-in-micro” particles or “NNiM particles.” The porous carrier is built up or formed around the composite nano-on-nano (NN) particles, and forms a matrix or scaffold which surrounds, encompasses, or bridges together the composite nanoparticles. As used herein, the term “embedded” when describing nanoparticles embedded in a porous carrier includes the term “bridged together by” when describing nanoparticles bridged together by a porous carrier, and refers to the configuration of the nanoparticles in the porous carrier resulting when the porous carrier is formed around or surrounds the nanoparticles. In this configuration, the nano-on-nano composite nanoparticles are distributed throughout the micron-sized carrier particles. The porous materials can allow gases and fluids to slowly flow throughout the porous material via the interconnected channels, being exposed to the high surface area of the porous material. The porous materials can therefore serve as an excellent carrier material for embedding particles in which high surface area exposure is desirable, such as composite nanoparticles comprising a catalytic nanoparticle and a support nanoparticle, as the porous materials enable gases or fluids to readily contact the composite nanoparticles.

Preparation of NNiM particles, including preparation of the surrounding porous carrier aluminum oxide (alumina) is disclosed in International Patent Appl. No. WO 2015/042598 and U.S. Patent Application Publication No. 2015/0140317. Preparation of NNiM particles is also disclosed in International Patent Appl. No. PCT/US2016/059540 and U.S. Provisional Patent Appl. No. 62/249,141, including preparation of surrounding porous carrier (carrier matrices) comprising cerium oxide (ceria), cerium-zirconium oxide, cerium-zirconium-lanthanum oxide, cerium-zirconium-lanthanum-neodymium oxide, or cerium-zirconium-lanthanum-yttrium oxide, which are built up around and surround or encompass the (nanoparticle catalyst-on-nanoparticle support) composite nanoparticles.

In some embodiments, the porous structure surrounding or built up around the composite nanoparticles (that is, the porous structure in which the composite nanoparticles are embedded) can comprise alumina. In some embodiments, the porous structure surrounding or built up around the composite nanoparticles (that is, the porous structure in which the composite nanoparticles are embedded) can comprise cerium oxide. In some embodiments, the porous structure surrounding or built up around the composite nanoparticles (that is, the porous structure in which the composite nanoparticles are embedded) can comprise cerium oxide mixed with other metal oxides such as zirconium oxide, lanthanum oxide, neodymium oxide, yttrium oxide, neodymium oxide, or a combination thereof, such as cerium-zirconium oxide, cerium-lanthanum oxide, cerium-yttrium oxide, cerium-neodymium oxide, cerium-zirconium-lanthanum oxide, cerium-zirconium-yttrium oxide, cerium-zirconium-neodymium oxide, cerium-lanthanum-yttrium oxide, cerium-lanthanum-neodymium oxide, cerium-yttrium-neodymium oxide, cerium-zirconium-lanthanum-yttrium oxide, cerium-zirconium-lanthanum-neodymium oxide, cerium-zirconium-yttrium-neodymium oxide, cerium-lanthanum-yttrium-neodymium oxide, or cerium-zirconium-lanthanum-yttrium-neodymium oxide.

The porous material surrounding or built up around the composite nanoparticles can have an average pore, hole, channel, or pit width (diameter) ranging from 1 nm to about 200 nm, or about 1 nm to about 100 nm, or about 2 nm to about 50 nm, or about 3 nm to about 25 nm. The porous material can have an average pore surface area in a range of about 50 m²/g to about 500 m²/g, or of about 100 m²/g to about 400 m²/g, or of about 150 m²/g to about 300 m²/g, or of less than about 50 m²/g, or of greater than about 500 m²/g, or of greater than about 100 m²/g, or of greater than about 200 m²/g, or of greater than about 300 m²/g, or of greater than about 400 m²/g, or of greater than about 450 m²/g, or of about 200 m²/g, of about 300 m²/g, of about 200 m²/g, of about 250 m²/g, of about 300 m²/g, of about 350 m²/g, of about 400 m²/g, of about 450 m²/g, or of about 500 m²/g.

In some embodiments, the porous carrier can be a porous ceramic. In some embodiments, the porous material may comprise porous metal oxide, such as aluminum oxide, cerium oxide, cerium-zirconium oxide, cerium-lanthanum oxide, cerium-yttrium oxide, cerium-neodymium oxide, cerium-zirconium-lanthanum oxide, cerium-zirconium-yttrium oxide, cerium-zirconium-neodymium oxide, cerium-lanthanum-yttrium oxide, cerium-lanthanum-neodymium oxide, cerium-yttrium-neodymium oxide, cerium-zirconium-lanthanum-yttrium oxide, cerium-zirconium-lanthanum-neodymium oxide, cerium-zirconium-yttrium-neodymium oxide, cerium-lanthanum-yttrium-neodymium oxide, or cerium-zirconium-lanthanum-yttrium-neodymium oxide. In some embodiments, the porous carrier may further comprise silica. In some embodiments, the porous carrier may comprise aluminum oxide, cerium oxide, cerium-zirconium oxide, cerium-lanthanum oxide, cerium-yttrium oxide, cerium-neodymium oxide, cerium-zirconium-lanthanum oxide, cerium-zirconium-yttrium oxide, cerium-zirconium-neodymium oxide, cerium-lanthanum-yttrium oxide, cerium-lanthanum-neodymium oxide, cerium-yttrium-neodymium oxide, cerium-zirconium-lanthanum-yttrium oxide, cerium-zirconium-lanthanum-neodymium oxide, cerium-zirconium-yttrium-neodymium oxide, cerium-lanthanum-yttrium-neodymium oxide, or cerium-zirconium-lanthanum-yttrium-neodymium oxide after a spacer material has been removed. For example, in some embodiments, a composite material may be formed with interspersed metal oxide, such as aluminum oxide, cerium oxide, cerium-zirconium oxide, cerium-lanthanum oxide, cerium-yttrium oxide, cerium-neodymium oxide, cerium-zirconium-lanthanum oxide, cerium-zirconium-yttrium oxide, cerium-zirconium-neodymium oxide, cerium-lanthanum-yttrium oxide, cerium-lanthanum-neodymium oxide, cerium-yttrium-neodymium oxide, cerium-zirconium-lanthanum-yttrium oxide, cerium-zirconium-lanthanum-neodymium oxide, cerium-zirconium-yttrium-neodymium oxide, cerium-lanthanum-yttrium-neodymium oxide, or cerium-zirconium-lanthanum-yttrium-neodymium oxide, and polymerized resorcinol. The polymerized resorcinol is removed, for example, by calcination, resulting in a porous carrier of aluminum oxide, cerium oxide, cerium-zirconium oxide, cerium-lanthanum oxide, cerium-yttrium oxide, cerium-neodymium oxide, cerium-zirconium-lanthanum oxide, cerium-zirconium-yttrium oxide, cerium-zirconium-neodymium oxide, cerium-lanthanum-yttrium oxide, cerium-lanthanum-neodymium oxide, cerium-yttrium-neodymium oxide, cerium-zirconium-lanthanum-yttrium oxide, cerium-zirconium-lanthanum-neodymium oxide, cerium-zirconium-yttrium-neodymium oxide, cerium-lanthanum-yttrium-neodymium oxide, or cerium-zirconium-lanthanum-yttrium-neodymium oxide. In some embodiments, a composite material may be formed with interspersed metal oxide, such as aluminum oxide, cerium oxide, cerium-zirconium oxide, cerium-lanthanum oxide, cerium-yttrium oxide, cerium-neodymium oxide, cerium-zirconium-lanthanum oxide, cerium-zirconium-yttrium oxide, cerium-zirconium-neodymium oxide, cerium-lanthanum-yttrium oxide, cerium-lanthanum-neodymium oxide, cerium-yttrium-neodymium oxide, cerium-zirconium-lanthanum-yttrium oxide, cerium-zirconium-lanthanum-neodymium oxide, cerium-zirconium-yttrium-neodymium oxide, cerium-lanthanum-yttrium-neodymium oxide, or cerium-zirconium-lanthanum-yttrium-neodymium oxide, and carbon black. The carbon black is removed, for example, by calcination, resulting in a porous carrier of aluminum oxide, cerium oxide, cerium-zirconium oxide, cerium-lanthanum oxide, cerium-yttrium oxide, cerium-neodymium oxide, cerium-zirconium-lanthanum oxide, cerium-zirconium-yttrium oxide, cerium-zirconium-neodymium oxide, cerium-lanthanum-yttrium oxide, cerium-lanthanum-neodymium oxide, cerium-yttrium-neodymium oxide, cerium-zirconium-lanthanum-yttrium oxide, cerium-zirconium-lanthanum-neodymium oxide, cerium-zirconium-yttrium-neodymium oxide, cerium-lanthanum-yttrium-neodymium oxide, or cerium-zirconium-lanthanum-yttrium-neodymium oxide.

In some embodiments, the porous material is a micron-sized particle, with an average size between about 1 micron and about 100 microns, between about 1 micron and about 10 microns, between about 3 microns and about 7 microns, or between about 4 microns and about 6 microns. In other embodiments, the porous material may be particles larger than about 7 microns. In some embodiments, the porous material may not be in the form of particles, but a continuous material.

Nano-on-nano particles can be produced where the catalytic nanoparticle can comprise platinum, palladium, or platinum/palladium alloy, and the support nanoparticle can comprise aluminum oxide. Nano-on-nano particles can be produced where the catalytic nanoparticle can comprise rhodium, and the support nanoparticle can comprise cerium oxide, cerium-zirconium oxide, cerium-lanthanum oxide, cerium-yttrium oxide, cerium-neodymium oxide, cerium-zirconium-lanthanum oxide, cerium-zirconium-yttrium oxide, cerium-zirconium-neodymium oxide, cerium-lanthanum-yttrium oxide, cerium-lanthanum-neodymium oxide, cerium-yttrium-neodymium oxide, cerium-zirconium-lanthanum-yttrium oxide, cerium-zirconium-lanthanum-neodymium oxide, cerium-zirconium-yttrium-neodymium oxide, cerium-lanthanum-yttrium-neodymium oxide, or cerium-zirconium-lanthanum-yttrium-neodymium oxide. In one embodiment, the support nanoparticle for a rhodium catalytic nanoparticle can comprise cerium oxide. In some embodiments, the support nanoparticle for a rhodium catalytic nanoparticle comprises 40-90 wt % cerium oxide, 5-60 wt % zirconium oxide, 1-15 wt % lanthanum oxide, and/or 1-10 wt % yttrium oxide. In some embodiments, the support nanoparticle for a rhodium catalytic nanoparticle comprises 86 wt % cerium oxide, 10 wt % zirconium oxide, and 4 wt % lanthanum oxide. In some embodiments, the support nanoparticle for a rhodium catalytic nanoparticle comprises 40 wt % cerium oxide, 50 wt % zirconium oxide, 5 wt % lanthanum oxide, and 5 wt % yttrium oxide.

In some embodiments, the porous material can comprise about 10% to about 70% by weight cerium oxide, about 30% to about 90% by weight zirconium oxide, about 1% to about 15% by weight lanthanum oxide, and about 1% to about 15% by weight yttrium oxide.

In some embodiments, the porous material can comprise about 1% to about 70% by weight cerium oxide, about 30% to about 99% by weight zirconium oxide, about 0.5% to about 15% by weight lanthanum oxide, and about 0.5% to about 15% by weight neodymium oxide.

The porous materials with embedded nano-on-nano particles within the porous structure of the material, where the porous structure comprises alumina, or where the porous structure comprises ceria, or where the porous structure comprises cerium-zirconium oxide, cerium-lanthanum oxide, cerium-yttrium oxide, cerium-neodymium oxide, cerium-zirconium-lanthanum oxide, cerium-zirconium-yttrium oxide, cerium-zirconium-neodymium oxide, cerium-lanthanum-yttrium oxide, cerium-lanthanum-neodymium oxide, cerium-yttrium-neodymium oxide, cerium-zirconium-lanthanum-yttrium oxide, cerium-zirconium-lanthanum-neodymium oxide, cerium-zirconium-yttrium-neodymium oxide, cerium-lanthanum-yttrium-neodymium oxide, or cerium-zirconium-lanthanum-yttrium-neodymium oxide, or where any of the foregoing metal oxide porous structures further comprise silica, can be prepared as described in WO 2015/042598, U.S. Patent Application Publication No. 2015/0140317, International Patent Appl. No. PCT/US2016/059540, and U.S. Provisional Patent Appl. No. 62/249,141, the disclosures of which are hereby incorporated by reference in their entirety. Alumina porous structures may be formed, for example, by the methods described in U.S. Pat. No. 3,520,654, the disclosure of which is hereby incorporated by reference in its entirety.

Nano-on-nano-in-micro (“NNiM”) materials are prepared by mixing nano-on-nano (NN) particles into the precursors to the porous materials, for example, by using a portion of NN particles when mixing together nanoparticles with amorphous carbon, or by mixing NN particles into sol-gel solutions of the appropriate metal oxide precursors. The porous material with embedded NN particles is then ground or milled into micron-sized particles (to form “NNiM” materials). The resulting material can then be used in washcoats. The amount of NN particles added is guided by the desired loading of PGM metal in the final NNiM material.

Oxidative NNiM material can be formed, where the nano-on-nano composite nanoparticles comprise a platinum catalytic nanoparticle disposed on an aluminum oxide support particle; where the nano-on-nano composite nanoparticles comprise a palladium catalytic nanoparticle disposed on an aluminum oxide support particle; or where the nano-on-nano composite nanoparticles comprise a platinum/palladium alloy catalytic nanoparticle disposed on an aluminum oxide support particle; and one or more of those NN particles is then embedded in a porous carrier formed of aluminum oxide, which is ground or milled into micron-sized particles. Reductive NNiM material can be formed, where the nano-on-nano composite nanoparticles comprise a rhodium catalytic nanoparticle disposed on a cerium oxide support particle, or where the nano-on-nano composite nanoparticles comprise a rhodium catalytic nanoparticle disposed on a cerium-zirconium oxide, cerium-lanthanum oxide, cerium-yttrium oxide, cerium-neodymium oxide, cerium-zirconium-lanthanum oxide, cerium-zirconium-yttrium oxide, cerium-zirconium-neodymium oxide, cerium-lanthanum-yttrium oxide, cerium-lanthanum-neodymium oxide, cerium-yttrium-neodymium oxide, cerium-zirconium-lanthanum-yttrium oxide, cerium-zirconium-lanthanum-neodymium oxide, cerium-zirconium-yttrium-neodymium oxide, cerium-lanthanum-yttrium-neodymium oxide, or cerium-zirconium-lanthanum-yttrium-neodymium oxide; and one or more of those NN particles is then embedded in a porous carrier formed of porous cerium oxide, or one or more of those NN particles is then embedded in a porous carrier formed of porous cerium-zirconium oxide, cerium-lanthanum oxide, cerium-yttrium oxide, cerium-neodymium oxide, cerium-zirconium-lanthanum oxide, cerium-zirconium-yttrium oxide, cerium-zirconium-neodymium oxide, cerium-lanthanum-yttrium oxide, cerium-lanthanum-neodymium oxide, cerium-yttrium-neodymium oxide, cerium-zirconium-lanthanum-yttrium oxide, cerium-zirconium-lanthanum-neodymium oxide, cerium-zirconium-yttrium-neodymium oxide, cerium-lanthanum-yttrium-neodymium oxide, or cerium-zirconium-lanthanum-yttrium-neodymium oxide carrier, which is ground or milled into micron-sized particles. Aluminum oxide porous material can also be used as the porous material in which any of the foregoing rhodium-containing composite NN nanoparticles can be embedded.

In some embodiments, the catalytic particles are evenly distributed throughout the porous carrier. In other embodiments, the catalytic particles are clustered throughout the porous carrier. In some embodiments, platinum group metals comprise about 0.001 wt % to about 10 wt % of the total catalytic material (catalytic particles and porous carrier). For example, platinum group metals may comprise about 1 wt % to about 8 wt % of the total catalytic material (catalytic particles and porous carrier). In some embodiments, platinum group metals may comprise less than about 10 wt %, less than about 8 wt %, less than about 6 wt %, less than about 4 wt %, less than about 2 wt %, or less than about 1 wt % of the total catalytic material (catalytic particles and porous carrier). In some embodiments, platinum group metals may comprise about 1 wt %, about 2 wt %, about 3 wt %, about 4 wt %, about 5 wt %, about 6 wt %, about 7 wt %, about 8 wt %, about 9 wt %, or about 10 wt % of the total catalytic material (catalytic particles and porous carrier).

In some embodiments, the catalytic nanoparticles comprise one or more platinum group metals. In embodiments with two or more platinum group metals, the metals may be in any ratio. In some embodiments, the catalytic nanoparticles comprise platinum group metal or metals, such as Pt:Pd in about a 2:1 ratio to about 100:1 ratio by weight, or about 2:1 to about 75:1 ratio by weight, or about 2:1 to about 50:1 ratio by weight, or about 2:1 to about 25:1 ratio by weight, or about 2:1 to about 15:1 ratio by weight. In one embodiment, the catalytic nanoparticles comprise platinum group metal or metals, such as Pt:Pd in about 2:1 ratio by weight.

The micron-sized NNiM particles can have an average size between about 1 micron and about 100 microns, such as between about 1 micron and about 10 microns, between about 3 microns and about 7 microns, or between about 4 microns and about 6 microns. The PGM particles may comprise about 0.001 wt % to about 10 wt % of the total mass of the NNiM particle (catalytic particles and porous carrier). For example, platinum group metals, such as rhodium, platinum, palladium, or platinum/palladium alloy, may comprise about 1 wt % to about 8 wt % of the total mass of the NNiM particle (catalytic particles and porous carrier). In some embodiments, platinum group metals may comprise less than about 10 wt %, less than about 8 wt %, less than about 6 wt %, less than about 4 wt %, less than about 2 wt %, or less than about 1 wt % of the total mass of the NNiM particle (catalytic particles and porous carrier). In some embodiments, platinum group metals may comprise about 1 wt %, about 2 wt %, about 3 wt %, about 4 wt %, about 5 wt %, about 6 wt %, about 7 wt %, about 8 wt %, about 9 wt %, or about 10 wt % of the total mass of the NNiM particle (catalytic particles and porous carrier).

### Cerium Compounds for Use in the Invention

Several embodiments of the invention use cerium oxide or compounds comprising mixed metal oxides containing cerium oxide and one or more metal oxides. In any embodiment described herein where cerium oxide or a mixed metal oxide comprising cerium oxide is used, the following oxides can be used instead of, or in addition to, the cerium oxide or mixed metal oxide: cerium oxide, cerium-zirconium oxide, cerium-lanthanum oxide, cerium-yttrium oxide, cerium-neodymium oxide, cerium-zirconium-lanthanum oxide, cerium-zirconium-yttrium oxide, cerium-zirconium-neodymium oxide, cerium-lanthanum-yttrium oxide, cerium-lanthanum-neodymium oxide, cerium-yttrium-neodymium oxide, cerium-zirconium-lanthanum-yttrium oxide, cerium-zirconium-lanthanum-neodymium oxide, cerium-zirconium-yttrium-neodymium oxide, cerium-lanthanum-yttrium-neodymium oxide, or cerium-zirconium-lanthanum-yttrium-neodymium oxide. Cerium oxide, cerium-zirconium oxide, and cerium-zirconium-lanthanum oxide, cerium-zirconium-lanthanum-yttrium oxide, and cerium-zirconium-lanthanum-neodymium oxide are a useful subgroup, especially cerium oxide and cerium-zirconium oxide.

In particular, for composite nanoparticles comprising a catalytic nanoparticle and a support nanoparticle, for any embodiment described herein where the catalytic particle comprises rhodium, the support nanoparticle can comprise cerium oxide, cerium-zirconium oxide, cerium-lanthanum oxide, cerium-yttrium oxide, cerium-neodymium oxide, cerium-zirconium-lanthanum oxide, cerium-zirconium-yttrium oxide, cerium-zirconium-neodymium oxide, cerium-lanthanum-yttrium oxide, cerium-lanthanum-neodymium oxide, cerium-yttrium-neodymium oxide, cerium-zirconium-lanthanum-yttrium oxide, cerium-zirconium-lanthanum-neodymium oxide, cerium-zirconium-yttrium-neodymium oxide, cerium-lanthanum-yttrium-neodymium oxide, or cerium-zirconium-lanthanum-yttrium-neodymium oxide. Cerium oxide, cerium-zirconium oxide, and cerium-zirconium-lanthanum oxide, cerium-zirconium-lanthanum-yttrium oxide, and cerium-zirconium-lanthanum-neodymium oxide are a useful subgroup, especially cerium oxide and cerium-zirconium oxide.

In any embodiment where composite nanoparticles comprising a rhodium catalytic nanoparticle and a cerium oxide or mixed metal oxide comprising cerium oxide are used in conjunction with additional metal oxide particles in a washcoat layer or washcoat formulation, the additional metal oxide particles (such as second metal oxide particles, micron-sized metal oxide particles, or second micron-sized metal oxide particles) can comprise cerium oxide, cerium-zirconium oxide, cerium-lanthanum oxide, cerium-yttrium oxide, cerium-neodymium oxide, cerium-zirconium-lanthanum oxide, cerium-zirconium-yttrium oxide, cerium-zirconium-neodymium oxide, cerium-lanthanum-yttrium oxide, cerium-lanthanum-neodymium oxide, cerium-yttrium-neodymium oxide, cerium-zirconium-lanthanum-yttrium oxide, cerium-zirconium-lanthanum-neodymium oxide, cerium-zirconium-yttrium-neodymium oxide, cerium-lanthanum-yttrium-neodymium oxide, or cerium-zirconium-lanthanum-yttrium-neodymium oxide. Cerium oxide, cerium-zirconium oxide, and cerium-zirconium-lanthanum oxide, cerium-zirconium-lanthanum-yttrium oxide, and cerium-zirconium-lanthanum-neodymium oxide are a useful subgroup, especially cerium oxide and cerium-zirconium oxide.

In any embodiment where nano-on-nano-in-micro particles are created, in which composite nanoparticles comprising rhodium catalytic nanoparticles on a support nanoparticle (where the support particle comprise cerium oxide or a metal oxide comprising cerium oxide and one or more additional metals) are embedded in a porous carrier matrix, the porous carrier matrix can comprise cerium oxide, cerium-zirconium oxide, cerium-lanthanum oxide, cerium-yttrium oxide, cerium-neodymium oxide, cerium-zirconium-lanthanum oxide, cerium-zirconium-yttrium oxide, cerium-zirconium-neodymium oxide, cerium-lanthanum-yttrium oxide, cerium-lanthanum-neodymium oxide, cerium-yttrium-neodymium oxide, cerium-zirconium-lanthanum-yttrium oxide, cerium-zirconium-lanthanum-neodymium oxide, cerium-zirconium-yttrium-neodymium oxide, cerium-lanthanum-yttrium-neodymium oxide, or cerium-zirconium-lanthanum-yttrium-neodymium oxide. Cerium oxide, cerium-zirconium oxide, and cerium-zirconium-lanthanum oxide, cerium-zirconium-lanthanum-yttrium oxide, and cerium-zirconium-lanthanum-neodymium oxide are a useful subgroup, especially cerium oxide and cerium-zirconium oxide.

### Exhaust Systems, Vehicles, and Emissions Performance

In some embodiments of the invention, a coated substrate as disclosed herein is housed within a catalytic converter in a position configured to receive exhaust gas from an internal combustion engine, such as in an exhaust system of an internal combustion engine, for example a gasoline engine. The catalytic converter can be installed on a vehicle containing a gasoline engine. The catalytic converter can treat gases from a stationary engine.

### Use of Coated Substrates of the Invention in Catalytic Converters

The coated substrates of the invention can be used in catalytic converters for treatment of the exhaust gases of combustion engines. They are particularly useful for treatment of the exhaust from gasoline engines. Catalytic converters for gasoline engines must oxidize unburned hydrocarbons to carbon dioxide and water (CₓH₂ₓ₊₂+[(3x+1)/2]O₂→xCO₂+(x+1)H₂O), oxidize carbon monoxide to carbon dioxide (2CO+O₂→2CO₂), and reduce oxides of nitrogen (NOx) to nitrogen and oxygen (2NOₓ→xO₂+N₂). Rhodium is generally used as a reduction catalyst in catalytic converters for gasoline exhaust. Palladium, platinum, or a platinum-palladium alloy can be used as the oxidation catalyst. Platinum tends to be much more expensive than palladium, and accordingly, it is preferable to minimize the amount of platinum used as an oxidation catalyst. In one embodiment, the coated substrates and/or catalytic converters disclosed herein are free of platinum or substantially free of platinum. In one embodiment, the coated substrates and/or catalytic converters disclosed herein use only palladium as an oxidation catalyst.

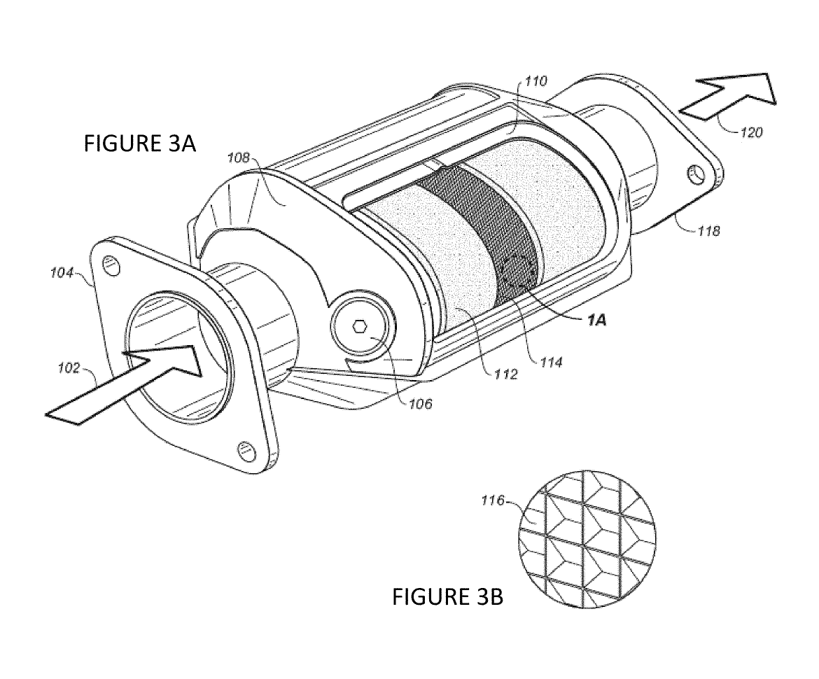

The coated substrate is placed into a housing, such as that shown in FIG. 3, which can in turn be placed into an exhaust system (also referred to as an exhaust treatment system) of an internal combustion engine. The internal combustion engine can be a gasoline engine. The exhaust system of the internal combustion engine receives exhaust gases from the engine, typically into an exhaust manifold, and delivers the exhaust gases to an exhaust treatment system. The catalytic converter forms part of the exhaust system. The exhaust system can also include other components, such as oxygen sensors, HEGO (heated exhaust gas oxygen) sensors, UEGO (universal exhaust gas oxygen) sensors, sensors for other gases, and temperature sensors. The exhaust system can also include a controller such as an engine control unit (ECU), a microprocessor, or an engine management computer, which can adjust various parameters in the vehicle (fuel flow rate, fuel/air ratio, fuel injection, engine timing, valve timing, etc.) in order to optimize the components of the exhaust gases that reach the exhaust treatment system, so as to manage the emissions released into the environment.

The coated substrates, catalytic converters, and exhaust systems described herein can be employed in vehicles which use a gasoline engine. The coated substrates, catalytic converters, and exhaust systems described herein can be employed to treat gases from a stationary gasoline engine.

### Performance Characteristics of Catalytic Converters

In one embodiment, a vehicle equipped with a catalytic converter utilizing a substrate of the invention meets the United States Environmental Protection Agency Tier 2 Exhaust Emission Standards.

In one embodiment, a vehicle equipped with a catalytic converter utilizing a substrate of the invention meets the United States Environmental Protection Agency Tier 3 Exhaust Emission Standards.

In one embodiment, a vehicle equipped with a catalytic converter utilizing a substrate of the invention meets the Euro 5 pollution standards.

In one embodiment, a vehicle equipped with a catalytic converter utilizing a substrate of the invention meets the Euro 6 pollution standards.

In some embodiments, the vehicle exhibits these characteristics after the catalytic converter has been aged. Aging of the catalytic converter can be artificially accelerated, for example by heating the catalytic converter or coated substrate to a temperature of about 1050° C. for about 80 hours.

### EXAMPLES

### Example 1

A first layer washcoat slurry was formed by combining porous, micron-sized cerium-zirconium-lanthanum-yttrium oxide particles (40% cerium oxide, 50% zirconium oxide, 5% lanthanum oxide, 5% yttrium oxide), composite nanoparticles (palladium nanoparticles bonded to aluminum oxide nanoparticles at a 40:60 ratio), barium acetate, and boehmite in the amounts shown in Table 1. The pH of the slurry was adjusted to about 4.5 and 2-hydroxyethyl cellulose was added as a thickener. The first layer washcoat was applied to the entire length of a substrate, which was then dried and calcined.

TABLE 1
Washcoat Slurry for First Washcoat Layer

| Component | Amount (% solids by weight) |
|---|---|
| metal oxide particles | 81% |
| composite nanoparticles | 2.7% |
| barium acetate | 11.2% |
| boehmite | 5.2% |

During the calcining process, the barium acetate is converted to barium oxide and the boehmite is converted to aluminum oxide. The resulting first washcoat layer comprises porous, micron-sized cerium-zirconium-lanthanum-yttrium oxide particles (40% cerium oxide, 50% zirconium oxide, 5% lanthanum oxide, 5% yttrium oxide), composite nanoparticles (palladium nanoparticles bonded to aluminum oxide nanoparticles at a 40:60 ratio), barium oxide, and aluminum oxide derived from boehmite in the amounts shown in Table 2. The resulting layer had a thickness of about 216 g/L and a palladium loading of about 2.4 g/L.

TABLE 2
First Washcoat Layer

| component | amount (% by weight) |
|---|---|
| metal oxide particles | 86% |
| composite nanoparticles | 2.9% |
| barium oxide | 6.8% |
| aluminum oxide (from boehmite) | 4.4% |

A second layer washcoat slurry was formed by combining nano-on-nano-on micro (NNm) particles comprising composite nanoparticles (rhodium nanoparticles bonded to support nanoparticles comprising cerium-zirconium-lanthanum-neodymium oxide (21% cerium oxide, 72% zirconium oxide, 2% lanthanum oxide, 5% neodymium oxide) at a 10:90 ratio) attached to porous, micron-sized cerium-zirconium-lanthanum-neodymium oxide particles (21% cerium oxide, 72% zirconium oxide, 2% lanthanum oxide, 5% neodymium oxide), boehmite, and filler particles (porous aluminum oxide stabilized with lanthanum oxide) in the amounts shown in Table 3. The pH of the slurry was adjusted to about 4.5 and 2-hydroxyethyl cellulose was added as a thickener. The second layer washcoat slurry was applied to the entire length of a substrate, which was then dried and calcined.

TABLE 3
Washcoat Slurry for Second Washcoat Layer

| Component | amount (% solids by weight) |
|---|---|
| metal oxide particles | 73.2% |
| composite nanoparticles | 2.9% |
| boehmite | 5.0% |
| filler particles | 19% |

During the calcining process, the boehmite is converted to aluminum oxide. The resulting second washcoat layer comprises porous, micron-sized cerium-zirconium-lanthanum-neodymium oxide particles (21% cerium oxide, 72% zirconium oxide, 2% lanthanum oxide, 5% neodymium oxide), composite nanoparticles (rhodium nanoparticles bonded to support nanoparticles comprising cerium-zirconium-lanthanum-neodymium oxide (21% cerium oxide, 72% zirconium oxide, 2% lanthanum oxide, 5% neodymium oxide) at a 10:90 ratio), aluminum oxide derived from boehmite, and filler particles (porous aluminum oxide stabilized with lanthanum oxide) in the amounts shown in Table 4. The resulting layer had a thickness of about 105 g/L and a palladium loading of about 0.3 g/L

TABLE 4
Second Washcoat Layer

| component | amount (% by weight) |
|---|---|
| metal oxide particles | 73.9% |
| composite nanoparticles | 2.9% |
| aluminum oxide (from boehmite) | 4.0% |
| filler particles | 19.2% |

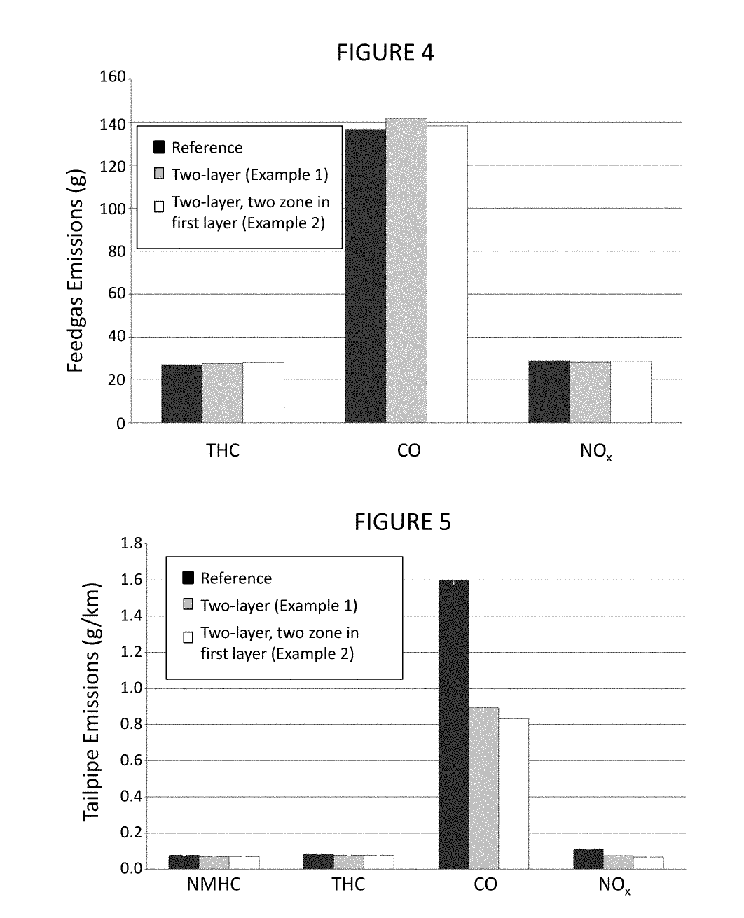

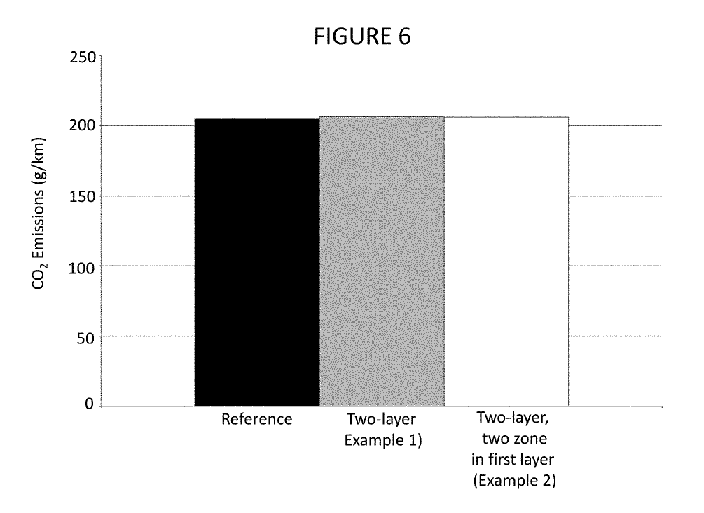

The resulting coated two-layer substrate had a total platinum group metal (PGM) loading content of 2.7 g/L (2.4 g/L palladium, 0.3 g/L rhodium). Both the substrate of the reference catalyst and the coated two-layer substrate were artificially aged by heating the substrates to 1050° C. for 80 hours. The coated substrate was used in a catalytic converter attached to a vehicle and compared to a commercially available catalyst with a platinum group metal loading of about 3.8 g/L (3.5 g/L palladium, 0.3 g/L rhodium) attached to a similar vehicle. The Exhaust feedgas containing hydrocarbons, carbon monoxide, and nitrogen oxides flowed through the catalyst and tailpipe emissions were measured. Amounts of total hydrocarbons (THC), carbon monoxide (CO), and nitrogen oxides (NOₓ) in the feedgas for the exemplary two-layer catalyst of the present invention and the commercially-available reference catalyst are presented in Table 5 and FIG. 4. Amounts of non-methane hydrocarbon (NMHC), total hydrocarbon (THC), carbon monoxide (CO), nitrogen oxides (NOₓ), and carbon dioxide (CO₂) in the tailpipe emissions for the exemplary two-layer catalyst of the present invention and the commercially-available reference catalyst are presented in Table 6 and FIGS. 5 and 6 (reported in g/km).

TABLE 5
Total feedgas components

| Catalyst | PGM (g/L) | THC (g) | CO (g) | NOₓ (g) |
|---|---|---|---|---|
| two-layer catalyst | 2.7 | 27.7 | 141.9 | 28.3 |
| (Example 1) | | | | |
| reference catalyst | 3.8 | 27.1 | 136.7 | 29.1 |

TABLE 6
Tailpipe emissions components

| | PGM | NMHC | THC | CO | NOₓ | CO₂ |
|---|---|---|---|---|---|---|
| Catalyst | (g/L) | (g/km) | (g/km) | (g/km) | (g/km) | (g/km) |
| two-layer | 2.7 | 0.070 | 0.078 | 0.895 | 0.076 | 206.3 |
| catalyst | | | | | | |
| (Example 1) | | | | | | |
| reference | 3.8 | 0.076 | 0.085 | 1.599 | 0.111 | 204.9 |
| catalyst | | | | | | |

### Example 2

A first zone of the first layer washcoat slurry was formed by combining porous, micron-sized cerium-zirconium-lanthanum-yttrium oxide particles (40% cerium oxide, 50% zirconium oxide, 5% lanthanum oxide, 5% yttrium oxide), composite nanoparticles (palladium nanoparticles bonded to aluminum oxide nanoparticles at a 40:60 ratio), barium acetate, and boehmite in the amounts shown in Table 7. The pH of the slurry was adjusted to about 4.5 and 2-hydroxyethyl cellulose was added as a thickener. The first zone of the first layer washcoat was applied to the front 50% of a substrate, which was then dried and calcined.

TABLE 7
Washcoat Slurry for First Zone of the First Washcoat Layer

| Component | Amount (% solids by weight) |
|---|---|
| metal oxide particles | 79.4% |
| composite nanoparticles | 4.5% |
| barium acetate | 11.0% |
| boehmite | 5.1% |

During the calcining process, the barium acetate is converted to barium oxide and the boehmite is converted to aluminum oxide. The resulting first zone of the first washcoat layer comprises porous, micron-sized cerium-zirconium-lanthanum-yttrium oxide particles (40% cerium oxide, 50% zirconium oxide, 5% lanthanum oxide, 5% yttrium oxide), composite nanoparticles (palladium nanoparticles bonded to aluminum oxide nanoparticles at a 40:60 ratio), barium oxide, and aluminum oxide derived from boehmite in the amounts shown in Table 8. The resulting layer had a thickness of about 216 g/L and a palladium loading of about 4.2 g/L.

TABLE 8
First Zone of the First Washcoat Layer

| component | amount (% by weight) |
|---|---|
| metal oxide particles | 84.2% |
| composite nanoparticles | 4.8% |
| barium oxide | 6.6% |
| aluminum oxide (from boehmite) | 4.3% |

A second zone of the first layer washcoat slurry was formed by combining porous, micron-sized cerium-zirconium-lanthanum-yttrium oxide particles (40% cerium oxide, 50% zirconium oxide, 5% lanthanum oxide, 5% yttrium oxide), composite nanoparticles (palladium nanoparticles bonded to cerium oxide nanoparticles at a 30:70 ratio), barium acetate, and boehmite in the amounts shown in Table 9. The pH of the slurry was adjusted to about 4.5 and 2-hydroxyethyl cellulose was added as a thickener. The second zone of the first layer washcoat was applied to the back 50% of a substrate, which was then dried and calcined.

TABLE 9
Washcoat Slurry for Second Zone of the First Washcoat Layer

| Component | Amount (% solids by weight) |
|---|---|
| metal oxide particles | 82.3% |
| composite nanoparticles | 1.0% |
| barium acetate | 11.4% |
| boehmite | 5.3% |

During the calcining process, the barium acetate is converted to barium oxide and the boehmite is converted to aluminum oxide. The resulting second zone of the first washcoat layer comprises porous, micron-sized cerium-zirconium-lanthanum-yttrium oxide particles (40% cerium oxide, 50% zirconium oxide, 5% lanthanum oxide, 5% yttrium oxide), composite nanoparticles (palladium nanoparticles bonded to cerium oxide nanoparticles at a 30:70 ratio), barium oxide, and aluminum oxide derived from boehmite in the amounts shown in Table 10. The resulting layer had a thickness of about 208 g/L and a palladium loading of about 0.6 g/L.

TABLE 10
Second Zone of the First Washcoat Layer

| Component | amount (% by weight) |
|---|---|
| metal oxide particles | 87% |
| composite nanoparticles | 1.1% |
| barium oxide | 6.9% |
| aluminum oxide (from boehmite) | 4.5% |

A second layer washcoat slurry was formed by combining nano-on-nano-on micro (NNm) particles comprising composite nanoparticles (rhodium nanoparticles bonded to support nanoparticles comprising cerium-zirconium-lanthanum-neodymium oxide (21% cerium oxide, 72% zirconium oxide, 2% lanthanum oxide, 5% neodymium oxide) at a 10:90 ratio) attached to porous, micron-sized cerium-zirconium-lanthanum-neodymium oxide particles (21% cerium oxide, 72% zirconium oxide, 2% lanthanum oxide, 5% neodymium oxide), boehmite, and filler particles (porous aluminum oxide stabilized with lanthanum oxide) in the amounts shown in Table 11. The pH of the slurry was adjusted to about 4.5 and 2-hydroxyethyl cellulose was added as a thickener. The first layer washcoat was applied to the entire length of a substrate, which was then dried and calcined.

TABLE 11
Washcoat Slurry for Second Washcoat Layer

| Component | amount (% solids by weight) |
|---|---|
| metal oxide particles | 73.2% |
| composite nanoparticles | 2.9% |
| boehmite | 5.0% |
| filler particles | 19% |

During the calcining process, the boehmite is converted to aluminum oxide. The resulting first washcoat layer comprises porous, micron-sized cerium-zirconium-lanthanum-neodymium oxide particles (21% cerium oxide, 72% zirconium oxide, 2% lanthanum oxide, 5% neodymium oxide), composite nanoparticles (rhodium nanoparticles bonded to support nanoparticles comprising cerium-zirconium-lanthanum-neodymium oxide (21% cerium oxide, 72% zirconium oxide, 2% lanthanum oxide, 5% neodymium oxide) at a 10:90 ratio), aluminum oxide derived from boehmite, and filler particles (porous aluminum oxide stabilized with lanthanum oxide) in the amounts shown in Table 12. The resulting layer had a thickness of about 105 g/L and a palladium loading of about 0.3 g/L

TABLE 12
Second Washcoat Layer

| component | amount (% by weight) |
|---|---|
| metal oxide particles | 73.9% |
| composite nanoparticles | 2.9% |
| aluminum oxide (from boehmite) | 4.0% |
| filler particles | 19.2% |

The resulting coated two-layer substrate, wherein the first layer has a first zone and a second zone, had a total platinum group metal (PGM) loading content of 2.7 g/L (2.4 g/L palladium, 0.3 g/L rhodium). Both the substrate of the reference catalyst and the coated two-layer, wherein the first layer comprises two zones, substrate of the present invention were artificially aged by heating the substrates to 1050° C. for 80 hours. The coated substrate was used in a catalytic converter attached to a vehicle and compared to a commercially available catalyst with a platinum group metal loading of about 3.8 g/L (3.5 g/L palladium, 0.3 g/L rhodium) attached to a similar vehicle. The Exhaust feedgas containing hydrocarbons, carbon monoxide, and nitrogen oxides flowed through the catalyst and tailpipe emissions were measured. Amounts of total hydrocarbons (THC), carbon monoxide (CO), and nitrogen oxides (NOₓ) in the feedgas for the exemplary two-layer catalyst of the present invention and the commercially-available reference catalyst are presented in Table 13 and FIG. 4. Amounts of non-methane hydrocarbon (NMHC), total hydrocarbon (THC), carbon monoxide (CO), nitrogen oxides (NOₓ), and carbon dioxide (CO₂) in the tailpipe emissions for the exemplary two-layer catalyst of the present invention and the commercially-available reference catalyst are presented in Table 14 and FIGS. 5 and 6 (reported in g/km).

TABLE 13
Total feedgas components

| Catalyst | PGM (g/L) | THC (g) | CO (g) | NOₓ (g) |
|---|---|---|---|---|
| two-layer catalyst, with | 2.7 | 28.2 | 138.3 | 28.8 |
| two zones in first layer | | | | |
| (Example 2) | | | | |
| reference catalyst | 3.8 | 27.1 | 136.7 | 29.1 |

TABLE 14
Tailpipe emissions components

| | PGM | NMHC | THC | CO | NOₓ | CO₂ |
|---|---|---|---|---|---|---|
| Catalyst | (g/L) | (g/km) | (g/km) | (g/km) | (g/km) | (g/km) |
| two-layer | 2.7 | 0.069 | 0.077 | 0.833 | 0.066 | 205.9 |
| catalyst | | | | | | |
| (Example 1) | | | | | | |
| reference | 3.8 | 0.076 | 0.085 | 1.599 | 0.111 | 204.9 |
| catalyst | | | | | | |

The disclosures of all publications, patents, patent applications, and published patent applications referred to herein by an identifying citation are hereby incorporated herein by reference in their entirety.

The present invention has been described in terms of specific embodiments incorporating details to facilitate the understanding of principles of construction and operation of the invention. Such reference herein to specific embodiments and details thereof is not intended to limit the scope of the claims appended hereto. It will be readily apparent to one skilled in the art that other various modifications can be made in the embodiments chosen for illustration without departing from the spirit and scope of the invention. Therefore, the description and examples should not be construed as limiting the scope of the invention.

1. A coated substrate for treating gasoline engine exhaust, comprising:
(i) a substrate;
(ii) a first washcoat layer coating the substrate comprising:
(a) first metal oxide particles;
first composite nanoparticles comprising a first catalytic nanoparticle comprising platinum, palladium, or a platinum-palladium alloy bonded to a first support nanoparticle comprising aluminum oxide; and
barium oxide; or
(b) first composite nanoparticles embedded in first porous carriers, the first composite nanoparticles comprising a first catalytic nanoparticle comprising platinum, palladium, or a platinum-palladium alloy bonded to a first support nanoparticle comprising aluminum oxide; and barium oxide; and
(iii) a second washcoat layer coating the substrate comprising:
(a) second metal oxide particles; and
second composite nanoparticles comprising a second catalytic nanoparticle comprising rhodium bonded to a second support particle; or
(b) second composite nanoparticles embedded in second porous carriers, the second composite nanoparticles comprising a second catalytic nanoparticle comprising rhodium bonded to a second support nanoparticle.

2. The coated substrate of claim 1, wherein the first washcoat layer or the second washcoat layer further comprises filler particles.

3. The coated substrate of claim 2, wherein the filler particles comprise aluminum oxide or aluminum-lanthanum oxide.

4. The coated substrate of claim 1, wherein the first washcoat layer or the second washcoat layer comprises aluminum oxide derived from boehmite.

5. The coated substrate of claim 1, wherein the first washcoat layer comprises about 40% to about 90% by weight of the first metal oxide particles, or the second washcoat layer comprises about 45% to about 95% by weight of the second metal oxide particles.

6. The coated substrate of claim 1, wherein the first washcoat layer comprises about 1% to about 10% by weight of the first composite nanoparticles.

7. The coated substrate of claim 1, wherein the first washcoat layer comprises about 3% to about 20% by weight barium oxide.

8. The coated substrate of claim 1, wherein the first washcoat layer or the second washcoat layer comprises up to about 70% filler particles.

9. (canceled)

10. The coated substrate of claim 4, wherein the first washcoat layer or the second washcoat layer comprises about 3% to about 8% by weight aluminum oxide derived from boehmite.

11. The coated substrate of claim 1, wherein the first washcoat layer is coated onto the substrate at about 150 g/L to about 250 g/L, or the second washcoat layer is coated onto the substrate at about 50 g/L to about 120 g/L.

12. The coated substrate of claim 1, wherein the first washcoat layer has a platinum group metal loading content of about 1 g/L to about 5 g/L.

13. A coated substrate for treating gasoline engine exhaust, comprising:
(i) a substrate;
(ii) a first washcoat layer coating the substrate comprising a first zone and a second zone, wherein the first zone and the second zone do not overlap, wherein:
(a) the first zone comprises:
(1) first metal oxide particles;
first composite nanoparticles comprising a first catalytic nanoparticle comprising platinum, palladium, or a platinum-palladium alloy bonded to a first support nanoparticle comprising aluminum oxide; and
barium oxide; or
(2) first composite nanoparticles embedded in first porous carriers, the first composite nanoparticles comprising a first catalytic nanoparticle comprising platinum, palladium, or a platinum-palladium alloy bonded to a first support nanoparticle comprising aluminum oxide; and barium oxide; and
(b) the second zone comprises:
(1) third metal oxide particles;
third composite nanoparticles comprising a third catalytic nanoparticle comprising platinum, palladium, or a platinum-palladium alloy bonded to a third support nanoparticle comprising cerium oxide; and
barium oxide; or
(2) third composite nanoparticles embedded in third porous carriers, the third composite nanoparticles comprising a third catalytic nanoparticle comprising platinum, palladium, or a platinum-palladium alloy bonded to a third support nanoparticle comprising cerium oxide; and barium oxide; and
(iii) a second washcoat layer coating the substrate comprising:
(a) second metal oxide particles; and
second composite nanoparticles comprising a second catalytic nanoparticle comprising rhodium bonded to a second support particle; or
(b) second composite nanoparticles embedded in second porous carriers, the second composite nanoparticles comprising a second catalytic nanoparticle comprising rhodium bonded to a second support nanoparticle.

14. The coated substrate of claim 13, wherein the first zone of the first washcoat layer, the second zone of the first washcoat layer, or the second washcoat layer further comprises filler particles.

15. The coated substrate of claim 14, wherein the filler particles comprise aluminum oxide or aluminum-lanthanum oxide.

16. (canceled)

17. The coated substrate of claim 13, wherein the first zone of the first washcoat layer, the second zone of the first washcoat layer, or the second washcoat layer comprises aluminum oxide derived from boehmite.

18. The coated substrate of claim 13, wherein the first zone or the second zone of the first washcoat layer comprises about 40% to about 90% by weight of the first metal oxide particles, or the second washcoat layer comprises about 45% to about 95% by weight of the second metal oxide particles.

19. The coated substrate of claim 13, wherein the first zone of the first washcoat layer comprises about 1% to about 10% by weight of the first composite nanoparticles.

20. The coated substrate of claim 13, wherein the first zone or the second zone of the first washcoat layer comprises about 3% to about 20% by weight barium oxide.

21. The coated substrate of claim 14, wherein the first zone of the first washcoat layer, the second zone of the first washcoat layer, or the second washcoat layer, comprises up to about 70% filler particles.

22. (canceled)

23. The coated substrate of claim 17, wherein the first zone of the first washcoat layer, the second zone of the first washcoat layer, or the second washcoat layer comprises about 3% to about 8% by weight aluminum oxide derived from boehmite.

24. The coated substrate of claim 13, wherein the first zone of the first washcoat layer is coated onto the substrate at about 150 g/L to about 250 g/L, the second zone of the first washcoat layer is coated onto the substrate at about 165 g/L to about 220 g/L, or the second washcoat layer is coated onto the substrate at about 50 g/L to about 120 g/L.

25. The coated substrate of claim 13, wherein the first zone of the first washcoat layer has a platinum group metal loading content of about 3 g/L to about 5 g/L.

26. (canceled)

27. The coated substrate of claim 13, wherein the second zone of the first washcoat layer comprises about 0.5% to about 3% by weight of the third composite nanoparticles.

28-32. (canceled)

33. The coated substrate of claim 13, wherein the second zone of the first washcoat layer has a platinum group metal loading content of about 0.5 g/L to about 1.2 g/L.

34. (canceled)

35. The coated substrate of claim 1, wherein the second washcoat layer comprises about 1.5% to about 5% by weight of the second composite nanoparticles.

36-39. (canceled)

40. The coated substrate of claim 1, wherein the second washcoat layer has a platinum group metal loading content of about 0.1 g/L to about 0.6 g/L.

41. The coated substrate of claim 1, wherein the first metal oxide particles, the second metal oxide particles, or the third metal oxide particles are micron-sized particles.

42. The coated substrate of claim 1, wherein the first metal oxide particles, the second metal oxide particles, or the third metal oxide particles are porous.

43. The coated substrate of claim 1, wherein the first metal oxide particles, the second metal oxide particles, or the third metal oxide particles comprise cerium oxide, zirconium oxide, lanthanum oxide, yttrium oxide, or a combination thereof.

44. The coated substrate of claim 43, wherein the first metal oxide particles, the second metal oxide particles, or the third metal oxide particles comprise cerium-zirconium-lanthanum-yttrium oxide.

45. The coated substrate of claim 1, wherein the second metal oxide particles, the second support nanoparticle, or the third support nanoparticle comprises cerium oxide, zirconium oxide, lanthanum oxide, yttrium oxide, neodymium oxide, or a combination thereof.

46. The coated substrate of claim 45, wherein the second metal oxide particles or the second support nanoparticle comprises cerium-zirconium-lanthanum-neodymium oxide.

47. The coated substrate of claim 1, wherein the first catalytic nanoparticle or the third catalytic nanoparticle comprises palladium.

48-50. (canceled)

51. The coated substrate of claim 1, wherein the third support nanoparticle comprises cerium oxide.

52. The coated substrate of claim 13, wherein the first zone is about 10% to about 90% of the length of the first washcoat layer coated onto the substrate.

53. (canceled)

54. The coated substrate of claim 1, wherein the first nanoparticle is not attached to the first metal oxide particle prior to forming the first washcoat layer.

55. The coated substrate of claim 13, wherein the third composite nanoparticle is not attached to the third metal oxide particle prior to forming the second zone of the first washcoat layer.

56. (canceled)

57. The coated substrate of claim 1, wherein the first composite nanoparticle comprises about 20% to about 60% by weight palladium, the second composite nanoparticle comprises about 5% to about 20% by weight rhodium, or the third composite nanoparticle comprises about 1% to about 50% by weight palladium.

58-81. (canceled)

82. A method of making a coated substrate, comprising
(i) coating a substrate with a first washcoat slurry, the first washcoat slurry comprising:
(1) first metal oxide particles;
first composite nanoparticles comprising a first catalytic nanoparticle comprising platinum, palladium, or a platinum-palladium alloy bonded to a first support nanoparticle comprising aluminum oxide; and
a barium salt; or
(2) first composite nanoparticles embedded in first porous carriers, the first composite nanoparticles comprising a first catalytic nanoparticle comprising platinum, palladium, or a platinum-palladium alloy bonded to a first support nanoparticle comprising aluminum oxide; and a barium salt; and
(ii) coating the substrate with a second washcoat slurry, the second washcoat slurry comprising:
second metal oxide particles; and
second composite nanoparticles comprising a second catalytic nanoparticle comprising rhodium bonded to a second support particle.

83. A method of making a coated substrate, comprising
(i) coating a substrate with a first washcoat slurry in a first zone, the first washcoat slurry comprising:
(1) first metal oxide particles;
first composite nanoparticles comprising a first catalytic nanoparticle comprising platinum, palladium, or a platinum-palladium alloy bonded to a first support nanoparticle comprising aluminum oxide; and
a barium salt; or
(2) first composite nanoparticles embedded in first porous carriers, the first composite nanoparticles comprising a first catalytic nanoparticle comprising platinum, palladium, or a platinum-palladium alloy bonded to a first support nanoparticle comprising aluminum oxide; and a barium salt;
(ii) coating the substrate with a third washcoat slurry in a second zone, the third washcoat slurry comprising:
(1) third metal oxide particles;
third composite nanoparticles comprising a third catalytic nanoparticle comprising platinum, palladium, or a platinum-palladium alloy bonded to a third support nanoparticle comprising cerium oxide; and
a barium salt; or
(2) third composite nanoparticles embedded in third porous carriers, the third composite nanoparticles comprising a third catalytic nanoparticle comprising platinum, palladium, or a platinum-palladium alloy bonded to a third support nanoparticle comprising cerium oxide; and a barium salt; and
(iii) coating the substrate with a second washcoat slurry, the second washcoat slurry comprising:
second metal oxide particles; and
second composite nanoparticles comprising a second catalytic nanoparticle comprising rhodium bonded to a second support particle.

84-139. (canceled)

140. A catalytic converter comprising a coated substrate of claim 1, wherein the substrate is disposed such that the exhaust gas contacts the first zone prior to the second zone if the first zone and the second zone are present.

141. (canceled)

142. A method of treating exhaust gases from a gasoline engine with the catalytic converter of claim 140, comprising passing the exhaust gases through the catalytic converter.

143. A vehicle comprising the catalytic converter of claim 140.

144. The vehicle of claim 143, wherein the vehicle comprises a gasoline-powered engine.

145. A gasoline-powered generator comprising the catalytic converter of claim 140.

146-225. (canceled)

226. The coated substrate of claim 13, wherein the second washcoat layer comprises about 1.5% to about 5% by weight of the second composite nanoparticles.

227. The coated substrate of claim 13, wherein the second washcoat layer has a platinum group metal loading content of about 0.1 g/L to about 0.6 g/L.

228. The coated substrate of claim 13, wherein the first metal oxide particles, the second metal oxide particles, or the third metal oxide particles are micron-sized particles.

229. The coated substrate of claim 13, wherein the first metal oxide particles, the second metal oxide particles, or the third metal oxide particles are porous.

230. The coated substrate of claim 13, wherein the first metal oxide particles, the second metal oxide particles, the third metal oxide particles, or the third support nanoparticles comprise cerium oxide, zirconium oxide, lanthanum oxide, yttrium oxide, or a combination thereof.

231. The coated substrate of claim 230, wherein the first metal oxide particles, the second metal oxide particles, the third metal oxide particles, or the third support nanoparticle comprise cerium-zirconium-lanthanum-yttrium oxide.

232. The coated substrate of claim 13, wherein the second metal oxide particles or the second support nanoparticle comprise cerium oxide, zirconium oxide, lanthanum oxide, yttrium oxide, neodymium oxide, or a combination thereof.

233. The coated substrate of claim 232, wherein the second metal oxide particles or the second support nanoparticle comprises cerium-zirconium-lanthanum-neodymium oxide.

234. The coated substrate of claim 13, wherein the third support nanoparticle comprises cerium oxide.

235. The coated substrate of claim 13, wherein the first catalytic nanoparticle or the third catalytic nanoparticle comprises palladium.

236. The coated substrate of claim 13, wherein the first nanoparticle is not attached to the first metal oxide particle prior to forming the first washcoat layer.

237. The coated substrate of claim 13, wherein the first composite nanoparticle comprises about 20% to about 60% by weight palladium, the second composite nanoparticle comprises about 5% to about 20% by weight rhodium, or the third composite nanoparticle comprises about 1% to about 50% by weight palladium.

238. A catalytic converter comprising a coated substrate of claim 13, wherein the substrate is disposed such that the exhaust gas contacts the first zone prior to the second zone if the first zone and the second zone are present.

239. A method of treating exhaust gases from a gasoline engine with the catalytic converter of claim 238, comprising passing the exhaust gases through the catalytic converter.

240. A vehicle comprising the catalytic converter of claim 239.

241. The vehicle of claim 240, wherein the vehicle comprises a gasoline-powered engine.

242. A gasoline-powered generator comprising the catalytic converter of claim 238.
